(19) United States
(12) Patent Application Publication
(10) Pub. No.: US 2006/0014096 A1
(43) Pub. Date: Jan. 19, 2006

(54) Image forming method, image forming apparatus and process cartridge therefor

(76) Inventors: Kohichi Ohshima, Mishima-shi (JP); Yasuo Suzuki, Fuji-shi (JP); Tetsuro Suzuki, Fuji-shi (JP); Michitaka Sasaki, Chiba-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/166,853

(22) Filed: Jun. 27, 2005

(30) Foreign Application Priority Data
Jul. 1, 2004 (JP) 2004-195722

(51) Int. Cl. G03G 5/147

(52) U.S. Cl. 430/124; 430/66; 430/58.7

(57) ABSTRACT

An image forming method including: charging an electrophotographic photoreceptor including: an electroconductive substrate; and a photosensitive layer comprising a crosslinked surface layer on a surface thereof, which is located overlying the electroconductive substrate, irradiating the electrophotographic photoreceptor with imagewise light to form an electrostatic latent image thereon; developing the electrostatic latent image with a toner to form a toner image on the electrophotographic photoreceptor; transferring the toner image onto a transfer material; and fixing the toner image on the transfer material, wherein the photosensitive layer is sensitive to light having a wavelength of from 400 to 450 nm, and the crosslinked surface layer is formed by crosslinking and hardening a radical polymerizing monomer having three or more functional groups without a charge transport structure and a radical polymerizing compound having one functional group with charge transport structure.

### BACKGROUND OF THE INVENTION

1. Field of the Invention

The present invention relates to an image forming method for electrophotographic copiers, printers and facsimiles, and more particularly to an image forming method using a high-resolution electrophotographic photoreceptor capable of recording at not less than 1,200 dpi.

2. Discussion of the Background

So far, as photosensitive materials for photoreceptors used for electrophotographic image forming methods, various inorganic and organic photosensitive materials have been used. At this point, the “electrophotographic image forming method” mentioned herein means an image forming process of the so-called Carlson process. The electrophotographic image forming method typically includes the following processes:

(1) a photosensitive photoreceptor is charged, for instance, using corona discharging in a dark place;

(2) the photoreceptor is exposed to imagewise light to selectively decay the charge on the lighted parts of the photoreceptor, resulting information of an electrostatic latent image; and

(3) the electrostatic latent image is developed with a toner including a colorant (e.g. dye stuffs and pigments), a polymer, etc. to form a visual image on the photoreceptor.

Photoreceptors using an organic photosensitive material have advantages of having good flexibility in designing a photoreceptor having good photosensitivity to image writing light used, good film formability, good flexibility, high film transparency, good mass productivity, less toxicity, low cost, etc. against photoreceptors including an inorganic photosensitive material. Therefore, organic photosensitive materials are used for almost all the photoreceptors now.

In electrophotographic methods and similar processes, photoreceptors are required to have good electrostatic characteristics such as high photosensitivity, appropriate electric potential, high potential retainability, high potential stability, low residual potential and high photosensitivity over a broad wavelength range.

Recent progress of information processing systems using this electrophotographic image forming method is remarkable. Especially, progress of printers using a digital recording method in which information having been converted into digital signals is reproduced using light is remarkable in printing qualities and reliabilities. Such digital recording methods are applied not only to printers but also to ordinary copiers. Thus, digital copiers have been developed. Since various information processing functions can be added to digital copiers, it is considered that the demand for these digital copiers increases more and more.

At present, as the electrophotographic photoreceptor used for the electrophotographic image forming methods, functionally-separated multilayer photoreceptors having a charge generation layer on an electroconductive substrate directly or through an intermediate layer and a charge transport layer thereon are typically used. In addition, for improving mechanical or chemical durability of the photoreceptors, a protection layer is optionally formed on the surface of the photoreceptors.

As for these functionally-separated multilayer photoreceptors, when a photoreceptor with a charged surface is exposed to light, the light passes through the charge transport layer and is then absorbed in the charge generation material in the charge generation layer. The charge generation material generates charge carriers by absorbing light. The thus generated charge carriers are injected into the charge transport layer. The charge carriers are transported along an electric field formed by charges on the charge transport layer to neutralize the charges of the photoreceptor. Thus, an electrostatic latent image is formed on the surface of the photoreceptor. In order to impart high sensitivity to such a functionally-separated multilayer photoreceptor, a combination of a charge generation material mainly having absorption in near infrared to visible regions and a charge transport material having absorption in yellow to ultraviolet regions, which does not prevent transmission of absorbed light toward the charge generation material (i.e., hardly causes masking effects (filtering effects) of writing light) is typically used. In addition, using such a charge transport layer which does not absorb writing light is important to impart not only high sensitivity but also good charge stability and high image resolution to the photoreceptor.

As writing light sources applicable to the digital recording methods, small, inexpensive and reliable laser diodes (hereinafter referred to as “LD”) and light emitting diodes (hereinafter referred to as “LED”) which emit light having a wavelength of from about 600 to 800 nm are typically used. The wavelength of light emitted by LDs typically used at present is 780 to 800 nm (i.e. a near infrared region). The Led typically emits light having a wavelength of 740 nm.

However, lately, as a light source for digital recording methods, LDs (short wavelength LDs) and LEDs which emit light having a wavelength of from 400 to 450 nm (i.e., violet to blue light) have been developed and marketed.

When such a LD which emits light having about a half wavelength of that of a conventional near infrared LD is used as a writing light source for a laser scanner head, it is theoretically possible to make the spot diameter of the laser beam on a photoreceptor considerably small as can be understood by the following formula:
d∝(π/4) ([ f/D) (1)
wherein d represents the spot diameter of the laser formed on the photoreceptor; λ represents the wavelength of the laser; f represents the focal distance of the f θ lens used; and D represents the lens diameter. Therefore, these short wavelength LDs are very useful for improving image recording density (i.e., image resolution).

In addition, when such a short wavelength LD or LED is used for optical systems of image forming apparatus, a compact and high speed image forming apparatus can be provided. Therefore, a stable photoreceptor which has a sensitivity to light having a wavelength of from 400 to 450 nm is required.

The current electrophotographic image forming apparatus has an image resolution of from 300 to 600 dpi, which is insufficient to produce photographic images. In order to increase the image resolution, a minimum dot diameter is effectively lessened, which needs an irradiator having a smaller beam diameter, an electrophotographic photoreceptor capable of forming a smaller electrostatic latent image and an image developer developing the electrostatic latent image with good reproducibility. This needs a more microscopic toner, and a developed dot image needs to be transferred onto a transfer material and fixed thereon without a distortion. However, an ultra high-resolution electrophotographic image forming apparatus satisfying all these is not developed yet.

The LD emitting light having a wavelength of from 780 to 800 nm can have a beam spot diameter of from 150 to 60 μm. A beam spot diameter of from 20 to 30 μm for 1,200 dpi and that of from 10 to 15 μm for 2,400 dpi needs ultra high precision optics and large optical elements, and the cost and space of which are not practicable. In order to solve this problem, Japanese Laid-Open Patent Publication No. 5-19598 discloses an electrophotographic image forming apparatus using a laser having a short wavelength. However, just a small beam spot diameter could not produce ultra high resolution images.

When the conventional multilayer photoreceptor is used, light having a very short wavelength is absorbed in a charge transport layer thereof, resulting in low sensitivity of the photoreceptor. In order to solve this problem, an electrophotographic image forming apparatus using a charge transport material absorbing less light is disclosed. Even when the light having a small beam diameter is irradiated to a charge generation layer of an electrophotographic photoreceptor, it is still difficult therefor to produce ultra high resolution images.

An irradiated part has a higher energy density accompanied with a higher speed of image forming process and digitalization, and a charge generation layer of an electrophotographic photoreceptor has a higher charge density. Charges having a high density scatter in the direction of the surface of the photoreceptor while transported thereto, resulting in a large electrostatic latent image regardless of the small beam diameter.

In order to solve this problem, the charge transport layer effectively has a thinner thickness, and needs to be from ½ to ⅓ of the current thickness. However, when the photosensitive layer is thin, deterioration of the charge stability, life and dot reproducibility due to concavities and convexities of the electroconductive substrate tend to occur. A photosensitive layer having a pin hole or a coating defect causing a dielectric breakdown occasionally causes production of defective images.

On the other hand, a single-layered photoreceptor having a photosensitive layer including a charge generation material, a charge transport material and a binder resin on an electroconductive substrate is known. The photoreceptor has an advantage for the ultra high resolution electrophotographic images because a charge generated by irradiation generate in a surface part of the photoreceptor and an electrostatic latent image less expands. However, the single-layered photoreceptor has less sensitivity and more residual potential than the multilayer photoreceptor, and still has a problem when used for a high-speed electrophotographic image forming apparatus.

In addition, a reverse multilayer photoreceptor including a charge generation layer on a charge transport material on an electroconductive substrate is known. The photoreceptor also has an advantage for the ultra high resolution electrophotographic images because a charge generated by irradiation generate in a surface part of the photoreceptor and an electrostatic latent image less expands. For example, Japanese Laid-Open Patent Publication No. 9-240051 discloses an electrophotographic image forming apparatus using a LD emitting light having a wavelength of from 400 to 500 nm as a light source.

However, since the fragile and thin charge generation layer formed as an outermost layer receives mechanical and chemical stress from a charger, image developer, a transferer and a cleaner, the photoreceptor noticeably deteriorates due to repeated use and is practicable.

In order to prolong life of a photoreceptor, Japanese Laid-Open Patent Publication No. 1-170951 discloses a reverse multilayer photoreceptor including a surface protective layer. However, the purpose thereof is to provide an electrophotographic image forming apparatus producing less ozone to reduce environmental burdens, and which is not designed for an ultra high resolution electrophotographic image forming apparatus.

In order to produce ultra high resolution and high quality color images, it is essential that repeatedly overlapping a cyan (C) dot, a magenta (M) dot, a yellow (Y) dot and a black (Bk) dot is stably performed for long periods. Namely, it is essential that not only basic quality such as color reproducibility, toner reproducibility and expressivity of highlights can stably be maintained, but also defective images such as background fouling, black spotted images and distorted images are not produced.

In the transfer process of a conventional image forming process., the toner transferability of 100% is not realized yet. And a part thereof remains on a photoreceptor after a toner image is transferred onto a transfer material. When images are continuously formed as it is, the following images have defects. When the formation of a latent image is impaired, high quality images without contamination cannot be produced. Therefore, cleaners fully removing the remaining toner are required. The cleaners include a fur brush, a magnetic brush or a blade, and the blade is mostly used in terms of the performance and simplicity. An elastic rubber plate is typically used as the blade. The blade repeatedly gives mechanical stress to a photoreceptor because of strongly contacting thereto.

In addition, it is well known that a paper as a transfer material, including a fiber formed of a hard cellulose or a clay such as kaolin, accelerates abrasion of a photosensitive layer formed of a soft organic photoconductive material when contacting and fractioning the photoreceptor at a high speed in the transfer process. Further, it is said that the photosensitive layer formed of a soft organic photoconductive material is also abraded when contacting a developer including a hard carrier in the development process. Furthermore, the recent contact or non-contact chargers, being located quite closer to the surface of the photoreceptor and corona discharging than a conventional charger, damages the photoreceptor more and cuts molecular chains of constituents in the surface thereof.

Thus, the surface of an electrophotographic photoreceptor directly receiving a chemical, electrical and mechanical external force from a charger, an image developer, a transferer and a cleaner is required to have durability against the external force. Particularly, the mechanical durability thereof against abrasion or damage due to the frictionization, and damage and peeled film due to mixing of foreign particles or paper jam.

As for the mechanical durability, it is reported that a BPZ polycarbonate used in the surface of an organic photoreceptor as a binder resin improves abrasion and toner filming resistance thereof. Japanese Laid-Open Patent Publication No. 6-118681 discloses a method of using a hardening silicone resin including a colloidal silica in a surface protective layer of a photoreceptor.

However, even the photoreceptor using a BPZ polycarbonate binder has insufficient abrasion resistance and does not have sufficient durability. On the other hand, although the photoreceptor including the hardening silicone resin including a colloidal silica in its surface layer improves the abrasion resistance thereof, the photoreceptor tends to produce foggy or blurred images when repeatedly used and has insufficient durability.

In order to improve these defects, Japanese Laid-Open Patent Publications Nos. 9-124943 and 9-190004 disclose a photoreceptor having a surface resin layer wherein an organic silicon-modified positive hole charge transport material is combined in a hardening organic silicon polymer. However, the surface resin layer is hardened and not abraded. Therefore, a moisture absorbed therein in an environment of high temperature and high humidity can not be removed, resulting in occurrence of paper dust and toner filming, and production of defective images such as blurred, striped or spotted images.

Japanese Laid-Open Patent Publication No. 2002-182415 discloses a photoreceptor producing ultra high resolution images having 1,200 dpi or more and having an abrasion resistant surface protective layer. However, the surface protective layer including an organic or inorganic filler occasionally scatters laser beam therein when irradiated therewith to disturb a laser spot. In addition, a coating liquid including the filler is difficult to disperse, which causes problems of the surface protective layer. Particularly, a hard inorganic filler causes a microscopic nonuniformity such as hard projections thereon, resulting in chipping blade and toner filming.

On the other hand, accompanied with downsizing of image forming apparatus, the photoreceptor has smaller diameter in addition to higher speed and free maintenance of the of image forming apparatus, and the organic photoreceptor is required to have higher durability. As mentioned above, although the organic photoreceptor has a disadvantage of being abraded with a mechanical load from an image developer and a cleaner, the cleaner is forced to have a harder cleaning rubber blade and higher contact pressure to remove a toner having a smaller particle diameter for higher image quality.

A damage due to a local abrasion causes defective cleaning, resulting in production of striped images. Currently, a photoreceptor is replaced with a new one based on the abrasion or the damage.

Therefore, reducing the abrasion is indispensable for higher durability of the organic photoreceptor and a most pressing problem to solve.

In order to improve the abrasion resistance of a photosensitive layer, (1) Japanese Laid-Open Patent Publication No. 56-48637 discloses a crosslinked charge transport layer including a hardening binder; (2) Japanese Laid-Open Patent Publication No. 64-1728 discloses a charge transport polymer material; and (3) Japanese Laid-Open Patent Publication No. 4-281461 discloses a crosslinked charge transport layer wherein an inorganic filler is dispersed. (1) The crosslinked charge transport layer including a hardening binder tends to increase residual potential and deteriorate image density because of poor compatibility with a charge transport material and impurities such as a polymerization initiator and an unreacted residue. (2) The charge transport polymer material is capable of improving the abrasion resistance in a manner, but the durability required for the organic photoreceptor is not fully satisfied. In addition, the charge transport polymer material is difficult to polymerize and purify, and therefore the charge transport polymer material having a high purity is difficult to obtain, resulting in instability of electrical properties therebetween. Further, production problems such as a coating liquid having a high viscosity occasionally occur. (3) The crosslinked charge transport layer wherein an inorganic filler is dispersed has higher abrasion resistance than a photoreceptor wherein a conventional low-molecular-weight charge transport material is dispersed in an inactive polymer, but a charge trap present on the surface of the inorganic filler increases residual potential, resulting in deterioration of image density. In addition, when concavities and convexities of the inorganic filler and a binder resin on the surface of a photoreceptor, defective cleaning occurs, resulting in toner filming and production of distorted images. Neither of these (1), (2) and (3) fully satisfies the overall durability including the electrical and mechanical durability.

Further, Japanese Patent No. 3262488 discloses a photoreceptor including a hardened multifunctional acrylate monomer to improve the abrasion and damage resistance of (1). It is described that the hardened multifunctional acrylate monomer is included in a protective layer on a photosensitive layer, but not specific charge transport materials included therein. In addition, a low-molecular-weight charge transport material simply included in a crosslinked charge transport layer has poor compatibility with the hardened multifunctional acrylate monomer, and therefore the low-molecular-weight charge transport material separates out to make the charge transport layer cloudy and increase potential of the irradiated part, resulting in deterioration of image density and mechanical strength.

Further, since the monomer is added in a protective layer coating liquid including a polymer binder, a three-dimensional network is not fully developed and a crosslinked bonding density becomes thin, resulting in failure of noticeable abrasion resistance.

Japanese Patent No. 3262488 discloses a method of forming a charge transport layer with a coating liquid including a monomer having a carbon-carbon double bond, a charge transport material having a carbon-carbon double bond and a binder resin. This binder resin is thought to improve adherence between a charge generation layer and a hardening charge transport layer, and ease an inner stress of the hardening charge transport layer. This binder resin is broadly classified to a resin having a carbon-carbon double bond and a reactivity with the charge transport material, and a resin without a carbon-carbon double bond and a reactivity therewith. Although this photoreceptor has both abrasion resistance and good electrical properties, when the resin without a reactivity with the charge transport material is used as a binder resin, the binder resin has poor compatibility with hardened material produced by a reaction between the monomer and the charge transport material, and the crosslinked charge transport layer has a layer separation therein, resulting in damages or retention of an external additive of a toner and paper powder. As mentioned above, a three-dimensional network is not fully developed and a crosslinked bonding density becomes thin, resulting in failure of noticeable abrasion resistance. In addition, the monomer specifically described is bifunctional, and the resultant abrasion resistance is not satisfactory. Even when the resin having a reactivity with the charge transport material is used as a binder resin, the molecular weight of the hardened material increase but the number of molecular crosslinked bond is a few, and it is difficult to increase both a bonding amount and crosslinked density of the charge transport material, resulting in insufficient electrical properties and abrasion resistance.

Japanese Laid-Open Patent Publication No. 2000-66425 discloses a photosensitive layer including a hardened positive hole charge transport material having two or more chain polymerizing functional groups in the same molecule. The photosensitive layer has a high hardness because the crosslinked bond density can be increased. However, since the bulky positive hole charge transport material has two or more chain polymerizing functional groups, the hardened positive hole charge transport material has a distortion therein and an inner stress increases, resulting in crack and peeling of the crosslinked surface layer when used for long periods.

Because of these reasons, a need exists for an image forming method using a photoreceptor having stable electrical properties, wherein the abrasion of a photosensitive layer thereof due to repeated image formation for long periods is inhibited.

### SUMMARY OF THE INVENTION

Accordingly, an object of the present invention is to provide an image forming method and an image forming apparatus using an electrophotographic photoreceptor capable of forming images having an ultra high resolution not less than 1,200 dpi and up to 2,400 dpi, and stably producing high-quality images with high durability.

Another object of the present invention is to provide an image forming method using a photoreceptor having stable electrical properties, wherein the abrasion of a photosensitive layer thereof due to repeated image formation for long periods is inhibited.

A further object of the present invention is to provide an image forming method wherein defective images such as blurred images, toner filming and black spots due to repeated image formation for long periods are inhibited.

These objects and other objects of the present invention, either individually or collectively, have been satisfied by the discovery of an image forming method comprising:

charging an electrophotographic photoreceptor comprising:
an electroconductive substrate;
a photosensitive layer located overlying the electroconductive substrate; and
a crosslinked surface layer located overlying the photosensitive layer;

irradiating the electrophotographic photoreceptor with imagewise light to form an electrostatic latent image thereon;

developing the electrostatic latent image with a toner to form a toner image on the electrophotographic photoreceptor;.

transferring the toner image onto a transfer material; and

fixing the toner image on the transfer material,

wherein the photosensitive layer is sensitive to light having a wavelength of from 400 to 450 nm, and the crosslinked surface layer is formed by crosslinking and hardening a radical polymerizing monomer having three or more functional groups without a charge transport structure and a radical polymerizing compound having one functional group with charge transport structure.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating a cross-section of a layer embodiment of the electrophotographic photoreceptor of the present invention;

FIG. 2 is a schematic view illustrating a cross-section of another layer embodiment of the electrophotographic photoreceptor of the present invention;

FIG. 3 is a schematic view illustrating a cross-section of a further layer embodiment of the electrophotographic photoreceptor of the present invention;

FIG. 4 is a schematic view illustrating a cross-section of another layer embodiment of the electrophotographic photoreceptor of the present invention;

FIG. 5 is a schematic view illustrating a cross-section of a further layer embodiment of the electrophotographic photoreceptor of the present invention;

FIG. 6 is a schematic view illustrating an embodiment of the image forming apparatus of the present invention; and

FIG. 7 is a schematic view illustrating an embodiment of the process cartridge of the present invention.

### DETAILED DESCRIPTION OF THE INVENTION

The present invention provides an image forming method using a photoreceptor having stable electrical properties, wherein the abrasion of a photosensitive layer thereof due to repeated image formation for long periods is inhibited.

When the crosslinked surface layer is not abraded at all, a low-resistivity material due to ozone and NOx causing image quality deterioration accumulates, and therefore a minimum abrasion thereof is necessary to remove the low-resistivity material. Since the crosslinked surface layer of the present invention is quite slightly abraded, high quality images can be produced without toner filming and blurred images. In addition, the crosslinked surface layer is so smooth and exquisite that the layer has a few or no point defect.

Organic materials used for photoreceptors typically have a permittivity of from 2 to 10, and when a crosslinked surface layer including rutile type titanium oxide having a permittivity of about 110 is layered on a photosensitive layer, a difference of the permittivity between the crosslinked surface layer and the photosensitive layer is not less than a one-digit level. Therefore, when the thickness of the crosslinked surface layer changes due to abrasion, the capacitance largely varies, resulting in unstable image quality. However, since the crosslinked surface layer of the present invention does not include a filler having a large permittivity, images without an adverse effect of the capacitance variation can be produced. In addition, the photoreceptor of the present invention unexpectedly can produce dot images having a resolution not less than 1,200 dpi without dot distortion even after repeatedly used. The reason of this is not clarified yet, but it is thought that the photoreceptor does not include the filler having a large permittivity, which is supposed to distort an electrical flux line of a latent image. Even a filler having comparatively a small permittivity, when leaving from the layer during repeated use, abrades the photoreceptor. However, since the crosslinked surface layer of the present invention does not include a filler having a small permittivity, either, this is avoidable.

The smooth and exquisite crosslinked surface layer of the present invention having quite few pin holes and scratch resistance produce nondefective images.

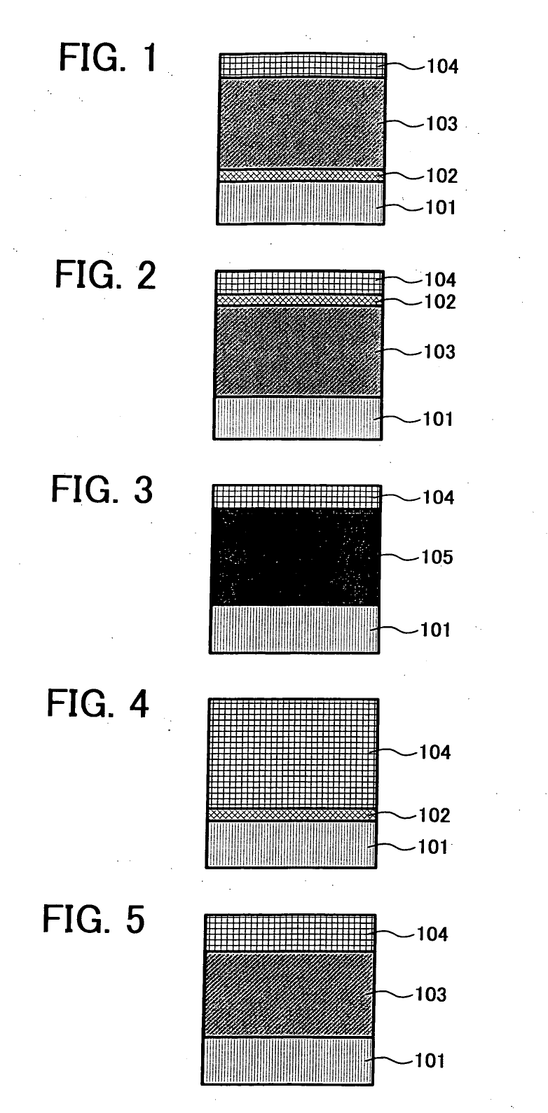

The photosensitive layer of the electrophotographic photoreceptor for use in the present invention includes, as shown in FIG. 1, a charge generation layer 102 formed on an electroconductive substrate 101 and a charge transport layer 103 formed thereon. In addition, a crosslinked surface layer 104 is formed on the charge transport layer 103. An intermediate layer is not shown in FIGS. 1 to 5.

When the photosensitive layer has this composition, the crosslinked surface layer and the charge transport layer are required to have a sufficient light transmission for a writing light source. More specifically, the crosslinked surface layer and the charge transport layer preferably have a light transmission not less than 50% for monochromatic light having a wavelength of from 390 to 460 nm. In addition, the thickness of the crosslinked surface layer and the charge transport layer are preferably as thin as possible such that a charge generated in the charge generation layer does not scatter in the process of moving through the charge transport layer and the crosslinked surface layer, which impairs formation of high-resolution images. The crosslinked surface layer preferably has a thickness of from 1 to 10 μm, and more preferably from 2 to 8 μm to have high durability. The charge transport layer preferably has a thickness of from 5 to 15 μm, depending on the development conditions, though.

The charge transport material (CTM) includes a positive hole CTM and a electron CTM. When the CTM is used in the charge transport layer (CTL), either or both thereof may be used. When the crosslinked surface layer includes the CTM, the crosslinked surface layer preferably includes the same CTM as that of the CTL. Further, the crosslinked surface layer can double as the CTL as shown in FIG. 4. In this case, the crosslinked surface layer preferably has a thickness of from 10 to 17 μm.

The photoreceptor for use in the present invention also includes, as shown in FIG. 2, a CTL 103 formed on an electroconductive substrate 101, a charge generation layer (CGL) 102 formed thereon and a crosslinked surface layer 104 formed on the CGL. When the photosensitive layer has this composition, the crosslinked surface layer is required to have a sufficient light transmission for a writing light source. In addition, the thickness of the crosslinked surface layer is preferably as thin as possible such that a charge generated in the CGL does not scatter in the process of moving through the crosslinked surface layer, which impairs formation of high-resolution images. The crosslinked surface layer preferably has a thickness of from 1 to 10 μm, and more preferably from 2 to 8 μm to have high durability. The CTL does not need to be so thin as the CTL in FIG. 1, and preferably has a thickness of from 5 to 25 μm.

When the crosslinked surface layer includes the CTM, the crosslinked surface layer preferably includes a CTM different from that in the CTL. When the CTL includes both of the positive hole CTM and the electron CTM, the crosslinked surface layer preferably includes both of them as well. Alternatively, the crosslinked surface layer is preferably designed to have a proper function depending on a charged polarity of the photoreceptor. Specifically, when negatively charged, the crosslinked surface layer preferably includes the positive hole CTM, when positively charged, crosslinked surface layer preferably includes the electron CTM.

Further, the photoreceptor for use in the present invention also includes, as shown in FIG. 3, a layer 105 including a CTM and a charge generation material (CGM), which is formed on an electroconductive substrate 101, and a crosslinked surface layer 104 formed on the layer 105. When the photosensitive layer has this composition, the crosslinked surface layer is required to have a sufficient light transmission for a writing light source. In addition, the thickness of the crosslinked surface layer is preferably as thin as possible such that a carrier generated in the CGL does not scatter in the process of moving through the crosslinked surface layer, which impairs formation of high-resolution images. The crosslinked surface layer preferably has a thickness of from 1 to 10 μm, more preferably from 2 to 8 μm, and furthermore preferably from 2 to 5 μm to have high durability. The layer 105 does not need to be so thin as the CTL in FIG. 1, and preferably has a thickness of from 5 to 25 μm.

When the crosslinked surface layer includes the CTM, the crosslinked surface layer preferably includes a CTM different from that in the layer 105. When the layer 105 includes both of the positive hole CTM and the electron CTM, the crosslinked surface layer preferably includes both of them as well. Alternatively, the crosslinked surface layer is preferably designed to have a proper function depending on a charged polarity of the photoreceptor. Specifically, when negatively charged, the crosslinked surface layer preferably includes the positive hole CTM, when positively charged, the crosslinked surface layer preferably includes the electron CTM.

In addition, the photoreceptor for use in the present invention may include, as shown in FIG. 5, a photosensitive layer wherein the crosslinked surface layer 104 in FIG. 2 doubles as the CGL 102. Since the crosslinked surface layer doubles as the CGL, a charge does not scatter in the process of moving to the surface of the photoreceptor. The crosslinked surface layer can include the positive hole CTM and/or the electron CTM. The crosslinked surface layer preferably has a thickness of from 1 to 10 μm, and more preferably from2 to 8 μm. The CTL preferably has a thickness of from 5 to 25 μm, and more preferably from 10 to 20 μm.

Suitable materials for use as the electroconductive substrate include plates, drums, or foils of metals such as aluminum, nickel, copper, titanium, gold and stainless steel; plastic films evaporated with a material such as aluminum, nickel, copper, titanium, gold, tin oxide; and indium oxide; and films or drums of a material such as papers and plastics which are coated with an electroconductive material. Besides these materials, metals and metal alloys such as iron, silver, zinc, lead, tin, antimony and indium; oxides of these metals; carbon; and electroconductive polymers can be used. As mentioned above, these can directly be formed to substrates or coated on suitable substrates by coating methods, evaporating methods, etching methods or plasma processing methods.

The electroconductive substrate preferably has a surface smoothness of from 0.02 to 1.5 μm when measured by ten-point mean roughness (Rz) method. When less than 0.02 μm, a laser beam scatters less, resulting defective images such as moire, and adherence of the electroconductive substrate to a photosensitive layer is so low that the photosensitive layer peels off therefrom, resulting in defective images having white spots. When greater than 1.5 μm, irregular potentials on the surface of the photosensitive layer cause deterioration of dot reproducibility, and pinholes due to abnormal discharges therein cause defective images having black spots.

An undercoat layer optionally formed on the electroconductive substrate typically includes a resin as a main component. Since a photosensitive layer is typically formed on the undercoat layer by coating a liquid including an organic solvent, the resin in the undercoat layer preferably has good resistance to general organic solvents. Specific examples of such resins include water-soluble resins such as polyvinyl alcohol resins, case in and polyacrylic acid sodium salts; alcohol soluble resins such as nylon copolymers and methoxymethylated nylon resins; and thermosetting resins capable of forming a three-dimensional network such as polyurethane resins, melamine resins, alkyd-melamine resins, epoxy resins and the like. The undercoat layer may include a fine powder of metal oxides such as titanium oxide, silica, alumina, zirconium oxide, tin oxide and indium oxide to prevent occurrence of moire in the recorded images and to decrease residual potential of the photoreceptor. The undercoat layer can also be formed by coating a coating liquid using a proper solvent and a proper coating method similarly to those for use in formation of the photosensitive layer mentioned above. The undercoat layer maybe formed using a silane coupling agent, titanium coupling agent or a chromium coupling agent.

Besides, a layer of aluminum oxide which is formed by an anodic oxidation method and a layer of an organic compound such as polyparaxylylene (parylene) or an inorganic compound such as SiO, SnO₂, TiO₂, ITO or CeO₂ which is formed by a vacuum evaporation method is also preferably used as the undercoat layer. Besides these materials, known materials can be used.

The undercoat layer preferably has a surface smoothness of from 0.02 to 1.5 μm when measured by ten-point mean roughness (Rz) method. When less than 0.02 μm, a laser beam scatters less, resulting defective images such as moiré, and adherence of the electroconductive substrate to a photosensitive layer is so low that the photosensitive layer peels off therefrom, resulting in defective images having white spots. When greater than 1.5 μm, irregular potentials on the surface of the photosensitive layer cause deterioration of dot reproducibility, and pin holes due to abnormal discharges therein cause defective images having black spots.

The undercoat layer preferably includes a fine powder dispersed in a binder resin. The electrophotographic photoreceptor of the present invention is used with a writing light source emitting a laser beam having a short wavelength of from 400 to 450 nm. The laser beam having a short wavelength scatters more than a laser beam having a long wavelength, however, when a transparent intermediate layer is used, the laser beam and reflected beam from the electroconductive substrate or undercoat layer are interfere with each other in the photosensitive layer, resulting in defective images such as moiré. The surface roughness of the substrate or undercoat layer is increased to prevent the moiré, however, the image resolution and dot reproducibility are negatively affected thereby.

In order to solve this problem, a particulate material is effectively dispersed in the undercoat layer to scatter the transmitted light. Therefore, a combination of scattering effects by the surface roughness of the electroconductive substrate or the undercoat layer and the particulate material dispersed therein can produce images having high resolution and quality without abnormal images.

The undercoat layer preferably has a thickness of from 1 to 10 μm. When less than 1 μm, the light scatters insufficiently, resulting on abnormal images such as moiré. When greater than 10 μm, the resultant photoreceptor has a large potential variation due to occurrence and accumulation of residual potential.

The CGL can be formed by coating a coating liquid which is preferably dissolving or dispersing a CGM in an appropriate solvent together with a binder resin if necessary and then drying the coated liquid. As the dispersing method for preparing the charge generation layer coating liquid, ball mills, supersonic dispersing machines, homomixers, etc. can be used. Suitable coating methods include a dipping coating method, a blade coating method, a spray coating method, etc.

When dispersing a CGM, the CGM preferably has a particle diameter not greater than 1 μm, and more preferably not greater than 0.5 μm, in order to improve the dispersibility. However, if the diameter is too small, the CGM is likely to aggregate, resulting in an increase of the resistance of the layer and deterioration of the photosensitivity and the repeat usage properties due to increase of crystal defects. In addition, there is a limit in microlizing the CGM, and therefore the particle diameter is preferably not less than 0.01 μm.

The CGL preferably has a thickness of from 0.1 to 2 μm.

Known materials sensitive to light having a wavelength of from 400 to 450 nm can be used as the CGM, and specific examples thereof include organic pigments such as azo pigments e.g. CI Pigment Blue 25 (Color Index CI 21180), CI Pigment Red 41 (CI 21200), CI Acid Red 52 (CI 45100) , CI Basic Red 3 (CI 45210), azo pigments having a carbazole skeleton (disclosed in Japanese Laid-Open Patent Publication No. 53-95033), azo pigments having a distyrylbenzene skeleton (disclosed in Japanese Laid-Open Patent Publication No. 53-133445), azo pigments having a triphenylamine skeleton (disclosed in Japanese Laid-Open Patent Publication No. 53-132347), azo pigments having a dibenzothiophene skeleton (disclosed in Japanese Laid-Open Patent Publication No. 54-21728), azo pigments having an oxadiazole skeleton (disclosed in Japanese Laid-Open Patent Publication No. 54-12742), azo pigments having a fluorenone skeleton (disclosed in Japanese Laid-Open Patent Publication No. 54-22834), azo pigments having a bisstilbene skeleton (disclosed in Japanese Laid-Open Patent Publication No. 54-17733), azo pigments having a distyrylcarbazole skeleton (disclosed in Japanese Laid-Open Patent Publication No. 54-14967) and azo pigments having a benzanthrone skeleton; phthalocyanine pigments such as CI Pigment Blue 16 (CI 74100), oxotitaniumphthalocyanine, chlorogalliumphthalocyanine and hydroxygalliumphthalocyanine; indigo pigments such as CI Vat Brown5 (CI 73410)and CI Vat Dye (CI 73030); and perylene pigments such as Algo Scarlet B (Bayer), Indanthrene Scarlet R (Bayer), etc. These charge generation materials can be used alone or in combination.

As the solvents used for preparing a coating dispersion or solution for the CGL, for instance, N,N-dimethylformamide, toluene, xylene, monochlorbenzene, 1,2-dichlorethane, 1,1,1-trichlorethane, dichlormethane, 1,1,2-trichlorethane, trichlorethylene, tetrahydrofuran, methyl ethyl ketone, methyl isobutyl ketone, cyclohexanone, ethyl acetate, butyl acetate, dioxane, etc. can be used.

As the binder resins for use in the CGL, any binder resins can be used if they have good insulation properties. For instance, insulative resins made by addition polymerization methods, poly addition methods and polycondensation methods, such as polyethylene, polyvinylbutyral, polyvinylformal, polystyrene resins, phenoxy resins, polypropylene, acrylic resins, methacrylic resins, vinyl chloride resins, vinyl acetate resins, epoxy resins, polyurethane resins, phenolic resins, polyester resins, alkyd resins, polycarbonate resins, polyamide resins, silicon resins and melamine resins; and copolymer resins including 2 or more of the repeated units of these resins, such as vinylchloride-vinylacetate copolymers, styrene-acryl copolymers, and vinylchloride-vinylacetate-maleicanhyderide copolymers; and organic polymer semiconductors, such as poly-N-vinylcarbazole can be used. These binder resins can be used alone or in combination. The content of the binder resin is 0 to 5 parts by weight, and preferably 0.1 to 3 parts by weight per 1 part by weight of the CGM in the CGL.

Known CTLs can be used as the CGL. When the CTL is layered on the CGL, the CGL needs to transmits monochromatic light having a wavelength of from 400 to 450 nm.

Specific examples of a binder resin for use in the CTL include thermoplastic or thermoset resins such as polystyrene, styrene-acrylonitrile copolymers, styrene-butadiene copolymers, styrene-maleic anhydride copolymers, polyester, polyvinyl chloride, vinyl chloride-vinyl acetate copolymers, polyvinylidene chloride, polyarylate, phenoxy resins, polycarbonate, acetylcellulose resins, ethylcellulose resins, polyvinyl butyral, polyvinyl formal, polyvinyl toluene, poly-N-vinylcarbazole,.acrylic resins, silicon resins, epoxy resins, melamine resins, polyurethane resins, phenolic resins and alkyd resins. Among these resins, the resins having the following formulae (1) and/or (2), polymer alloy resins of polyarylate resins or polyarylate resins and polycarbonate resins, and polymer alloy resins of polyarylate resins and polyethylenephthalate resins are preferably used. 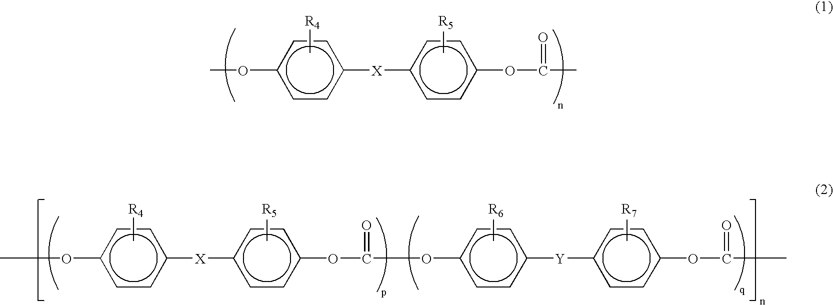
wherein R₄, R₅, R₆ and R₇ independently represent a hydrogen atom, a substituted or an unsubstituted alkyl group, a halogen atom, or a substituted or an unsubstituted aryl group; X represents a divalent group of fatty series or of cyclic fatty series; Y represents a direct bonding, a linear alkylene group, a branched alkylene group, a cyclic alkylene group, —O—, —S—, —SO—, —SO2—, —CO—, —CO—O-Z-O-CO— (Z represents a divalent aliphatic group), or a group having the following formula: 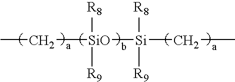
wherein, a is an integer of from 1 to 20; b is an integer of from 1 to 2000; and R₈ and R₉ independently represent a substituted or unsubstituted alkyl group, or a substituted or unsubstituted aryl group; p and q represent a composition (mol fraction), and p from 0.1 to 1, q from 0 to 0.9; and n represents a repeating number and is an integer of from 5 to 5,000.

Specific examples thereof include, but are not limited to, resins having the following formulae.

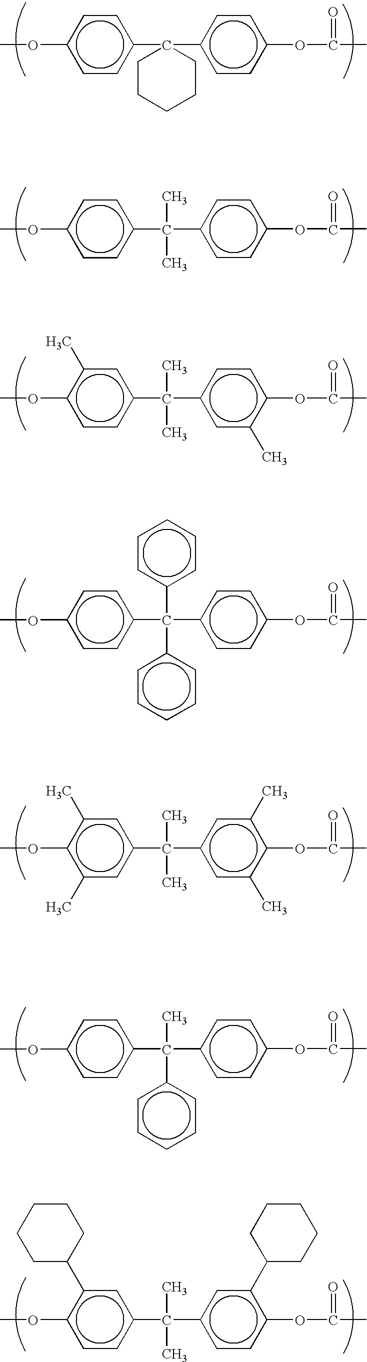

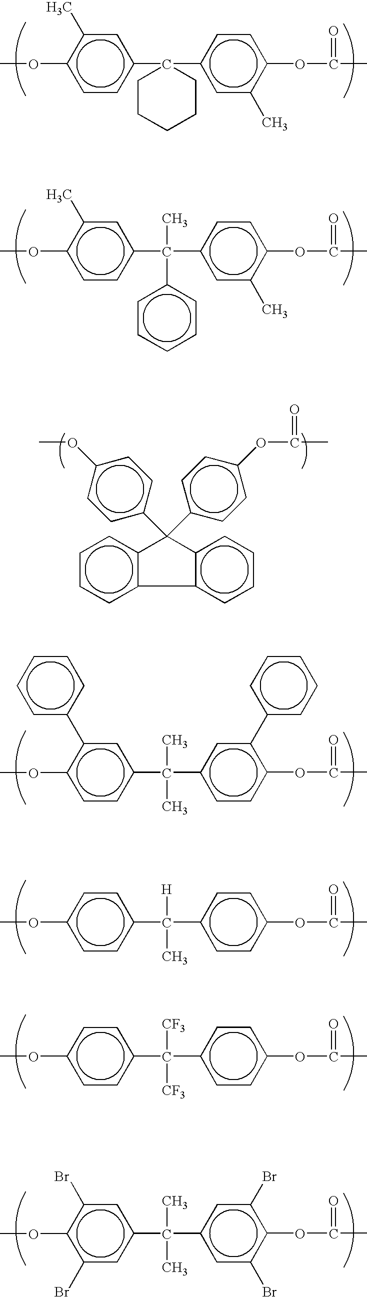

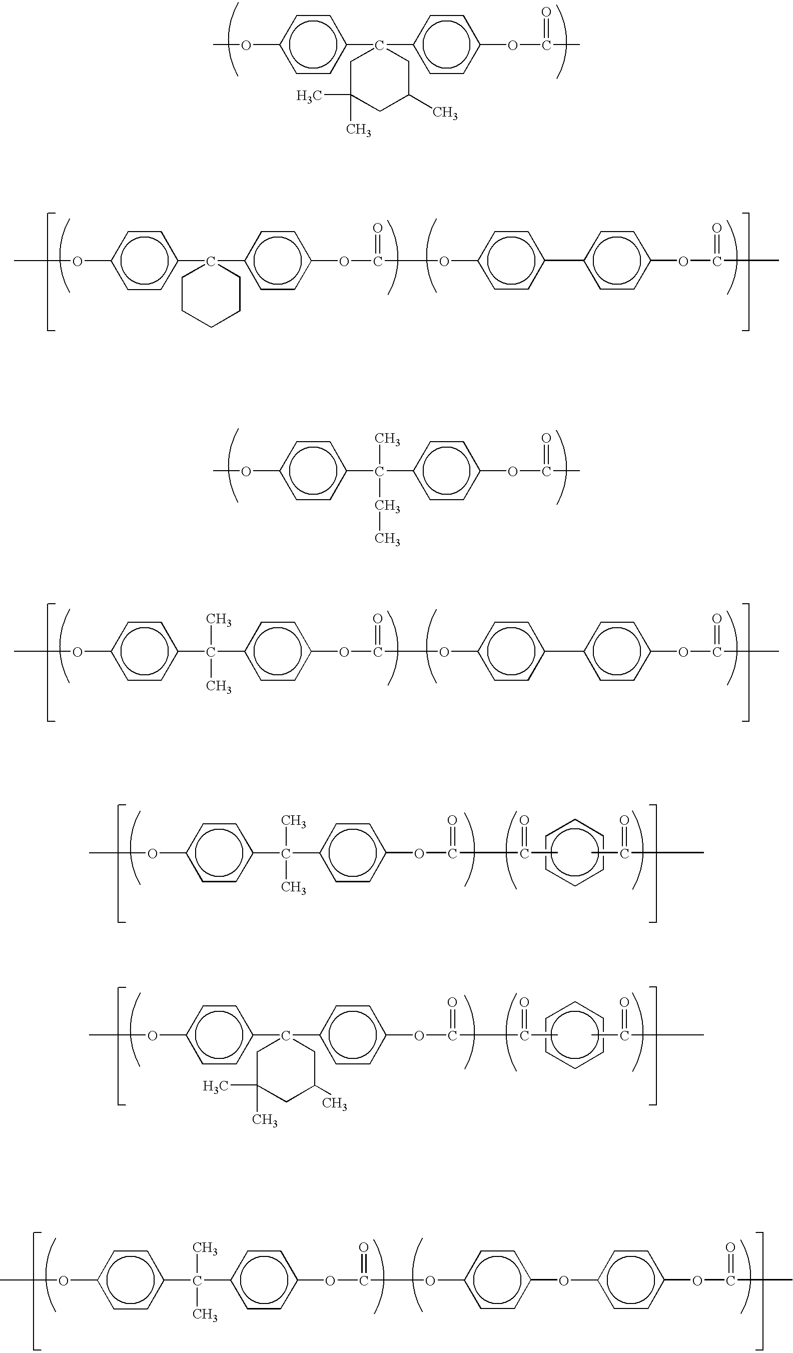

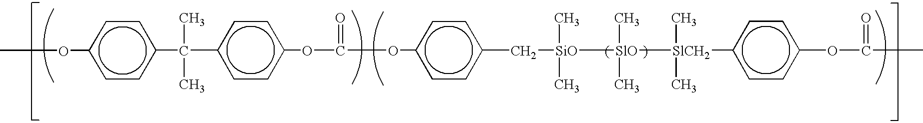

Specific examples of the hole transport materials include poly-N-carbazole and its derivatives, poly-γ-carbazolylethylgultamate and its derivatives, pyrene-formaldehyde condensates and their derivatives, polyvinylpyrene, polyvinylphenanthrene, oxazole derivatives, imidazole derivatives, triphenylamine derivatives and the compounds having one of the following formulae (3) to (20): 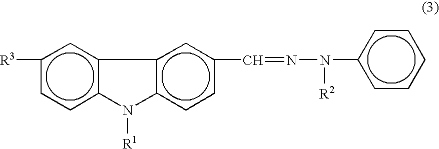
wherein R¹ represents a methyl group, an ethyl group, a 2-hydroxyethyl group or 2-chlorethyl group; R² represents a methyl group, an ethyl group, a benzyl group or a phenyl group; and R³ represents a hydrogen atom, a chlorine atom, a bromine atom, an alkyl group having 1 to 4 carbon atoms, an alkoxy group having 1 to 4 carbon atoms, a dialkylamino group or a nitro group. 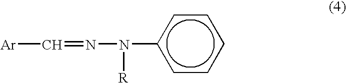
wherein Ar represents a naphthalene ring, an anthracene ring, a pyrene ring, one of their substitution groups, a pyridine ring, a furan ring or a thiophene ring; and R represents an alkyl group, a phenyl group or a benzyl group. 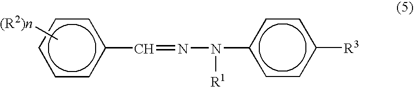
wherein R¹ represents an alkyl group, a benzyl group, a phenyl group or a naphthyl group; R² represents a hydrogen atom, an alkyl group having 1 to 3 carbon atoms, an alkoxy group having 1 to 3 carbon atoms, a dialkylamino group and a diaralkylamino group or a diarylamino group; n represents an integer of from 1 to 4, and each R² can be the same or different from the others when n is 2 or more; and R³ represents a hydrogen atom or a methoxy group. 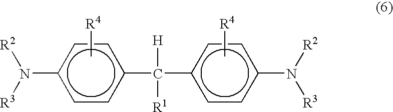
wherein R¹ represents an alkyl group having 1 to 11 carbon atoms, a substituted or unsubstituted phenyl group or a heterocyclic ring group; R² and R³ independently represent a hydrogen atom, an alkyl group having 1 to 4 carbon atoms, a hydroxyalkyl group, a chloralkyl group or a substituted or unsubstituted aralkyl group, and R2 and R3 can be combined to form a heterocyclic ring including a nitrogen atom; and each R4 represents a hydrogen atom, an alkyl group having 1 to 4 carbon atoms, an alkoxy group or a halogen atom. 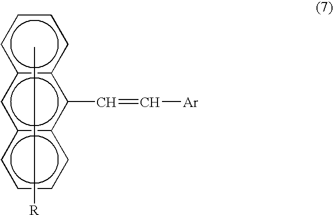
wherein R represents a hydrogen or a halogen atom; and Ar represents a substituted or unsubstituted phenyl group, a naphthyl group and an anthryl group or a carbazolyl group. 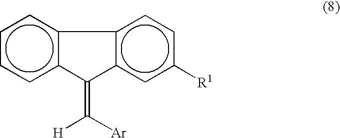
wherein R¹ represents a hydrogen atom, a halogen atom, a cyano group, and an alkoxy group having 1 to 4 carbon atoms or an alkyl group having 1 to 4 carbon atoms; and Ar represents one of the following formulae: 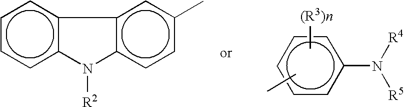
wherein R² represents an alkyl group having 1 to 4 carbon atoms; R³ represents a hydrogen atom, a halogen atom, an alkyl group having 1 to 4 carbon atoms, an alkoxy group having 1 to 4 carbon atoms or a dialkylamino group; n represents 1 or 2 and each R³ can be the same or different from the other when n is 2; and R⁴ and R⁵ independently represent a hydrogen atom, a substituted or unsubstituted alkyl group having 1 to 4 carbon atoms or a substituted or unsubstituted benzyl group. 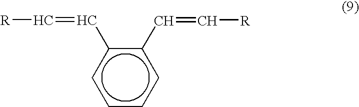
wherein R represents a carbazolyl group, a pyridyl group, a thienyl group, an indolyl group, a furyl group or a substituted or unsubstituted phenyl group, a or a substituted or unsubstituted styryl group, a or a substituted or unsubstituted naphtyl group respectively or a substituted or unsubstituted anthryl group, wherein these substituents are selected from a dialkyl amino group, an alkyl group, an alkoxy group, a carboxyl group or its ester, a halogen atom, a cyano group, an aralkylamino group, an N-alkyl-N-aralkylamino group, an amino group, a nitro group and an acethylamino group. 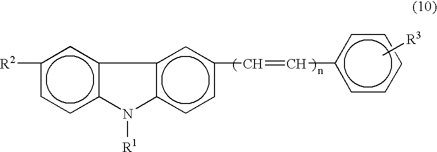
wherein R¹ represents an alkyl group having 1 to 4 carbon atoms, a substituted or unsubstituted phenyl group or benzyl group; R²represents a hydrogen atom, an alkyl group having 1 to 4 carbon atoms, an alkoxy group having 1 to 4 carbon atoms, a halogen atom, a nitro group, an amino group or an amino group substituted by an alkyl group having 1 to 4 carbon atoms or benzyl group; and n is an integer of 1 or 2. 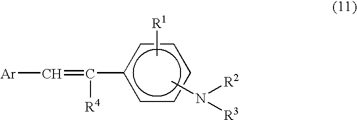
wherein R¹ represents a hydrogen atom, an alkyl group, an alkoxy group or a halogen atom; R² and R³ independently represent an alkyl group, a substituted or unsubstituted aralkyl group or a substituted or unsubstituted aryl group; R⁴ represents a hydrogen atom, an alkyl group having 1 to 4 carbon atoms or a substituted or unsubstituted phenyl group; and Ar represents a substituted or unsubstituted phenyl group or naphthyl group. 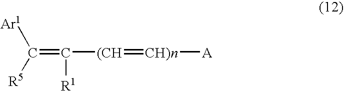
wherein n is 0 or 1; R¹ represents a hydrogen atom, an alkyl group or a substituted or unsubstituted phenyl group; Arl represents a substituted or unsubstituted aryl group; R⁵ represents a substituted or unsubstituted alkyl group including a substituted alkyl group or a substituted or unsubstituted aryl group; A represents 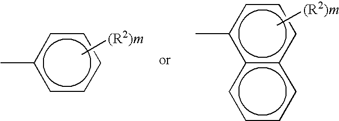
9-anthryl group or a substituted or unsubstituted carbazolyl group; and R2 represents a hydrogen atom, an alkyl group, an alkoxy group, a halogen atom or 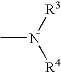
wherein, R³ and R⁴ independently represent an alkyl group, a substituted or unsubstituted aralkyl group or a substituted or unsubstituted aryl group and R⁴ can form a ring; m is an integer of from 1 too 5; and R² can be the same or different from each other when m is 2 or more; and A and R¹ may form a ring when n is 0. 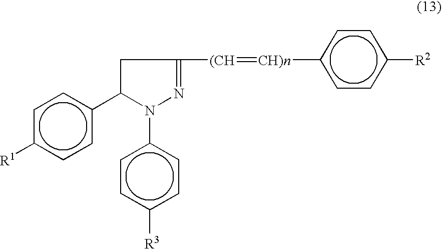
wherein R¹, R² and R³ independently represent a hydrogen atom, an alkyl group having 1 to 4 carbon atoms, an alkoxy group having 1 to 4 carbon atoms, a halogen atom or a dialkylamino group; and n is 0 or 1. 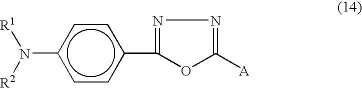
wherein R¹ and R² represent a substituted or unsubstituted alkyl group or a substituted or unsubstituted aryl group; and A represents a substituted amino group, a substituted or unsubstituted aryl group or an allyl group. 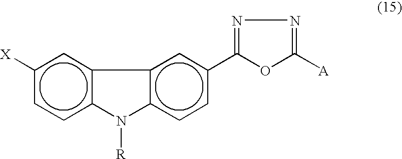
wherein X represents a hydrogen atom, an alkyl group having 1 to 4 carbon atoms or a halogen atom; R represents a substituted or unsubstituted alkyl group or a substituted or unsubstituted aryl group; and A represents a substituted amino group or a substituted or unsubstituted aryl group. 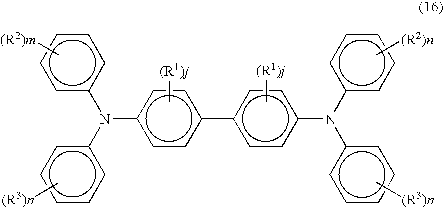
wherein R¹ represents an alkyl group having 1 to 4 carbon atoms, an alkoxy group having 1 to 4 carbon atoms or a halogen atom; R² and R³ independently represent a hydrogen atom, an alkyl group having 1 to 4 carbon atoms, an alkoxy group having 1 to 4 carbon atoms or a halogen atom; and j, m, and n are independently 0 or an integer of from 1 to 4. 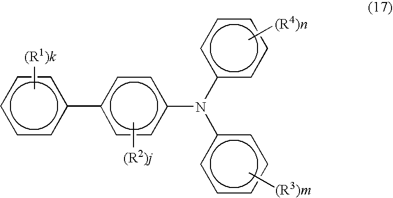
wherein R¹, R³ and R⁴ independently represent a hydrogen atom, an amino group, an alkoxy group, a thioalkoxy group, an aryloxy group, a methylenedioxy group, a substituted or unsubstituted alkyl group, a halogen atom or a substituted or unsubstituted aryl group, and R² represents a hydrogen atom, an alkoxy group, a substituted or unsubstituted alkyl group or a halogen atom, but a case in which R¹, R², R³ and R⁴ are all hydrogen atoms is excluded. k, j, m, and n are independently an integer of from 1 to 4; and R¹, R², R³ and R⁴ can be the same or different from the others when k, j, m, and n ate an integer of from 2 to 4. 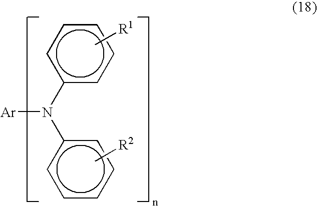
wherein Ar represents a condensation polycyclic hydrocarbon group having 18 or less carbon atoms which can have a substituent; and R¹ and R² independently represent a hydrogen atom, a halogen atom, a substituted or unsubstituted alkyl group, an alkoxy group, or a substituted or unsubstituted phenyl group and n is 1 or 2.
A-CH═CH—Ar—CH═CH-A (19)
wherein Ar represents a substituted or unsubstituted aromatic hydrocarbon group; and A represents 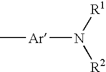
wherein Ar′ represents a substituted or unsubstituted aromatic hydrocarbon group; and R¹ and R² independently represent substituted or unsubstituted alkyl group or a substituted or unsubstituted aryl group. 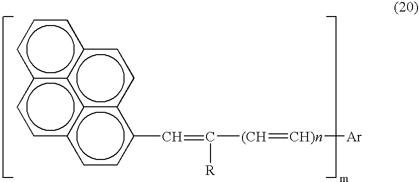
wherein Ar represents a substituted or unsubstituted aromatic hydrocarbon group; R represents a hydrogen atom, a substituted or unsubstituted alkyl group or a substituted or unsubstituted aryl group; n is 0 or 1; m is 1 or 2; and Ar and R may form a ring when n is 0 and m is 1.

Specific examples of the compounds represented by formula (3) include 9-ethylcalbazole-3-aldehyde-1-methyl-1-phenylhydrazone, 9-ethylcalbazole-3-aldehyde-1-benzyl-1-phenylhydrazone, 9-ethylcalbazole-3-aldehyde-1,1-diphenylhydrazone, etc.

Specific examples of the compounds represented by formula (4) include 4-diethylaminostyryl-β-aldehhyde-1-methyl-1-phenylhydrazone, 4-methoxynaphthalene-1-aldehyde-1-benzyl-1-phenylhydrazone, etc.

Specific examples of the compounds represented by formula (5) include 4-methoxybenzaldehyde-1-methyl-1-phenylhydrazone, 2,4-dimethoxybenzaldehyde-1-benzyl-1-phenylhydrazone, 4-diethylaminobenzaldehyde-1,1-diphenylhydrazone, 4-methoxybenzaldehyde-1-(4-methoxy)phenylhydrazone, 4-diphenylaminobenzaldehyde-1-benzyl-1-phenylhydrazone, 4-dibenzylaminobenzaldehyde-1,1-diphenylhydrazone, etc.

Specific examples of the compounds represented by formula (6) include 1,1-bis(4-dibenzylaminophenyl)propane, tris(4-diethylaminophenyl)methane, 1,1-bis(4-dibenzylaminophenyl)propane, 2,2′-dimethyl-4,4′-bis(diethylamino)-triphenylmethane, etc.

Specific examples of the compounds represented by formula (7) include 9-(4-diethylaminostyryl)anthracene, 9-bromo-10-(4-diethylaminostyryl)anthracene, etc.

Specific examples of the compounds represented by formula (8) include 9-(4-dimethylaminobenzylidene)fluorene, 3-(9-fluorenylidene)-9-ethylcarbazole, etc.

Specific examples of the compounds represented by formula (9) include 1,2-bis-(4-diethylaminostyryl)benzene, 1,2-bis(2-,4-dimethoxystyryl)benzene, etc.

Specific examples of the compounds represented by formula (10) include 3-styryl-9-ethylcarbazole, 3-(4-methoxystyryl)-9-ethylcarbazole etc.

Specific examples of the compounds represented by formula (11) include 4-diphenylaminostilbene, 4-dibenzylaminostilbene, 4-ditolylaminostilbene, 1-(4-iphenylaminostyryl)naphthalene, 1-(4-diethylaminostyryl)naphthalene, etc.

Specific examples of the compounds represented by formula (12) include 4′-diphenylamino-α-phenylstilbene, 4′-bis(4-methylphenyl)amino-α-phenylstilbene, etc.

Specific examples of the compounds represented by formula (13) include 1-phenyl-3-(4-diethylaminostyryl)-5-(4-diethylaminophenyl)pyrazoline, etc.

Specific examples of the compounds represented by formula (14) include 2,5-bis(4-diethylaminophenyl)-1,3,4-oxadiazole, 2-N,N-diphenylamino-5-(4-diethylaminophenyl)-1,3,4-oxadiazole, 2-(4-dimethylaminophenyl)-5-(4-diethylaminophenyl)-1,3,4-oxadiazole, etc.

Specific examples of the compounds represented by formula (15) include 2-N,N-diphenylamino-5-(N-ethylcarbazole-3-yl)-1,3,4-oxadiazole, 2-(4-diethylaminophenyl)-5-(N-ethylcarbazole-3-yl)-1,3,4-oxadiazole, etc.

Specific examples of the benzidine compounds represented by formula (16) include N,N′-diphenyl-N,N′-bis(3-methylphenyl)-[1,1′-biphenyl]-4,4′-diamine, 3,3′-dimethyl-N,N,N′,N′-tetrakis(4-methylphenyl)-[1,1′-biphenyl]-4,4′-diamine, etc.

Specific examples of the biphenylamine compounds represented by formula (17) include 4′-methoxy-N,N-diphenyl-[1,1′-biphenyl]-4-amine,4′-methyl-N,N-bis(4-methylphenyl)-[1,1′-biphenyl]-4-amine, 4′-methoxy-N,N-bis(4-methylphenyl)-[1,1′-biphenyl]-4-amine, N,N-bis(3,4-dimethylphenyl)-[1,1′-biphenyl]-4-amine, etc.

Specific examples of the triarylamine compounds represented by formula (18) include 1-diphenylaminopyrene, 1-di(p-tolylamino)pyrene, N,N-di(p-tolyl)-1-naphthylamine, N,N-di(p-tolyl)-1-phenanthorylamine, 9,9-dimethyl-2-(di-p-tolylamino)fluorene, N,N,N′,N′-tetrakis(4-methylphenyl)-phenanthrene-9,10-diamine, N,N,N′,N′-tetrakis(3-methylphenyl)-m-phenylenediamine, etc.

Specific examples of the diolefin aromatic compounds represented by formula (19) include 1,4-bis(4-diphenylaminostyryl)benzene, 1,4-bis[4-di(p-tolyl)aminostyryl]benzene, etc.

Specific examples of the styrylpyrene compounds represented by formula (20) include 1-(4-diphenylaminostyryl)pyrene, 1-[4-di(p-tolyl)aminostyryl]pyrene, etc.

Specific examples of the electron transport materials include chloranil, bromoanil, tetracyanoethylene, tetracyanoquinodimethane, 2,4,7-trinitro-9-fluorenone, 2,4,5,7-tetranitro-9-fluorenone, 2,4,5,7-tetranitroxanthone, 2,4,8-trinitrothioxanthone, 2,6,8-trinitro-indeno[1,2-b]thiophene-4-one, and 1,3,7-trinitrodibenzothiophene-5,5-dioxide, etc. In addition, electron transport materials represented by the following formula (21) or (22) is preferably used. 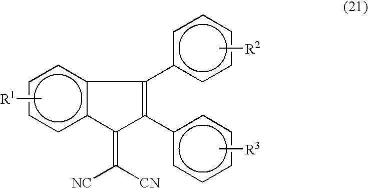
wherein R¹, R² and R³ independently represent a hydrogen atom, a halogen atom, a substituted or unsubstituted alkyl group, an alkoxy group or a substituted or unsubstituted phenyl group. 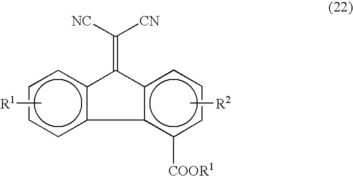
wherein R¹, R² and R³ independently represent a hydrogen atom, a halogen atom, a substituted or unsubstituted alkyl group, an alkoxy group or a substituted or unsubstituted phenyl group.

These charge transport materials can be used alone or in combination.

The CTL of the photoreceptor for use in the present invention can include a charge transport polymer material. Specific examples thereof include, but are not limited to, poly-N-carbazole derivatives, poly-γ-carbazolylethylglutamate derivatives, pyrene-formaldehyde condensate derivatives, polyvinylpyrene, polyvinylphenanthrene, oxazole derivatives, imidazole derivatives, acetophenone derivatives (disclosed in Japanese Laid-Open Patent Publication No. 7-325409), distyrylbenzene derivatives, diphenethylbenzene derivatives (disclosed in Japanese Laid-Open Patent Publication No. 9-127713), α-phenylstilbene derivatives (disclosed in Japanese Laid-Open Patent Publication No. 9-297419), butadiene derivatives (disclosed in Japanese Laid-Open Patent Publication No. 9-80783), hydrogenated butadiene (disclosed in Japanese Laid-Open Patent Publication No. 9-80784), diphenylcyclohexane derivatives (disclosed in Japanese Laid-Open Patent Publication No. 9-80772), distyryltriphenylamine derivatives (disclosed in Japanese Laid-Open Patent Publication No. 9-222740), diphenyldistyrylbenzene derivatives (disclosed in Japanese Laid-Open Patent Publications Nos. 9-265197 and 9-265201), stilbene derivatives (disclosed in Japanese Laid-Open Patent Publication No. 9-211877), m-phenylenediamine derivatives (disclosed in Japanese Laid-Open Patent Publications Nos. 9-304956 and 9-304957), resorcin derivatives (disclosed in Japanese Laid-Open Patent Publication No. 9-329907) and triarylamine derivatives (disclosed in Japanese Laid-Open Patent Publications Nos. 64-9964, 7-199503, 8-176293, 8-208820, 8-253568, 8-269446, 3-221522, 4-11627, 4-183719, 4-124163, 4-320420, 4-316543, 5-310904, 7-56374 and 8-62864; and U.S. Pat. Nos. 5,428,090 and 5,486,439). These CTMs can be used alone or in combination.

Specific examples thereof include, but are not limited to, homopolymers, random copolymers, alternating copolymers and block copolymers having the following formulae P1 to P27.

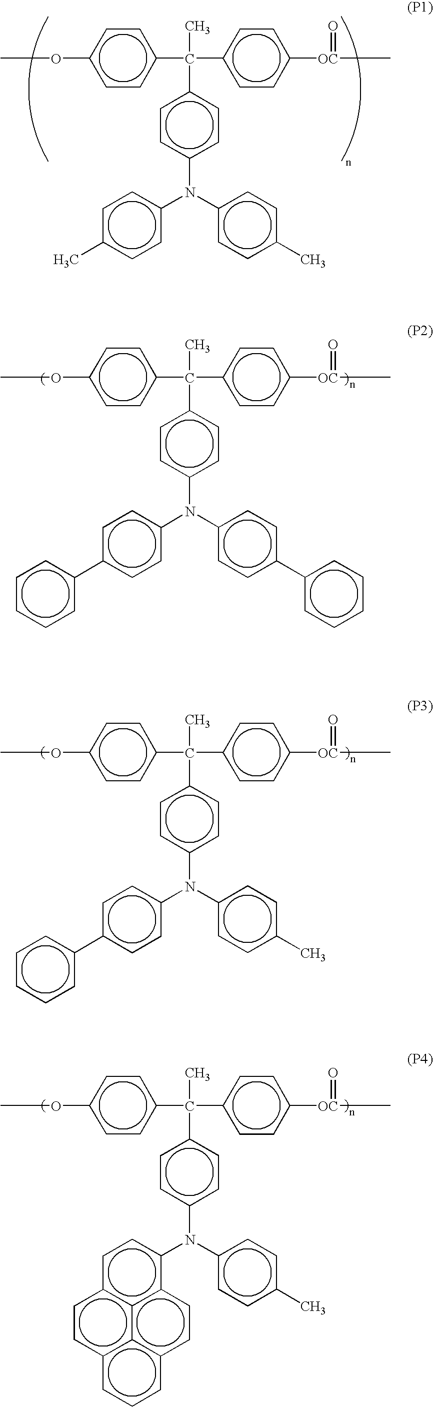

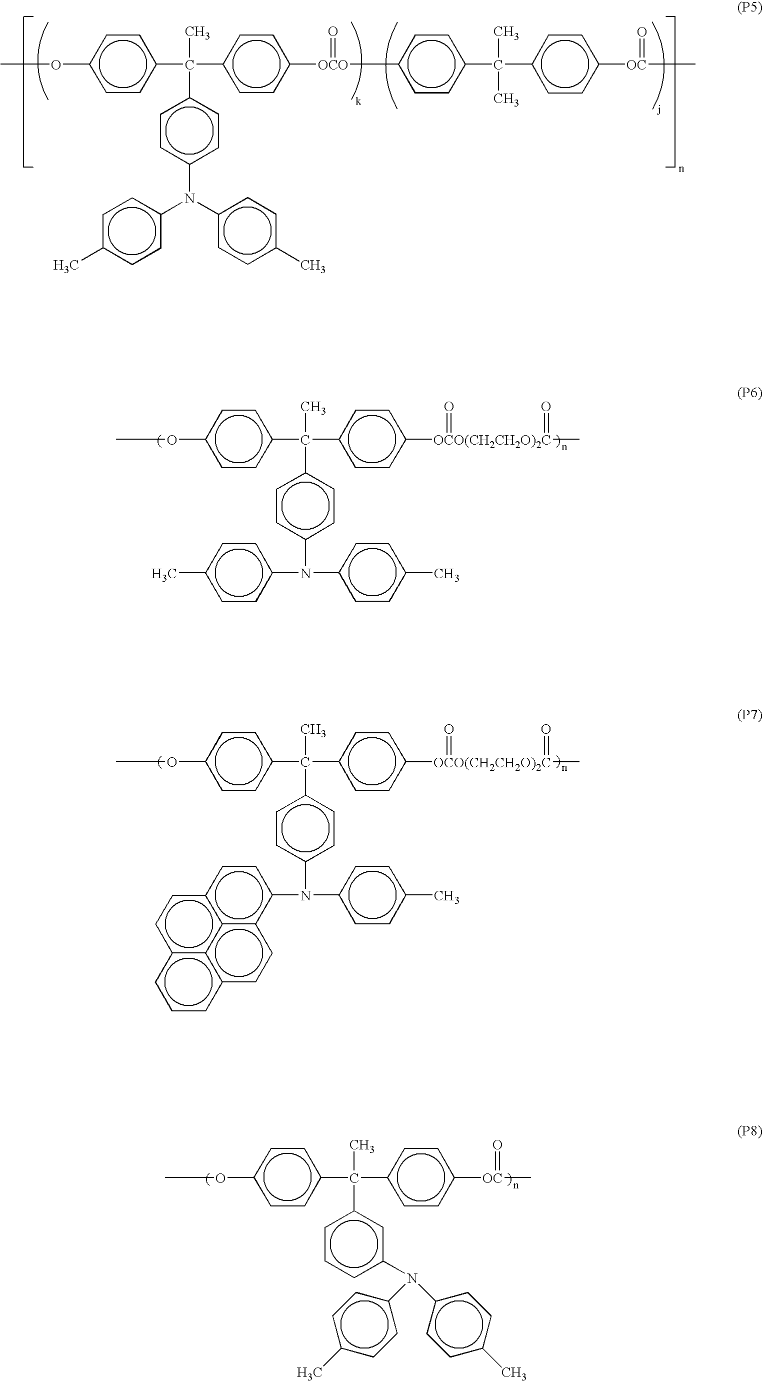

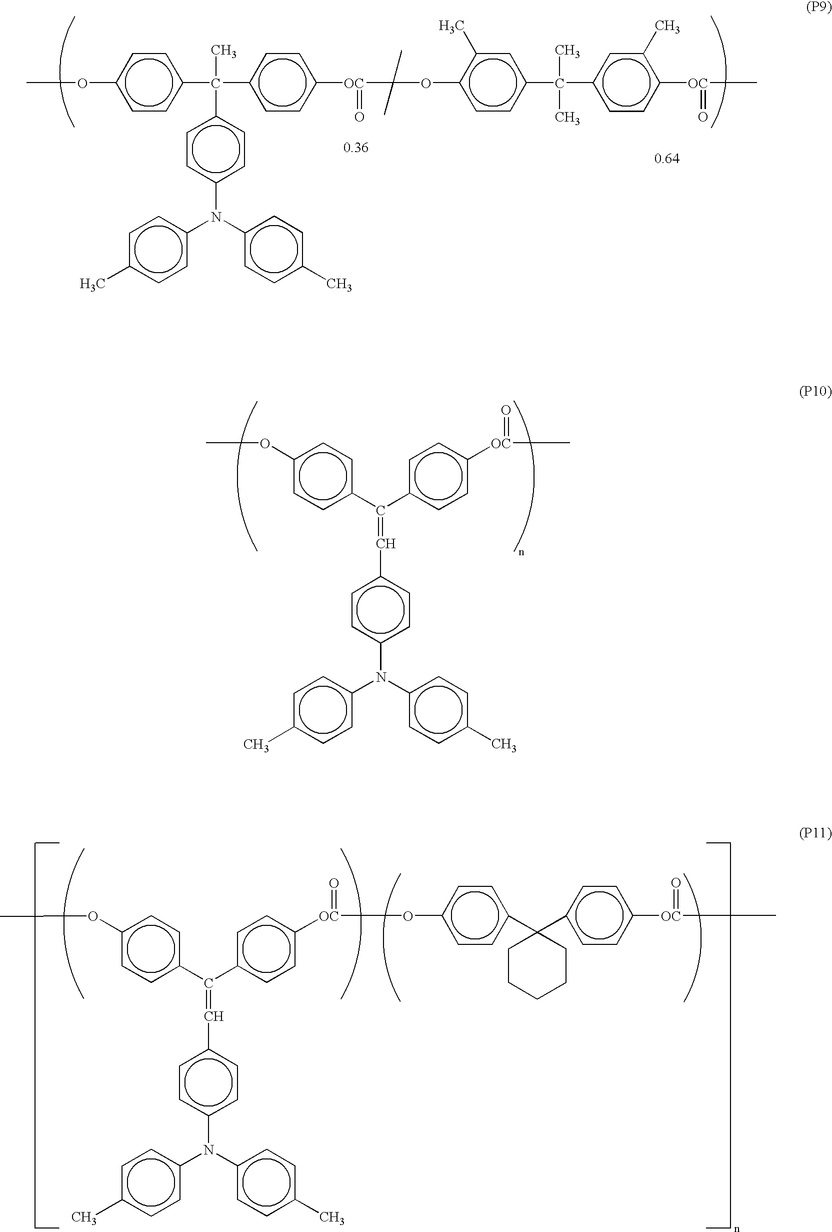

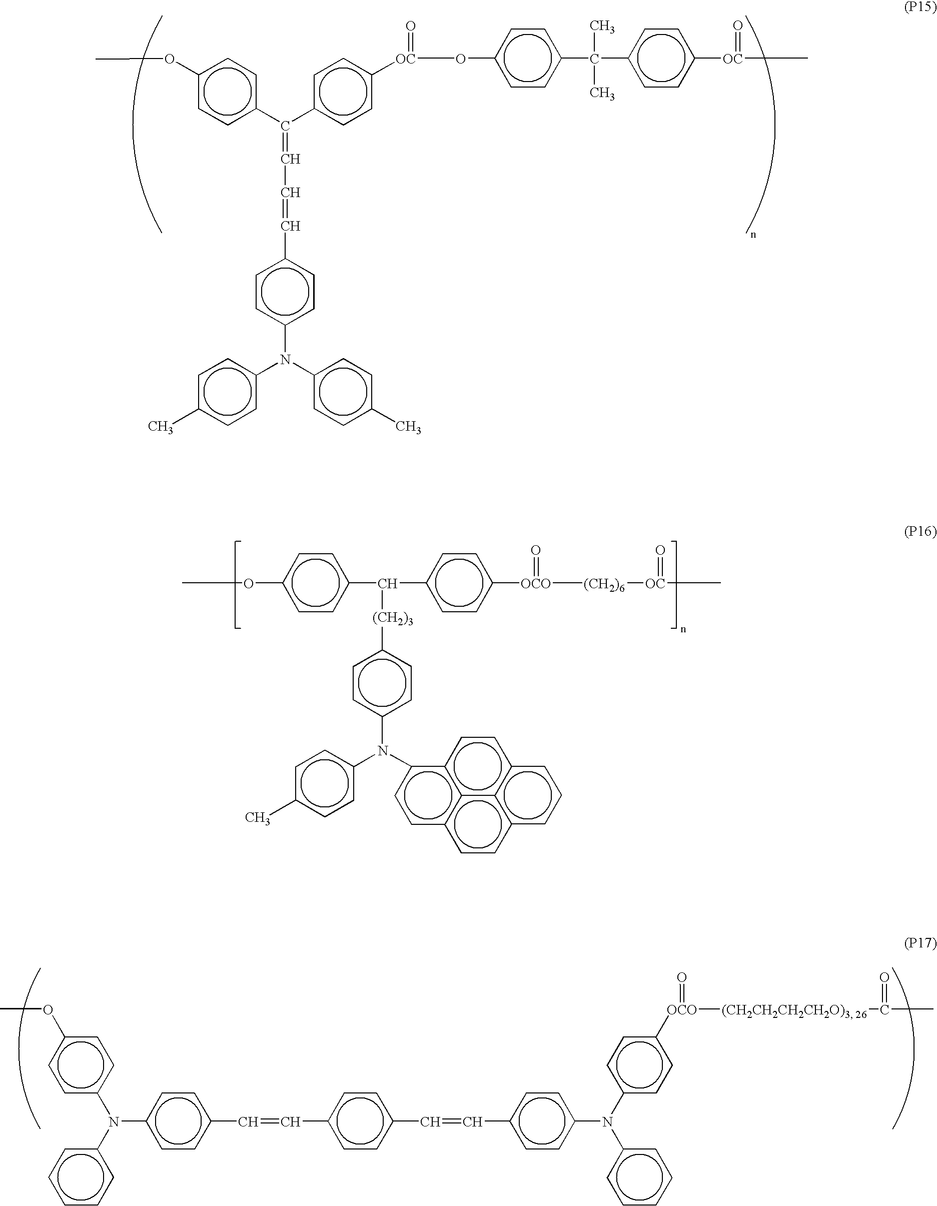

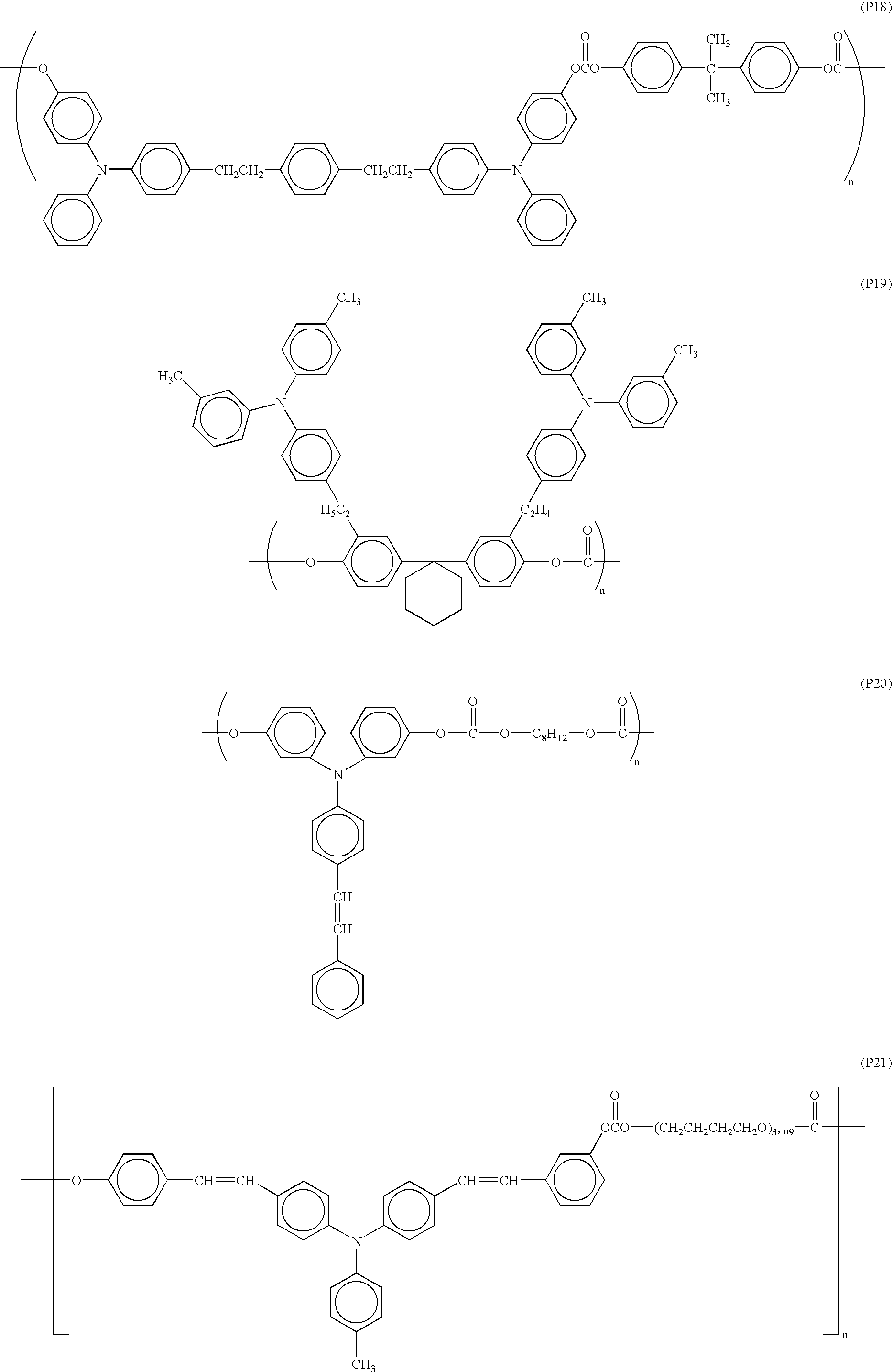

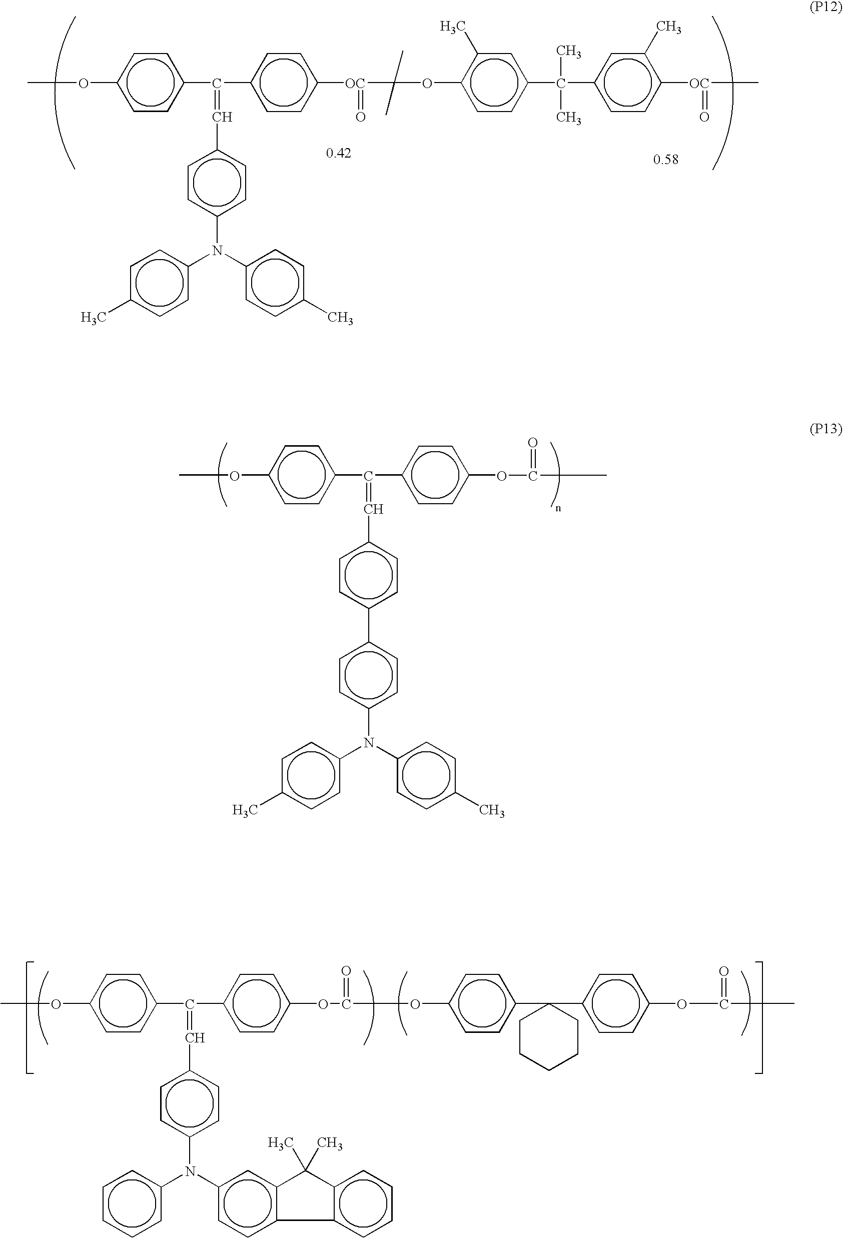

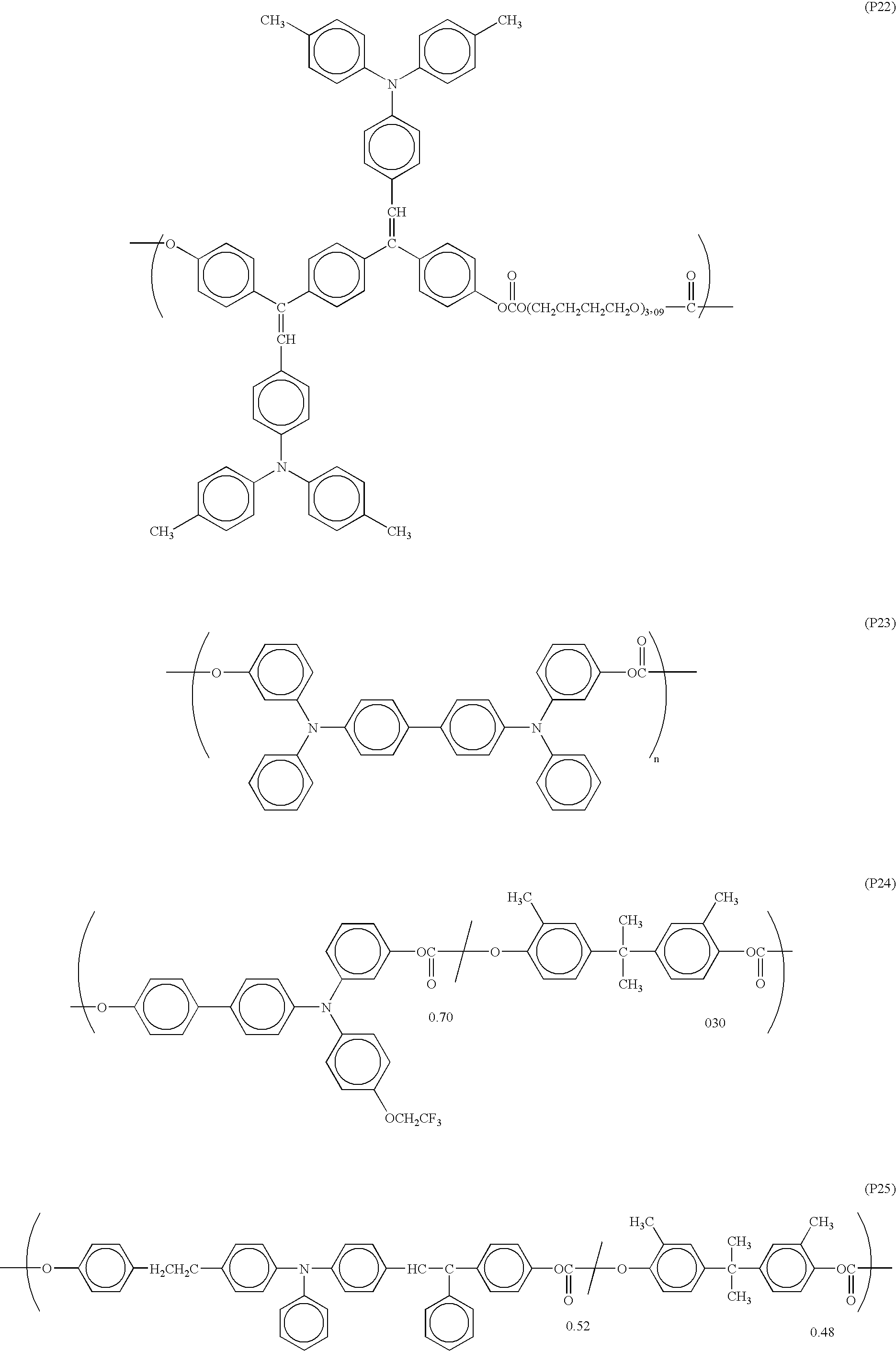

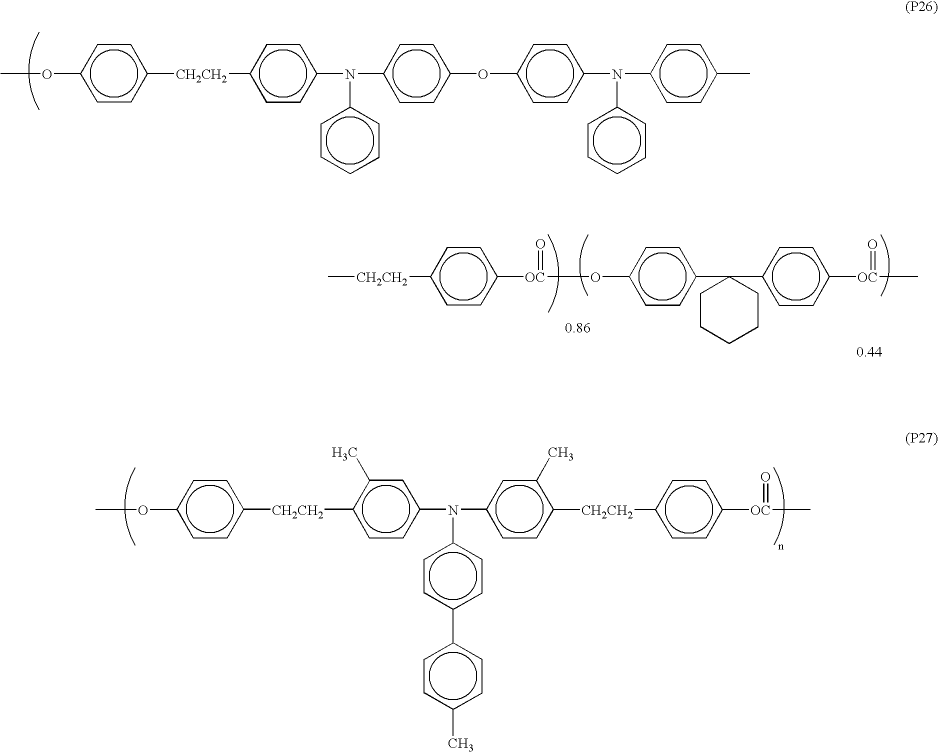

The content of the CTM in the CTL is from 20 to 300 parts by weight, and preferably from 40 to 150 parts by weight, per 100 parts by weight of the binder resin included in the charge transport layer. Specific examples of the solvents used for forming the CTL include tetrahydrofuran, dioxane, toluene, dichloromethane, monochlorobenzene, dichloroethane, cyclohexanone, methyl ethyl ketone, acetone, etc.

When the crosslinked surface layer overlies a single-layered photosensitive layer, the photosensitive layer can be formed by coating and drying a liquid wherein a CGM having a charge generation function, a CTM having a charge transport function and a binder resin are dispersed or dissolved in a proper solvent. The photosensitive layer may optionally includes an additive such as plasticizers and leveling agents. As a method of dispersing CGMs, CTMs, plasticizers and leveling agents, the method mentioned in the above CGL and CTL can be used. Besides the binder resins mentioned in the above CTL, the binder resins in the above CGL can be mixed therewith. In addition, the above-mentioned charge transport polymer material can effectively be used to prevent components of the lower photosensitive layer from mixing in the crosslinked surface layer.

The single-layered photosensitive layer preferably includes a CGM in an amount of from 1 to 30% by weight, a binder resin of from 20 to 80% by weight and a CTM of from 10 to 70 parts by weight based on total weight thereof.

When a photosensitive layer is a crosslinked surface layer combined with a CGL and a CTL, the crosslinked surface layer can include a low-molecular-weight CTM.

The low-molecular-weight CTM includes positive hole transport materials and electron transport materials.

Specific examples of the electron transport materials include electron accepting materials such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitro-xanthone, 2,4,8-trinitrothioxanthone, 2,6,8-trinitro-4H-indeno[1,2-b]thiophene-4-one, 1,3,7-trinitrobenzothiophene-5,5-dioxide, diphenoquinone derivatives, etc. These electron transport materials can be used alone or in combination.

Specific examples of the positive hole transport materials include electron donating materials such as oxazole derivatives, oxadiazole derivatives, imidazole derivatives, monoarylamines derivatives, diarylamine derivatives, triarylamine derivatives, stilbene derivatives, α-phenylstilbene derivatives, benzidine derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, bisstilbene derivatives, enamine derivatives, and other known materials. These positive hole transport materials can be used alone or in combination.

The crosslinked surface layer formed above the CTL needs not to absorb monochromatic light having a wavelength of from 400 to 450 nm.

When the crosslinked surface layer is formed with a hardening resin, various crosslinking reactions such as radical polymerization, ion polymerization, heat polymerization photo polymerization and irradiation-induced polymerization can be used. In the present invention, the radical polymerization using heat and/or light is preferably used.

A CTM is crosslinked in the crosslinked surface layer to have charge transportability. Details of this will be mentioned later.

In addition, materials having a silicone structure, a perfluoroalkyl structure or a long-chain alkyl structure may be crosslinked in the crosslinked surface layer to have low surface energy by methods disclosed in Japanese Laid-Open Patent Publications Nos. 11-95474 and 2000-131860.

Japanese Laid-Open Patent Publications Nos. 8-20226, 11-212398, 11-219087, 11-311928, 2000-047523, 2000-098838 and 2000-147946 disclose methods of controlling abrasion resistance of photoreceptors, wherein polymer lubricants including zinc stearate, silicone oil, fluorinated oil and fluorine are coated on and/or applied to the surface of a photoreceptor to form an ultra thin layer thereon such that the photoreceptor has low surface energy and abrasion, and produces high-quality images.

The photoreceptor of the present invention having a crosslinked surface layer as an outermost layer, formed by coating and hardening a coating liquid including a radical polymerizing monomer having three or more functional groups without a charge transport structure and a radical polymerizing compound having one functional group with charge transport structure, has high durability and produces high-quality images for long periods.

This is because the photoreceptor of the present invention includes a radical polymerizing monomer having three or more functional groups in the surface layer, which develops a three-dimensional network therein and a highly-hardened crosslinked surface layer having quite a high cross linked density is formed, resulting in a high abrasion resistance. When only radical polymerizing monomers having one and two functional groups are used, the crosslinked density is thin in the crosslinked layer and the resultant photoreceptor does not have a significant abrasion resistance. When the crosslinked surface layer includes a polymer material, development of the three-dimensional network is impaired and crosslinked density deteriorates, and therefore the resultant photoreceptor does not have sufficient abrasion resistance. Further, the polymer material is not soluble with a hardened material produced from a reaction of a radical polymerizing composition (a radical polymerizing monomer having three or more functional groups without a charge transporting structure, a radical polymerizing compound having one functional group with a charge transporting structure and a reactive silicone compound having a radical polymerizing functional group, a local abrasion arises from a phase separation, resulting in a scratch on the surface of the resultant photoreceptor.

To form the crosslinked surface layer of the present invention, in addition to the radical polymerizing monomer having three or more functional groups, the radical polymerizing compound having one functional group with a charge transporting structure and reactive silicone compound having a radical polymerizing functional group are included therein, and these are hardened at the same time to form a crosslinking bond having a high hardness and improve durability of the resultant photoreceptor. Further, since the crosslinked layer includes the radical polymerizing compound having one functional group with a charge transporting structure, the resultant photoreceptor has stable electrical properties for long periods. On the contrary, when a low-molecular-weight charge transport material without a functional group is included in the crosslinked surface layer, the low-molecular-weight charge transport material separates out and becomes clouded because of the low solubility, and mechanical strength of the crosslinked surface layer deteriorates. When a charge transport material having two or more functional groups, although they are fixed with plural bondings in the crosslinked structure, a distortion arises in a hardening resin because the charge transporting structure is extremely bulky and an internal stress in the crosslinked surface layer increases, and therefore the resultant photoreceptor frequently has a crack and a scratch due to a carrier adherence. Further, since the charge transport material having two or more functional groups are fixed with plural bondings in the crosslinked structure, an intermediate structure (cation radical) when a charge is transported cannot stably be maintained, resulting in deterioration of sensitivity due to a charge trap and increase of a residual potential. This deterioration of electrical properties results in deterioration of image density and thinner character images.

Further, the crosslinked surface layer preferably has a surface roughness Rz not greater than 1 μm. When Rz is greater than 1 μm, a microscopic toner is liable to scrape through a cleaning blade, resulting in background fouling and stripe images. In addition, the layer is too thick to wear, and a paper powder adhered to a convexity thereof, an oxidizing gas from a charger and depleted materials cannot sufficiently be removed, resulting in production of distorted and swollen images.

The radical polymerizing monomer having three or more functional groups without a charge transporting structure for use in the present invention represents a monomer which has neither a positive hole transport structure such as triarylamine, hydrazone, pyrazoline and carbazole nor an electron transport structure such as condensed polycyclic quinone, diphenoquinone, a cyano group and an electron attractive aromatic ring having a nitro group, and has three or more radical polymerizing functional groups. Specific examples of the radical polymerizing functional groups include (1) 1-substituted ethylene, i.e., vinyl groups combined with substituents such as aromatic rings, olefin groups such as styrene and isoprene, carbonyl groups such as vinyl ketone and acrylic derivatives, cyano groups such as acrylonitrile and thioether groups such as vinyl sulfide; (2) 1,1-di-substituted olefin such as vinylidene chloride, fluorinated vinylidene, ester methacrylate, methacrylamide and α-ester cyanoacrylate; (3) specific 1, 2-di-substituted olefin such as vinylene carbonate, maleimide derivatives and difluoromethylene; and (4) conjugated diene compounds such as butadiene and isoprene, and these may be mixed with heterogeneous substituents. Among these radical polymerizing functional groups, the acrylate and methacrylate are effectively used.

Specific examples of the radical polymerizing monomer having three or more functional groups without a charge transporting structure include, but are not limited to, trimethylolpropanetriacrylate (TMPTA), trimethylolpropanetrimethacrylate, HPA-modified trimethylolpropanetriacrylate, EO-modified trimethylolpropanetriacrylate, PO-modified trimethylolpropanetriacrylate, caprolactone-modified trimethylolpropanetriacrylate, HPA-modified trimethylolpropanetrimethacrylate, pentaerythritoltriacrylate, pentaerythritoltetraacrylate (PETTA), glyceroltriacrylate, ECH-modified glyceroltriacrylate, EO-modified glyceroltriacrylate, PO-modified glyceroltriacrylate, tris(acryloxyethyl)isocyanurate, dipentaerythritolhexaacrylate (DPHA), caprolactone-modified dipentaerythritolhexaacrylate, dipentaerythritolhydroxypentaacrylate, alkyl-modified dipentaerythritolpentaacrylate, alkyl-modified dipentaerythritoltetraacrylate, alkyl-modified dipentaerythritoltriacrylate, dimethylolpropanetetraacrylate (DTMPTA), pentaerythritolethoxytetraacrylate, 2,2,5,5-tetrahydroxymethylcyclopentanonetetraacrylate. These can be used alone or in combination.

The radical polymerizing monomer having three or more functional groups without a charge transporting structure for use in the present invention preferably has a ratio of the molecular weight to the number of functional groups (molecular weight/number of functional groups) in the monomer not greater than 250. The crosslinked surface layer preferably includes the radical polymerizing monomer having three or more functional groups without a charge transporting structure in an amount of from 20 to 80% by weight, and more preferably from 30 to 70% by weight. When less than 20% by weight, a three-dimensional crosslinked bonding density of the crosslinked surface layer is insufficient, and the abrasion resistance thereof does not remarkably improve more than a layer including a conventional thermoplastic resin. When greater than 80%byweight, a content of a charge transporting compound lowers and electrical properties of the resultant photoreceptor deteriorates. Although it depends on a required abrasion resistance and electrical properties, in consideration of a balance therebetween, a content of the radical polymerizing monomer having three or more functional groups without a charge transporting structure is most preferably from 30 to 70% by weight based on total weight of the crosslinked surface layer.

The radical polymerizing compound having one functional group with a charge transporting structure for use in the present invention is a compound which has a positive hole transport structure such as triarylamine, hydrazone, pyrazoline and carbazole or an electron transport structure such as condensed polycyclic quinone, diphenoquinone, a cyano group and an electron attractive aromatic ring having a nitro group, and has a radical polymerizing functional group. Specific examples of the radical polymerizing functional group include the above-mentioned radical polymerizing monomers, and particularly the acryloyloxy groups and methacryloyloxy groups are effectively used. In addition, a triarylamine structure is effectively used as the charge transport structure. Further, when a compound having the following formula (23) or (24), electrical properties such as a sensitivity and a residual potential are preferably maintained. 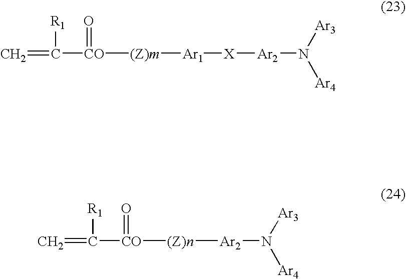
wherein R₁ represents a hydrogen atom, a halogen atom, a substituted or an unsubstituted alkyl group, a substituted or an unsubstituted aralkyl group, a substituted or an unsubstituted aryl group, a cyano group, a nitro group, an alkoxy group, —COOR₇ wherein R₇ represents a hydrogen atom, a halogen atom, a substituted or an unsubstituted alkyl group, a substituted or an unsubstituted aralkyl group and a substituted or an unsubstituted aryl group and a halogenated carbonyl group or CONR₈R₉ wherein R₈ and R₉ independently represent a hydrogen atom, a halogen atom, a substituted or an unsubstituted alkyl group, a substituted or an unsubstituted aralkyl group and a substituted or an unsubstituted aryl group; Ar₁ and Ar₂ independently represent a substituted or an unsubstituted arylene group; Ar₃ and Ar₄ independently represent a substituted or an unsubstituted aryl group; X represents a single bond, a substituted or an unsubstituted alkylene group, a substituted or an unsubstituted cycloalkylene group, a substituted or an unsubstituted alkylene ether group, an oxygen atom, a sulfur atom and vinylene group; Z represents a substituted or an unsubstituted alkylene group, a substituted or an unsubstituted alkylene ether group and alkyleneoxycarbonyl group; and m and n represent 0 and an integer of from 1 to 3.

In the formulae (23) and (24), Ar₃ and Ar₄ independently represent a substituted or an unsubstituted aryl group, and specific examples thereof include condensed polycyclic hydrocarbon groups, non-condensed cyclic hydrocarbon groups and heterocyclic groups.

The condensed polycyclic hydrocarbon group is preferably a group having 18 or less carbon atoms forming a ring such as a fentanyl group, a indenyl group, a naphthyl group, an azulenyl group, a heptalenyl group, a biphenylenyl group, an As-indacenyl group, a fluorenyl group, an acenaphthylenyl group, a praadenyl group, an acenaphthenyl group, a phenalenyl group, a phenantolyl group, an anthryl group, a fluoranthenyl group, an acephenantolylenyl group, an aceanthrylenyl group, a triphenylel group, a pyrenyl group, a crycenyl group and a naphthacenyl group.

Specific examples of the non-condensed cyclic hydrocarbon groups and heterocyclic groups include monovalent groups of monocyclic hydrocarbon compounds such as benzene, diphenylether, polyethylenediphenylether, diphenylthioether, and diphenylsulfone; monovalent groups of non-condensed hydrocarbon compounds such as biphenyl, polyphenyl, diphenylalkane, diphenylalkene, diphenylalkine, triphenylmethane, distyrylbenzene, 1,1-diphenylcycloalkane, polyphenylalkane and polyphenylalkene; and monovalent groups of ring gathering hydrocarbon compounds such as 9,9-diphenylfluorene.

Specific examples of the heterocyclic groups include monovalent groups such as carbazole, dibenzofuran, dibenzothiophene, oxadiazole and thiadiazole.

The substituted or unsubstituted aryl group represented by Ar₃ and Ar₄ may include the following substituents:

(1) a halogen atom, a cyano group and a nitro group;

(2) a straight or a branched-chain alkyl group having 1 to 12, preferably from 1 to 8, and more preferably from 1 to 4 carbon atoms, and these alkyl groups may further include a fluorine atom, a hydroxyl group, a cyano group, an alkoxy group having 1 to 4 carbon atoms, a phenyl group or a halogen atom, an alkyl group having 1 to 4 carbon atoms or a phenyl group substituted by an alkoxy group having 1 to 4 carbon atoms. Specific examples of the alkyl groups include methyl groups, ethyl groups, n-butyl groups, i-propyl groups, t-butyl groups, s-butyl groups, n-propyl groups, trifluoromethyl groups, 2-hydroxyethyl groups, 2-ethoxyethyl groups, 2-cyanoethyl groups, 2-methocyethyl groups, benzyl groups, 4-chlorobenzyl groups, 4-methylbenzyl groups, 4-phenylbenzyl groups, etc.

(3) alkoxy groups (—OR₂) wherein R₂ represents an alkyl group specified in (2). Specific examples thereof include methoxy groups, ethoxy groups, n-propoxy groups, I-propoxy groups, t-butoxy groups, s-butoxy groups, I-butoxy groups, 2-hydroxyethoxy groups, benzyloxy groups, trifluoromethoxy groups, etc.

(4) aryloxy groups, and specific examples of the aryl groups include phenyl groups and naphthyl groups. These aryl group may include an alkoxy group having 1 to 4 carbon atoms, an alkyl group having 1 to 4 carbon atoms or a halogen atom as a substituent. Specific examples of the aryloxy groups include phenoxy groups, 1-naphthyloxy groups, 2-naphthyloxy groups, 4-methoxyphenoxy groups, 4-methylphenoxy groups, etc.

(5) alkyl mercapto groups or aryl mercapto groups such as methylthio groups, ethylthio groups, phenylthio groups and p-methylphenylthio groups. 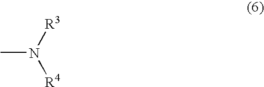
wherein R₃ and R₄ independently represent a hydrogen atom, an alkyl groups specified in (2) and an aryl group, and specific examples of the aryl groups include phenyl groups, biphenyl groups and naphthyl groups, and these may include an alkoxy group having 1 to 4 carbon atoms, an alkyl group having 1 to 4 carbon atoms or a halogen atom as a substituent, and R₃ and R₄ may form a ring together. Specific examples of the groups having this formula include amino groups, diethylamino groups, N-methyl-N-phenylamino groups, N,N-diphenylamino groups, N-N-di(tolyl)amino groups, dibenzylamino groups, piperidino groups, morpholino groups, pyrrolidino groups, etc.

(7) a methylenedioxy group, an alkylenedioxy group such as a methylenedithio group or an alkylenedithio group.

(8) a substituted or an unsubstituted styryl group, a substituted or an unsubstituted β-phenylstyryl group, a diphenylaminophenyl group, a ditolylaminophenyl group, etc. The arylene group represented by Ar₁ and Ar₂ are derivative divalent groups from the aryl groups represented by Ar₃ and Ar₄.

The above-mentioned X represents a single bond, a substituted or an unsubstituted alkylene group, a substituted or an unsubstituted cycloalkylene group, a substituted or an unsubstituted alkylene ether group, an oxygen atom, a sulfur atom and vinylene group.

The substituted or unsubstituted alkylene group is a straight or a branched-chain alkylene group having 1 to 12, preferably from 1 to 8, and more preferably from 1 to 4 carbon atoms, and these alkylene groups may further includes a fluorine atom, a hydroxyl group, a cyano group, an alkoxy group having 1 to 4 carbon atoms, a phenyl group or a halogen atom, an alkyl group having 1 to 4 carbon atoms or a phenyl group substituted by an alkoxy group having 1 to 4 carbon atoms. Specific examples of the alkylene groups include methylene groups, ethylene groups, n-butylene groups, i-propylene groups, t-butylene groups, s-butylene groups, n-propylene groups, trifluoromethylene groups, 2-hydroxyethylene groups, 2-ethoxyethylene groups, 2-cyanoethylene groups, 2-methocyethylene groups, benzylidene groups, phenylethylene groups, 4-chlorophenylethylene groups, 4-methylphenylethylene groups, 4-biphenylethylene groups, etc.

The substituted or unsubstituted cycloalkylene group is a cyclic alkylene group having 5 to 7 carbon atoms, and these alkylene groups may include a fluorine atom, a hydroxyl group, a cyano group, an alkoxy group having 1 to 4 carbon atoms. Specific examples thereof include cyclohexylidine groups, cyclohexylene groups and 3,3-dimethylcyclohexylidine groups, etc.

Specific examples of the substituted or unsubstituted alkylene ether groups include ethylene oxy, propylene oxy, ethylene glycol, propylene glycol, diethylene glycol, tetraethylene glycol and tripropylene glycol, and The alkylene group of the alkylene ether group may include a substituent such as a hydroxyl group, a methyl group and an ethyl group.

The vinylene group has the following formula:

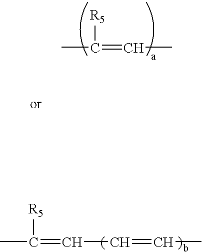

wherein R5 represents a hydrogen atom, an alkyl group (same as those specified in (2)), an aryl group (same as those represented by Ar₃and Ar₄); a represents 1 or 2; and b represents 1, 2 or 3.

Z represents a substituted or an unsubstituted alkylene group, a substituted or an unsubstituted alkylene ether group and alkyleneoxycarbonyl group.

Specific examples of the substituted or unsubstituted alkylene group include those of X.

Specific examples of the substituted or unsubstituted. alkylene ether group include those of X.

Specific examples of the alkyleneoxycarbonyl group include caprolactone-modified groups. Specific examples of the radical polymerizing compound having one functional group with a charge transporting structure include, but are not limited to, compounds having the following formulae Nos. 1 to 160.

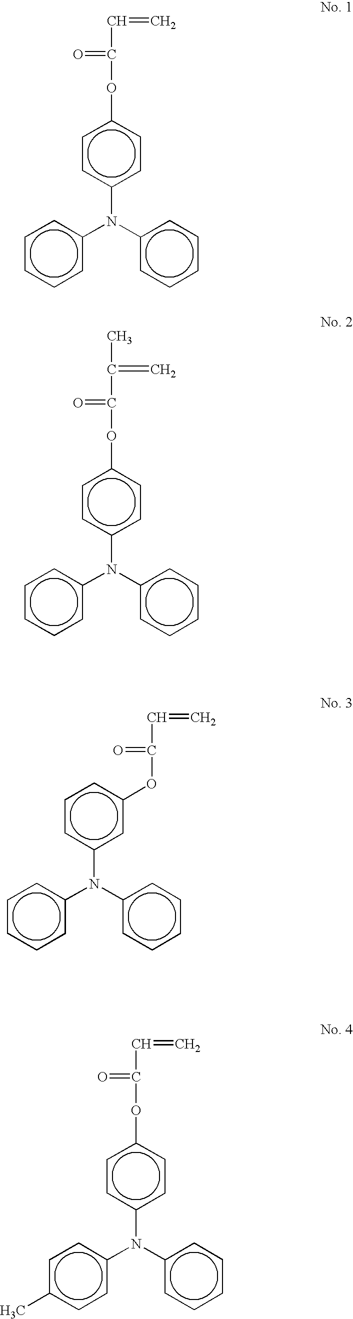

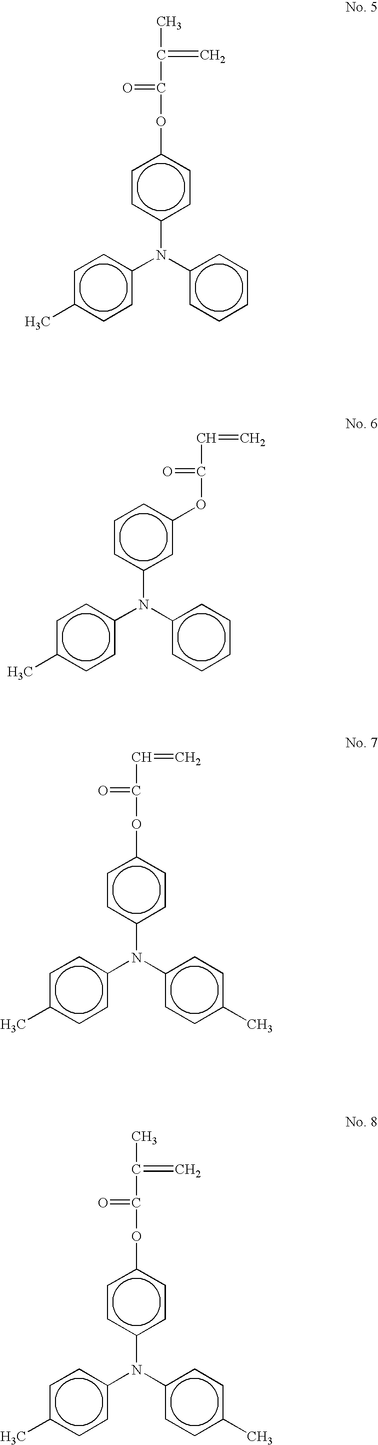

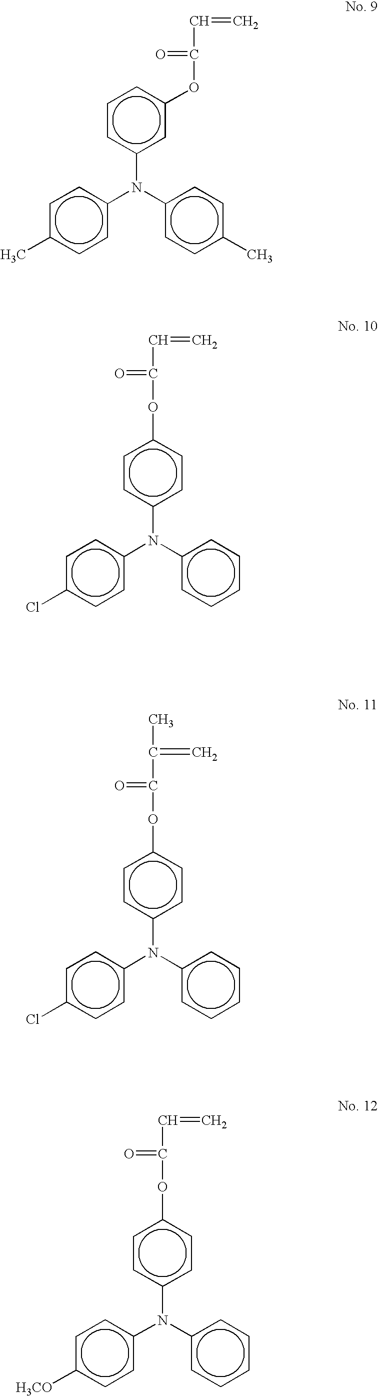

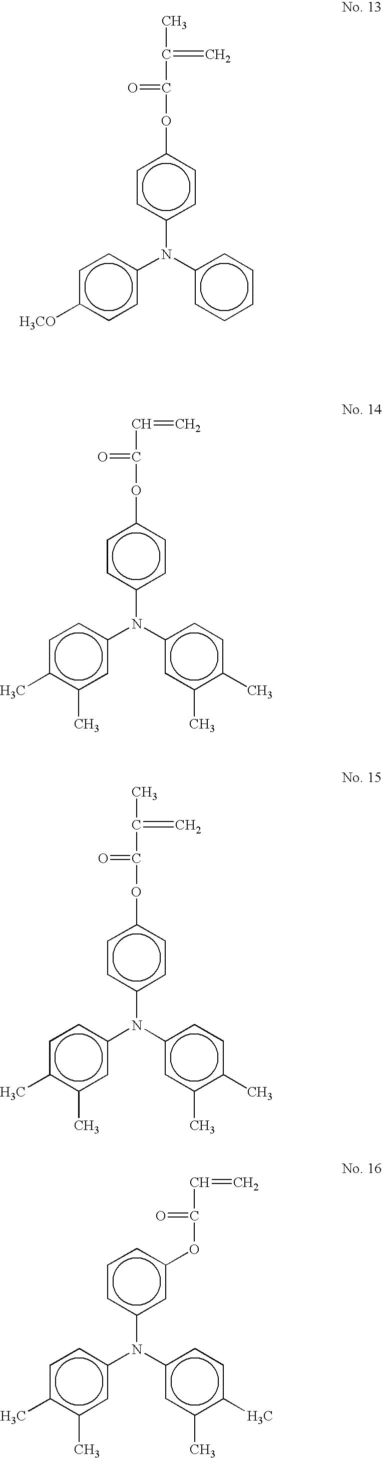

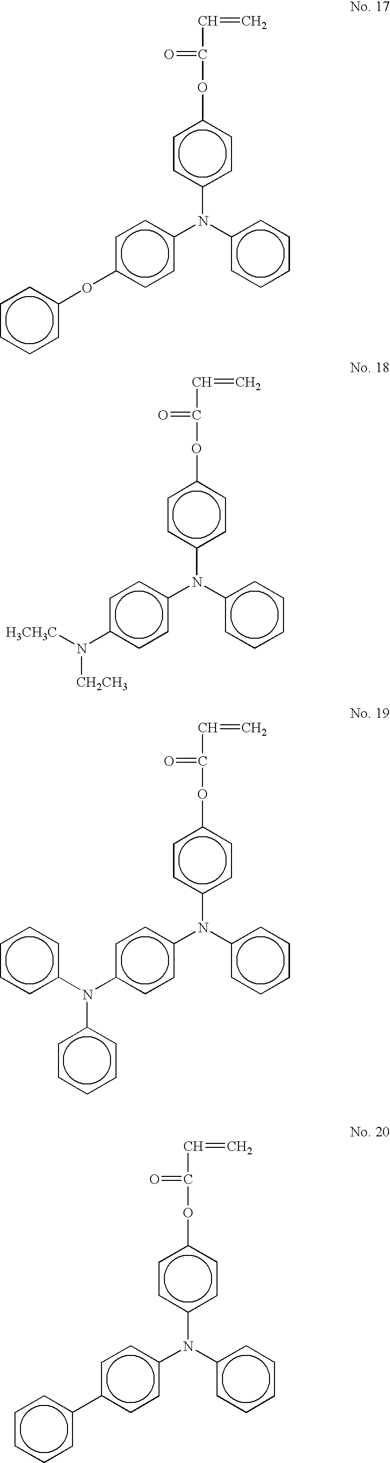

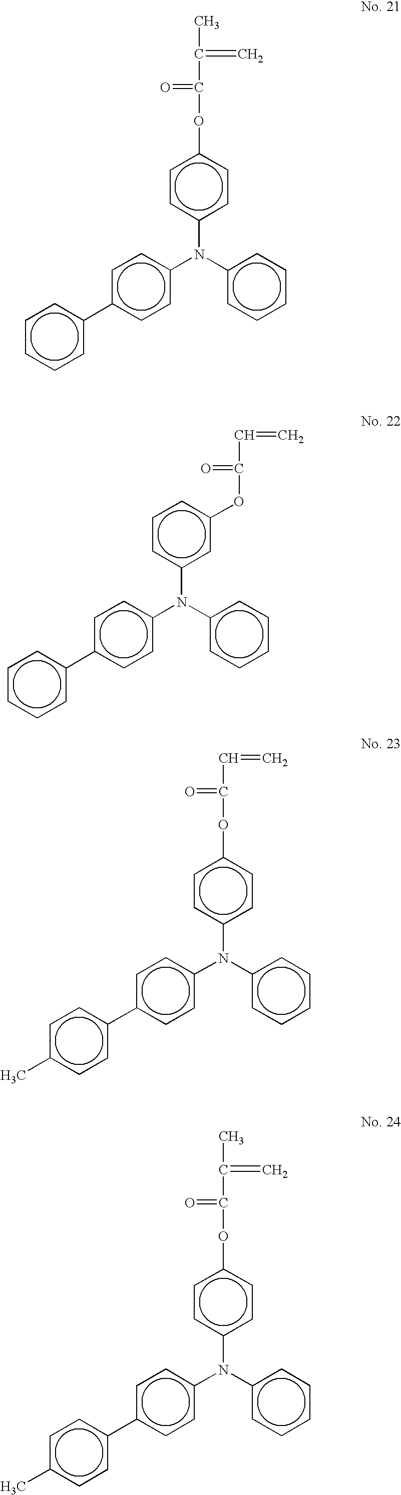

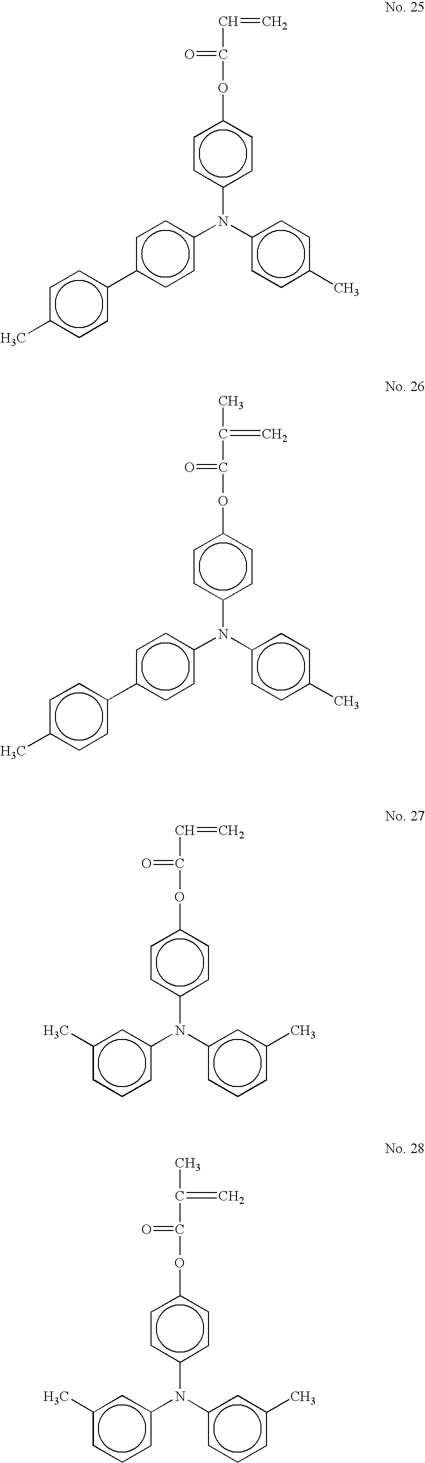

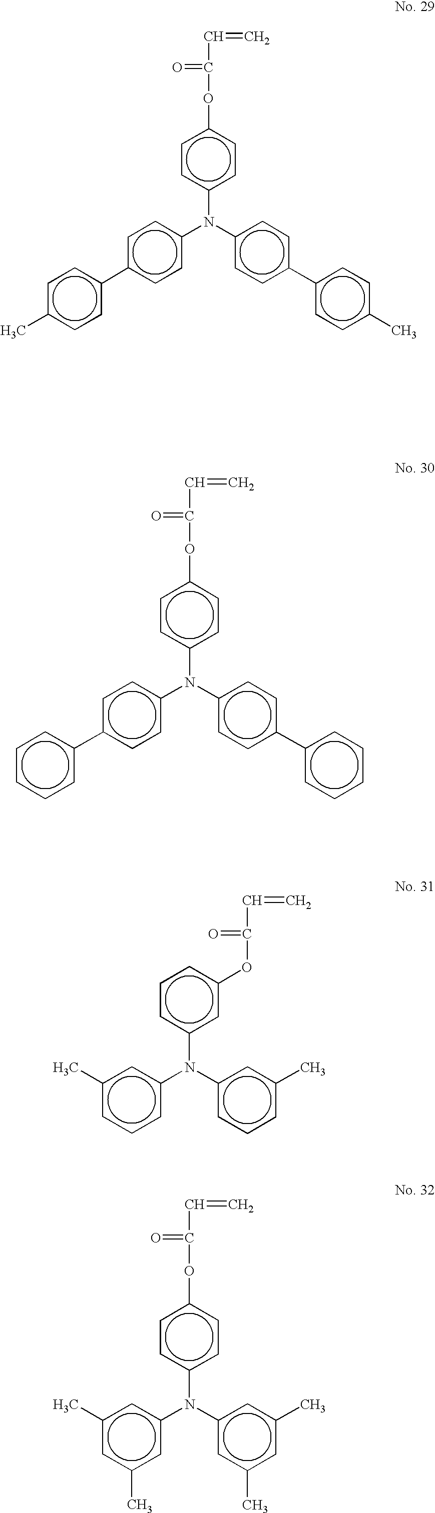

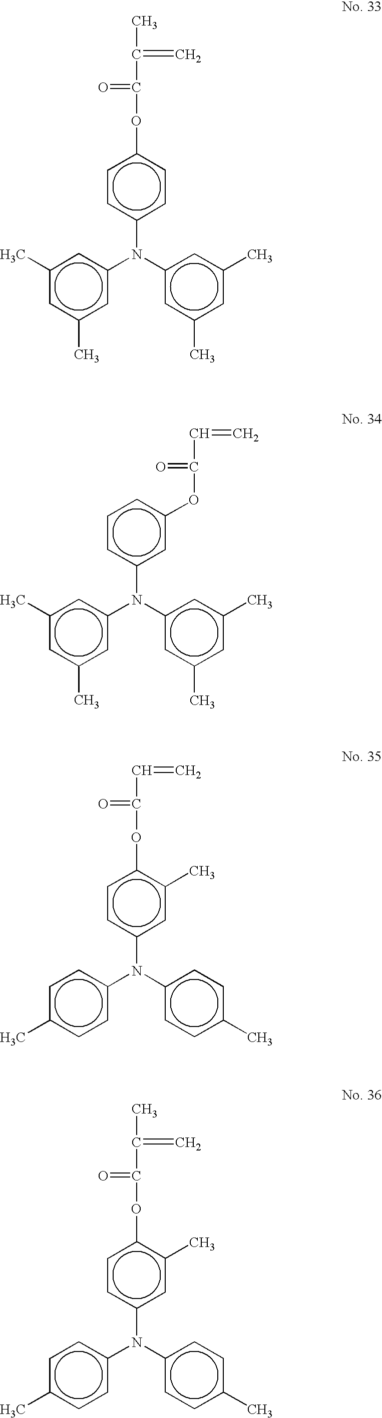

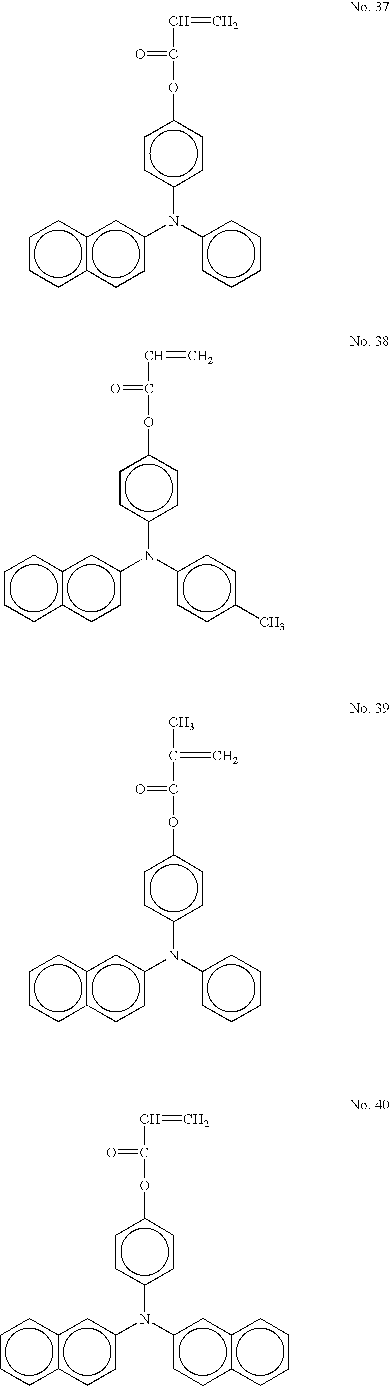

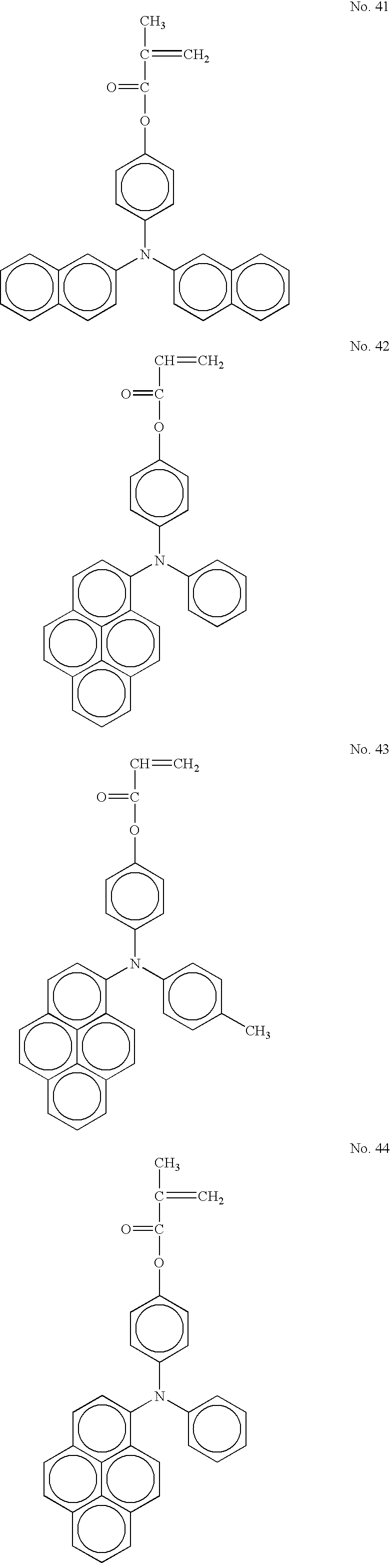

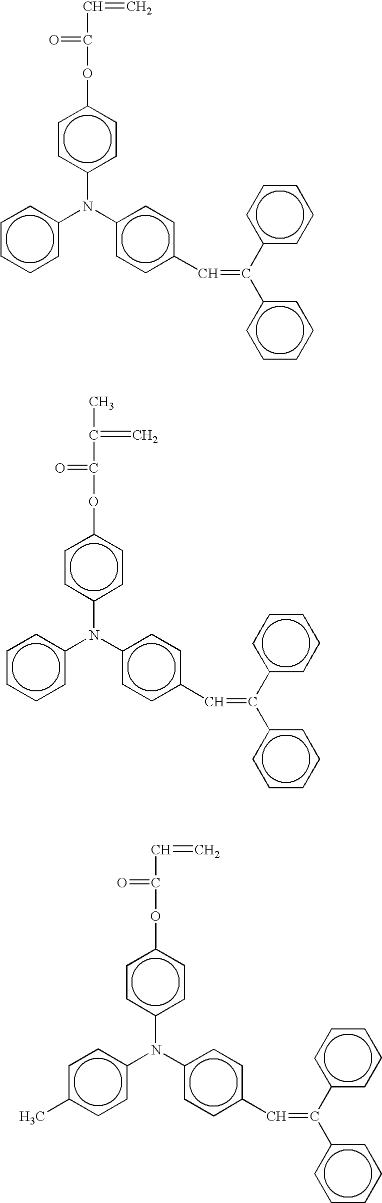

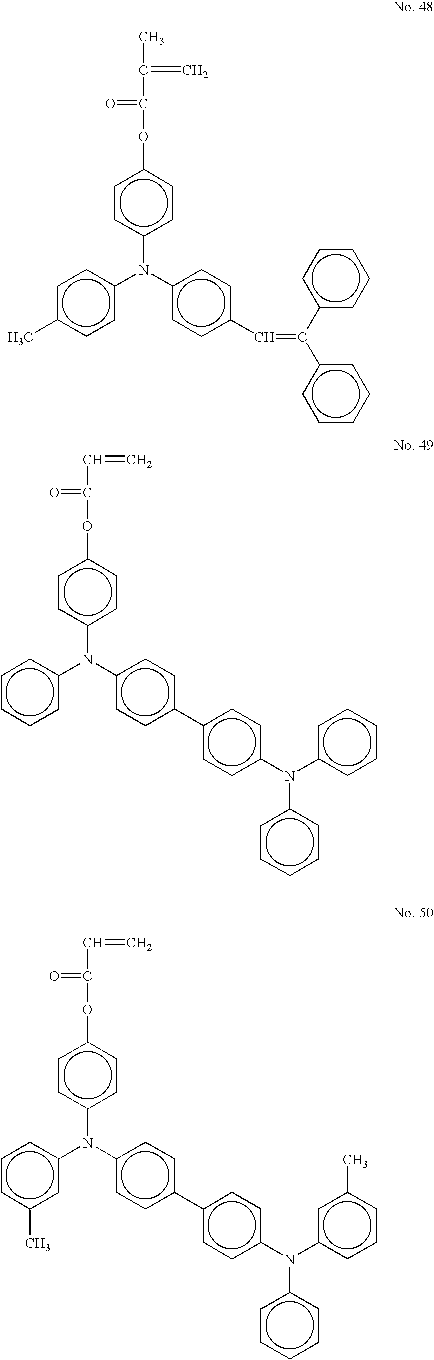

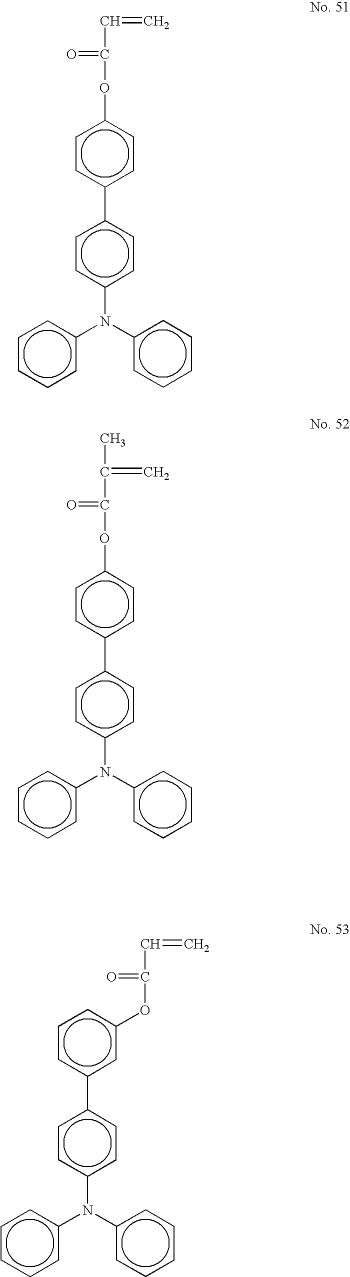

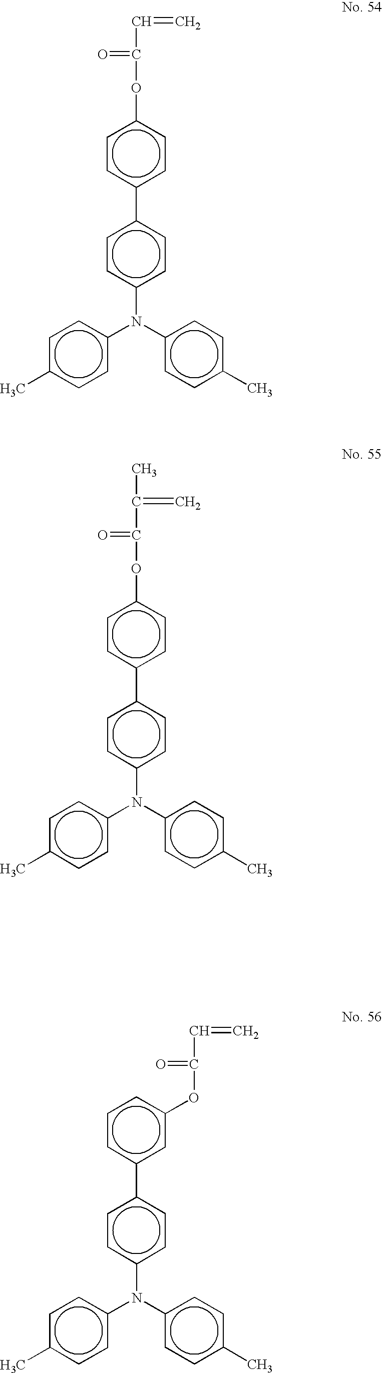

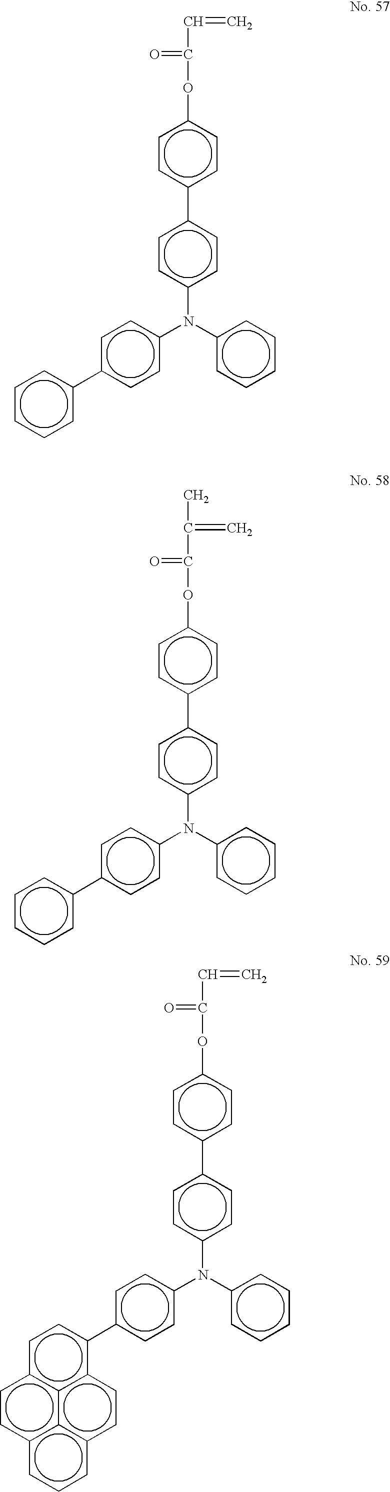

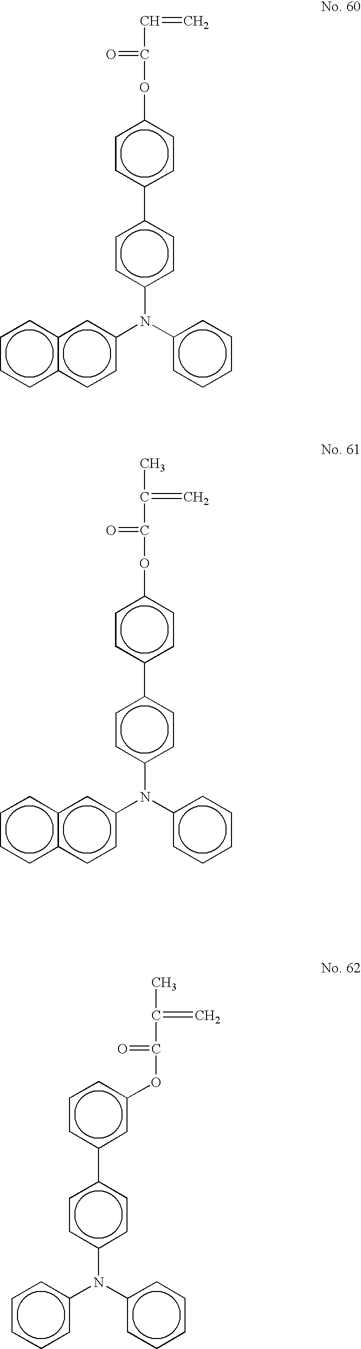

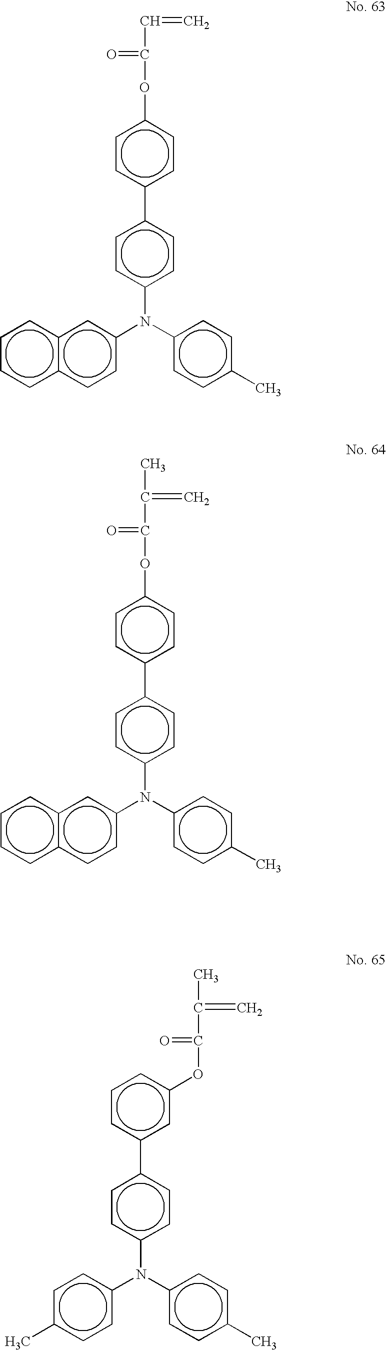

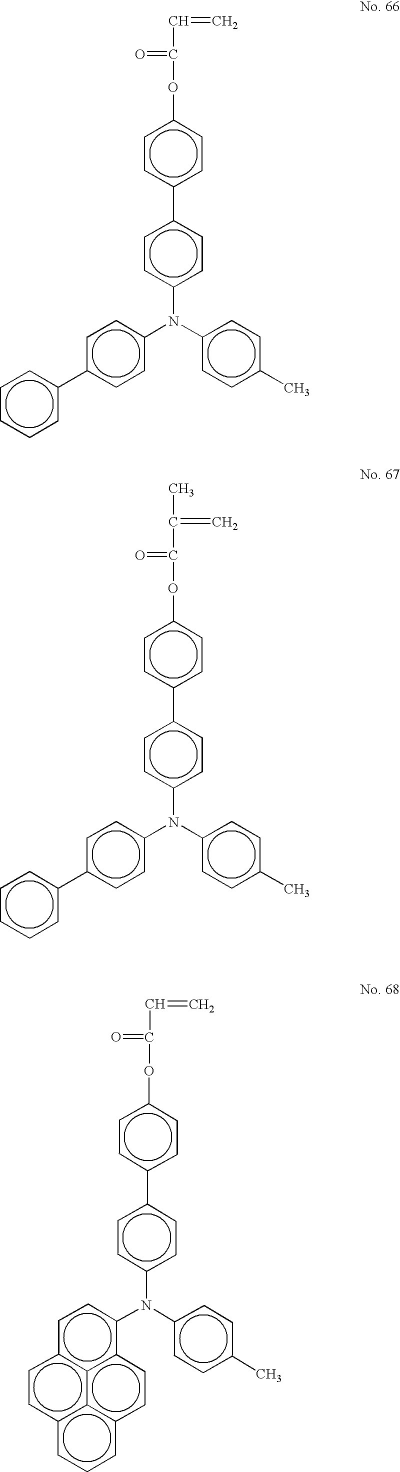

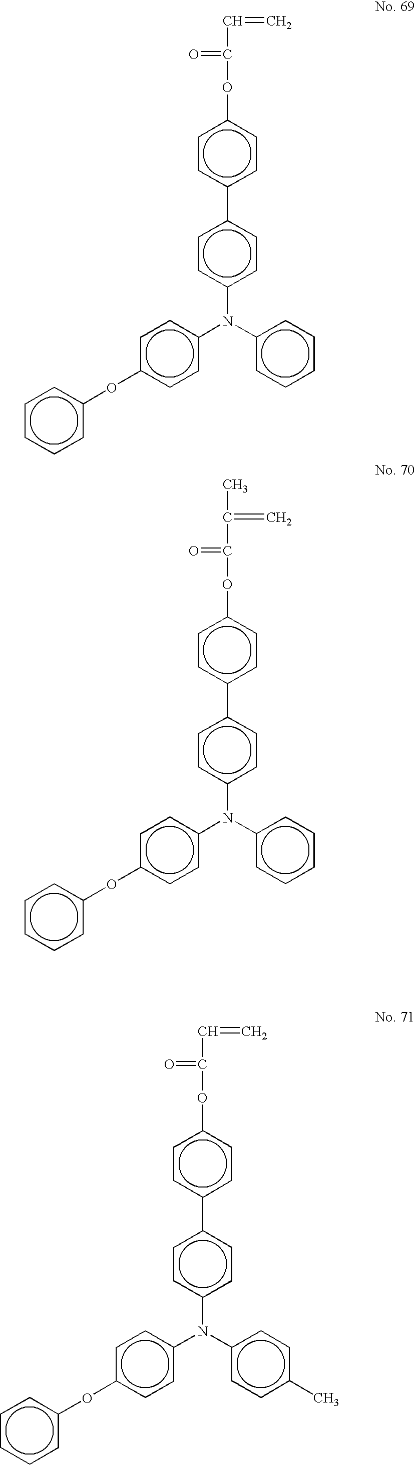

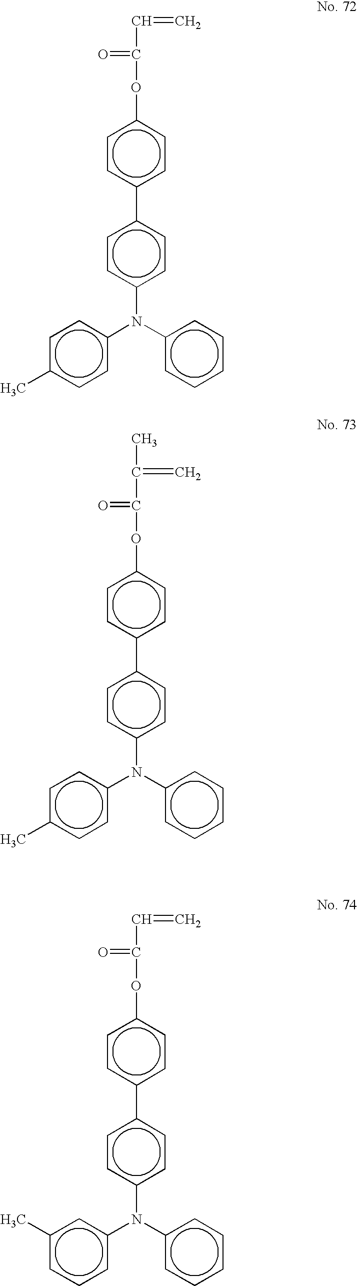

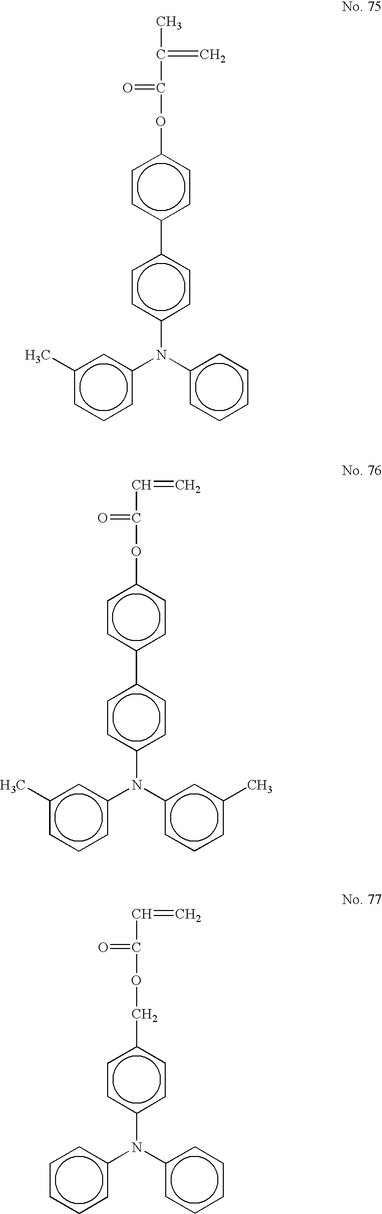

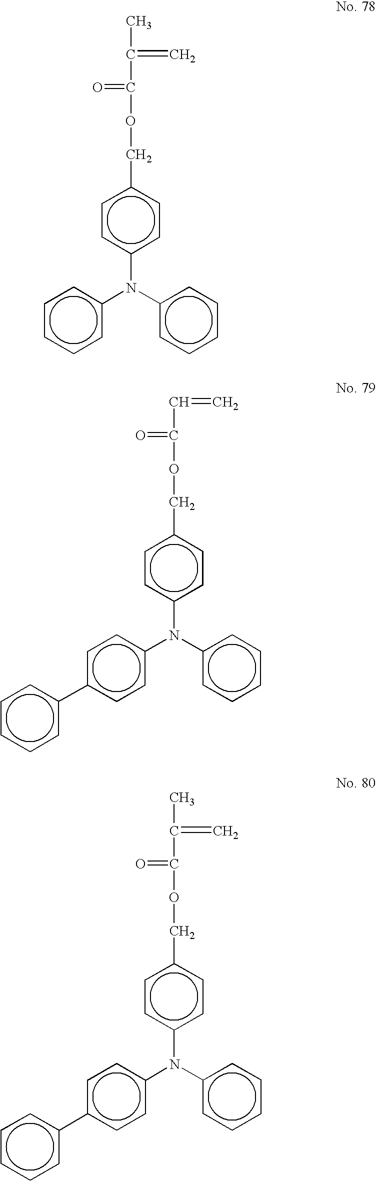

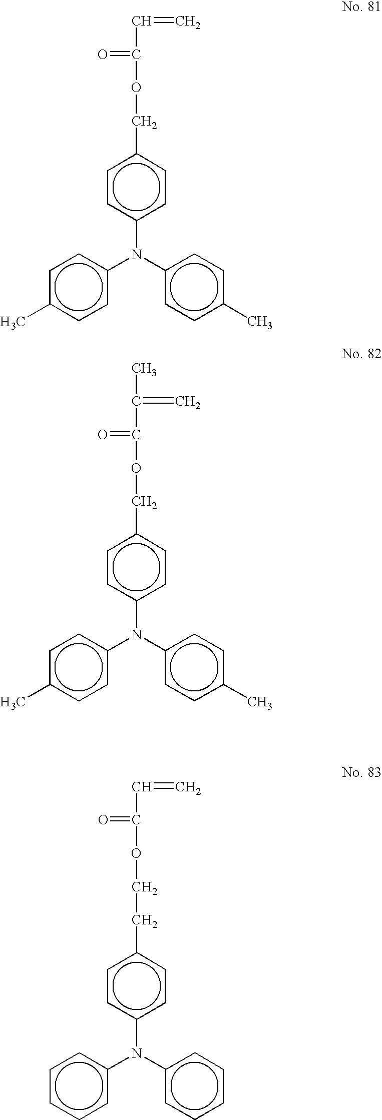

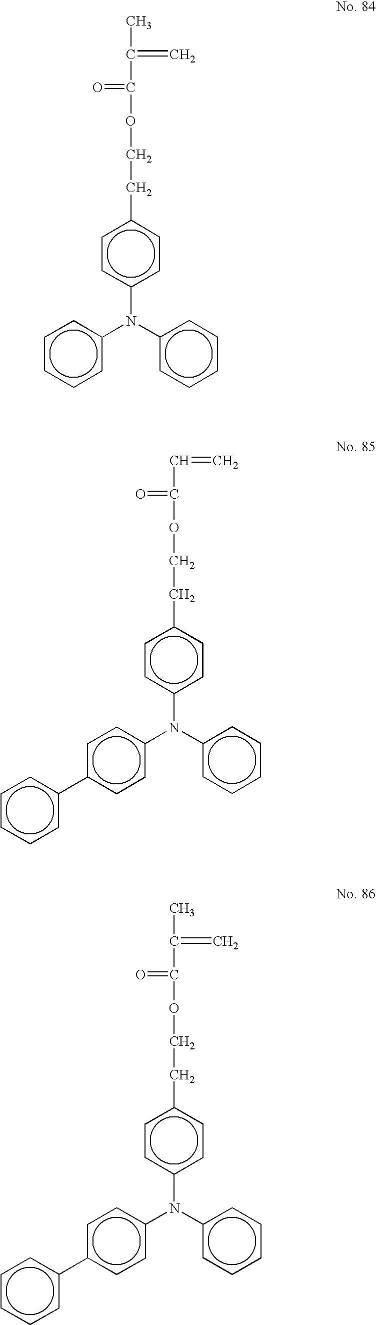

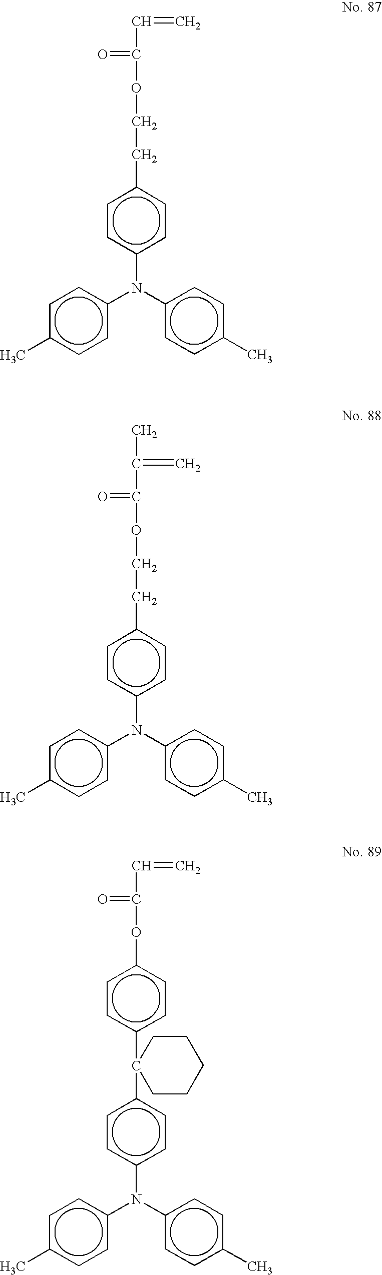

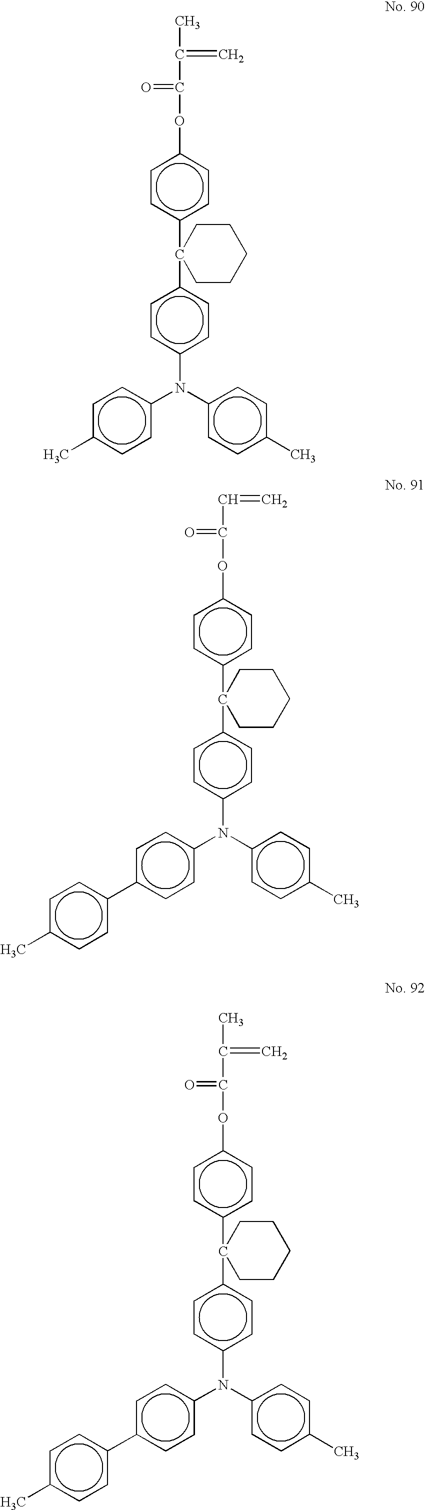

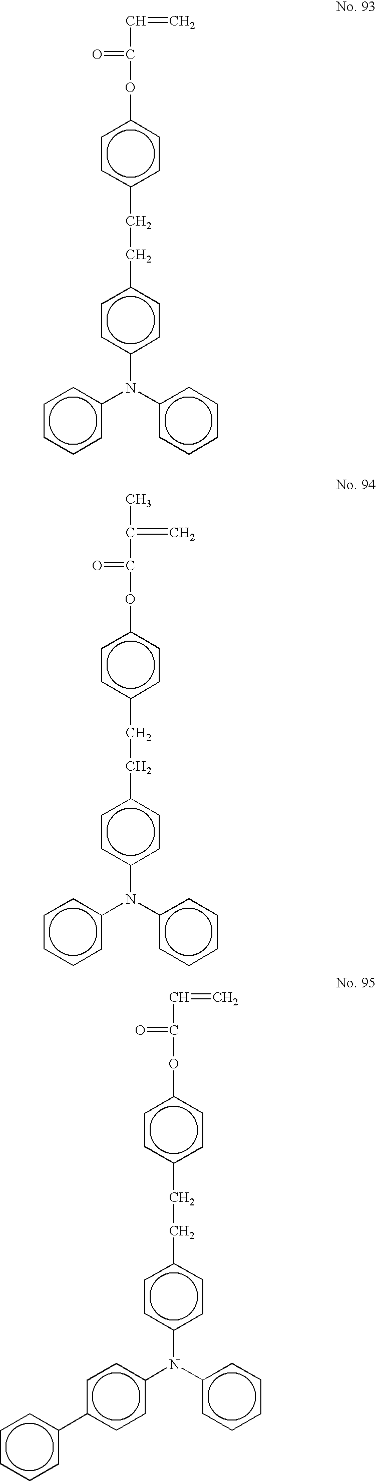

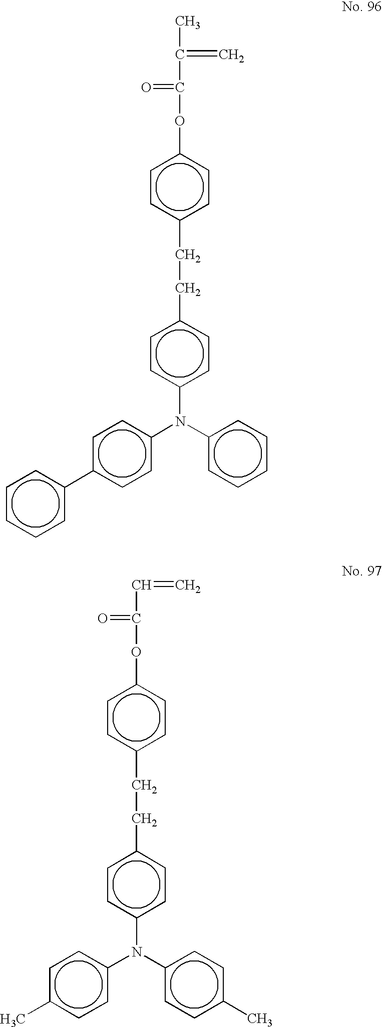

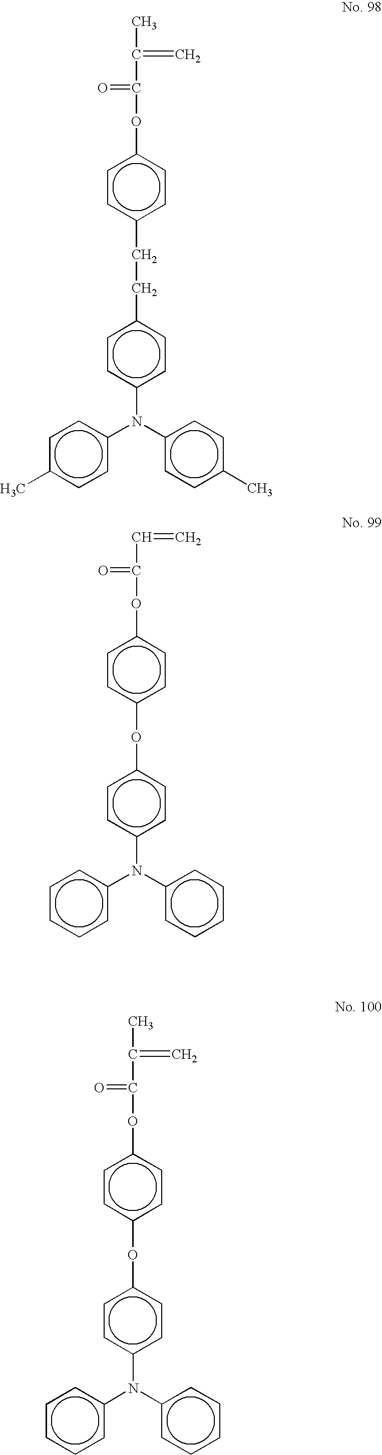

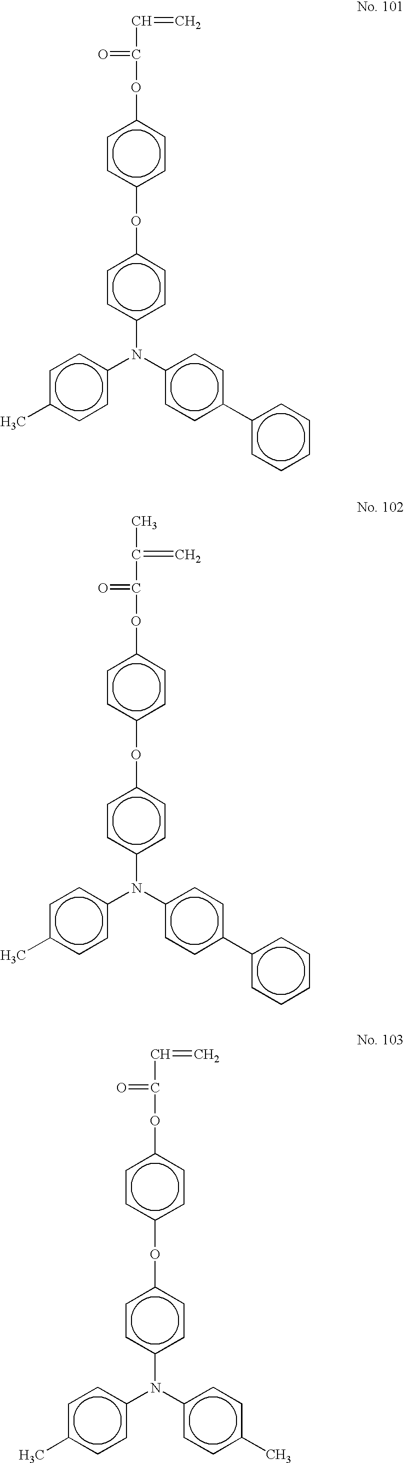

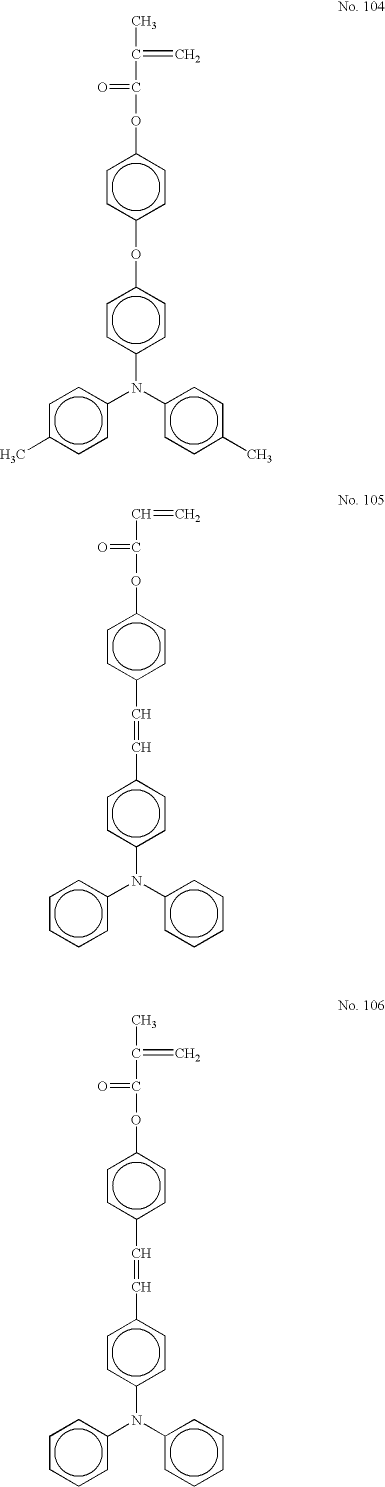

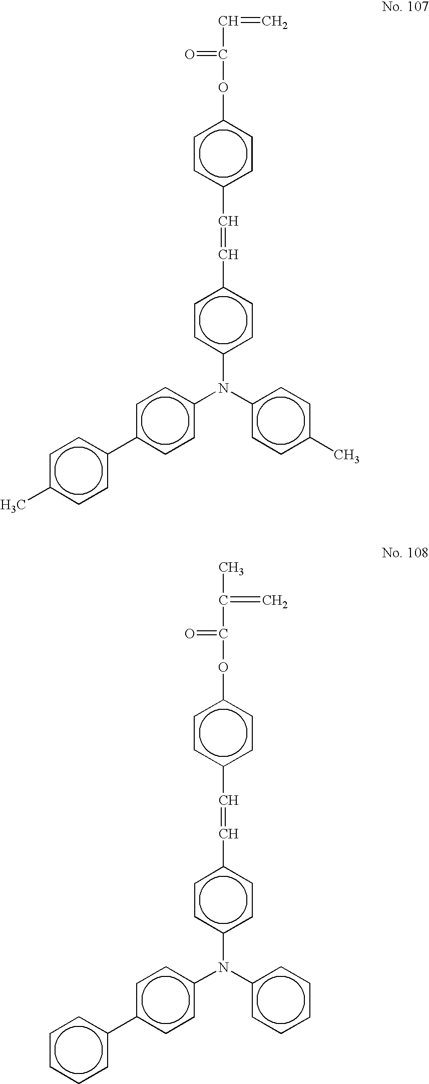

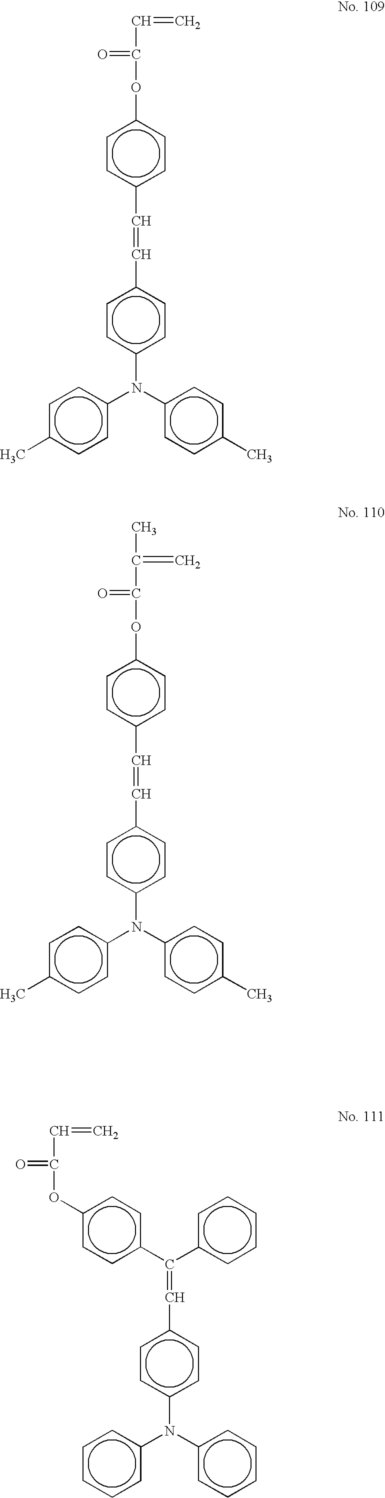

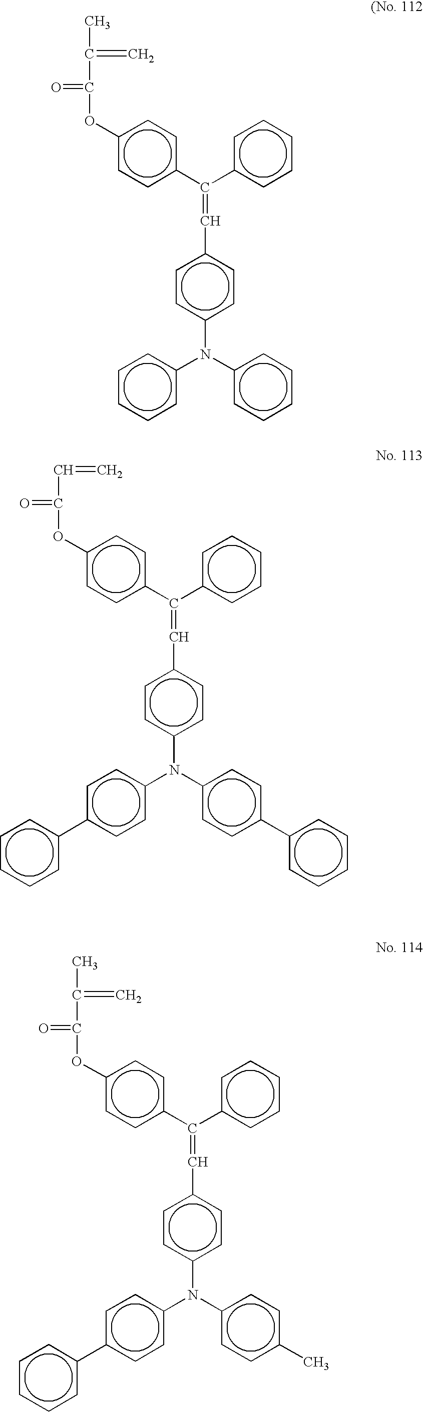

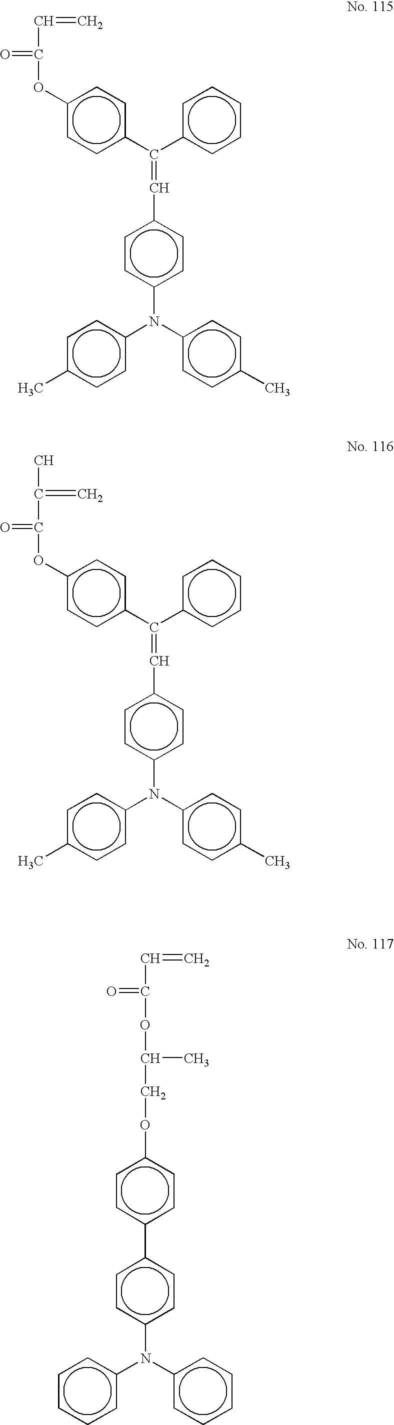

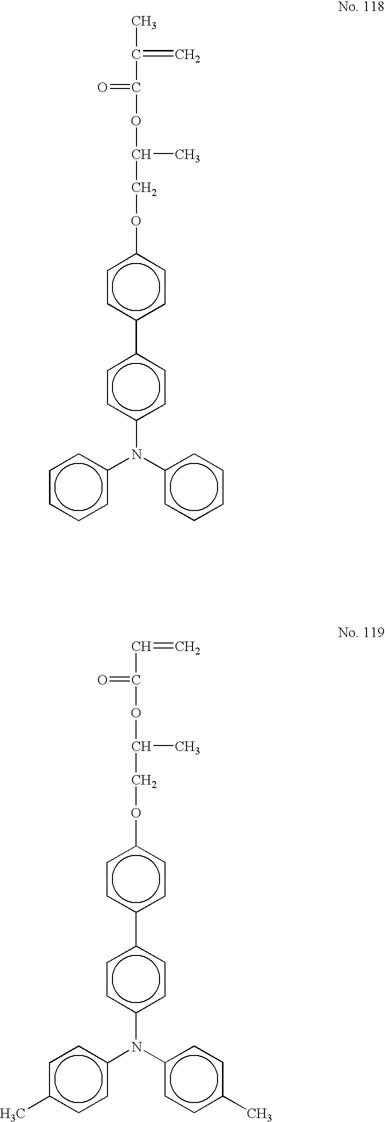

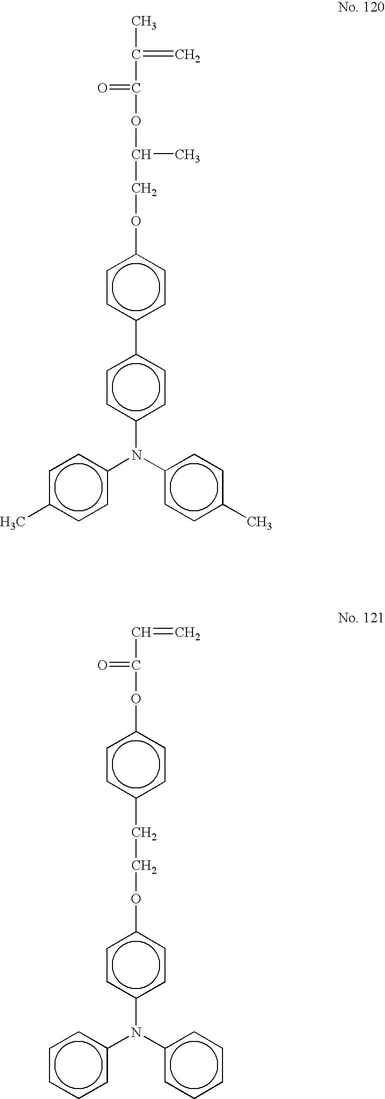

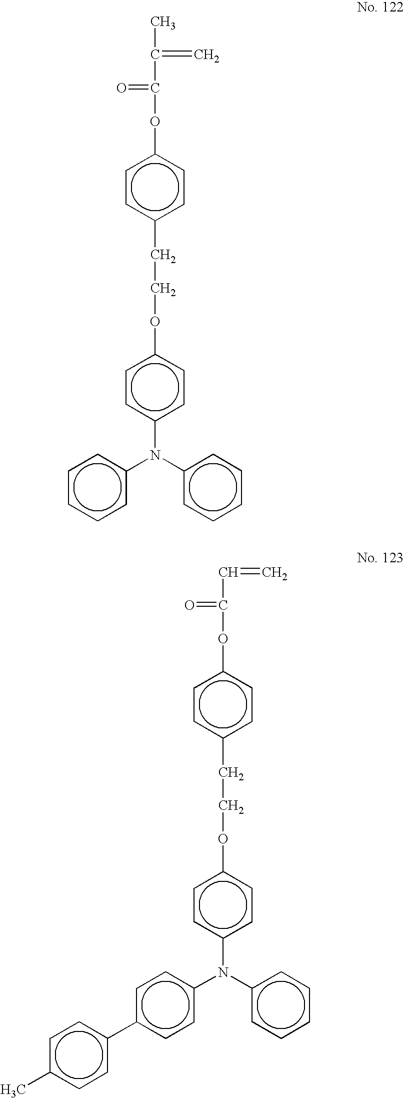

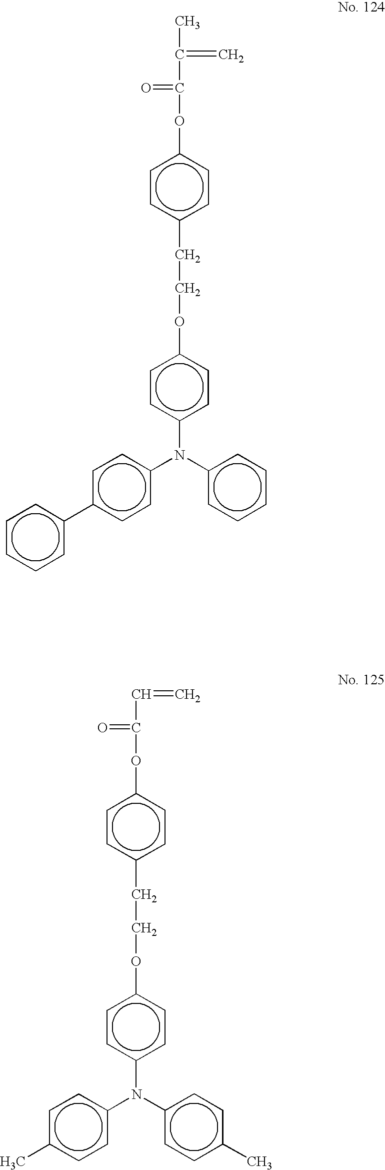

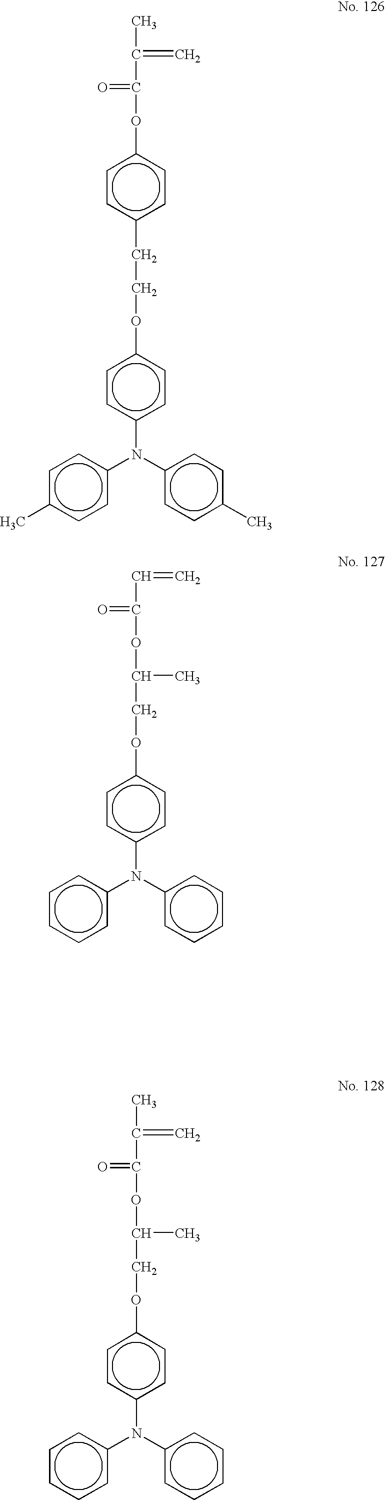

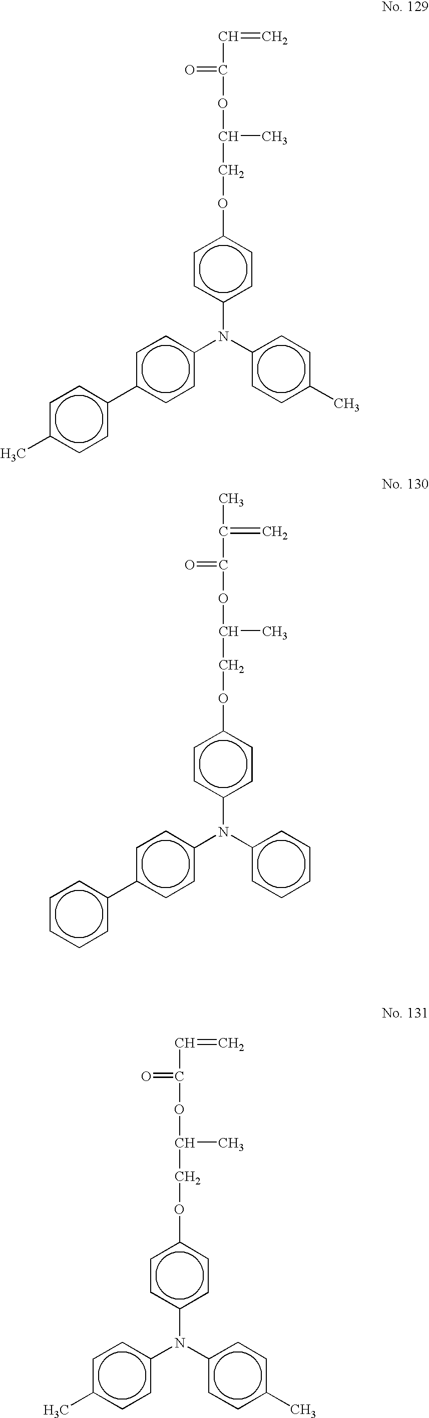

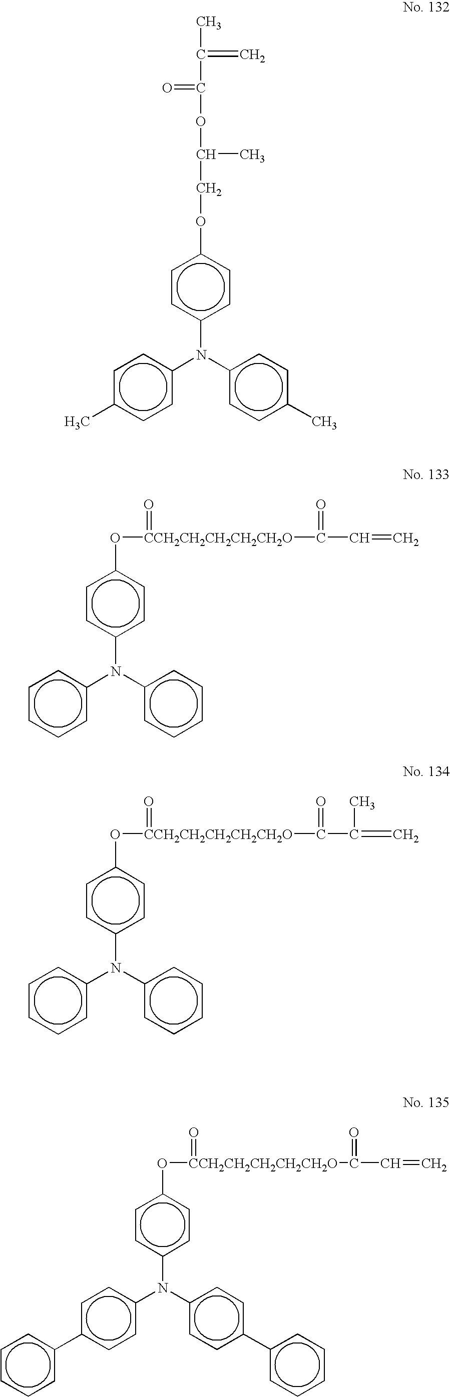

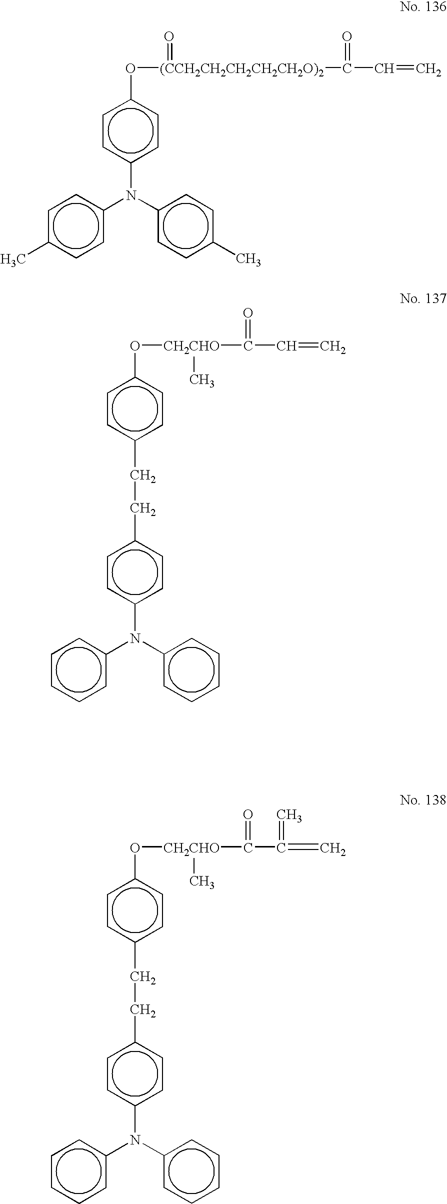

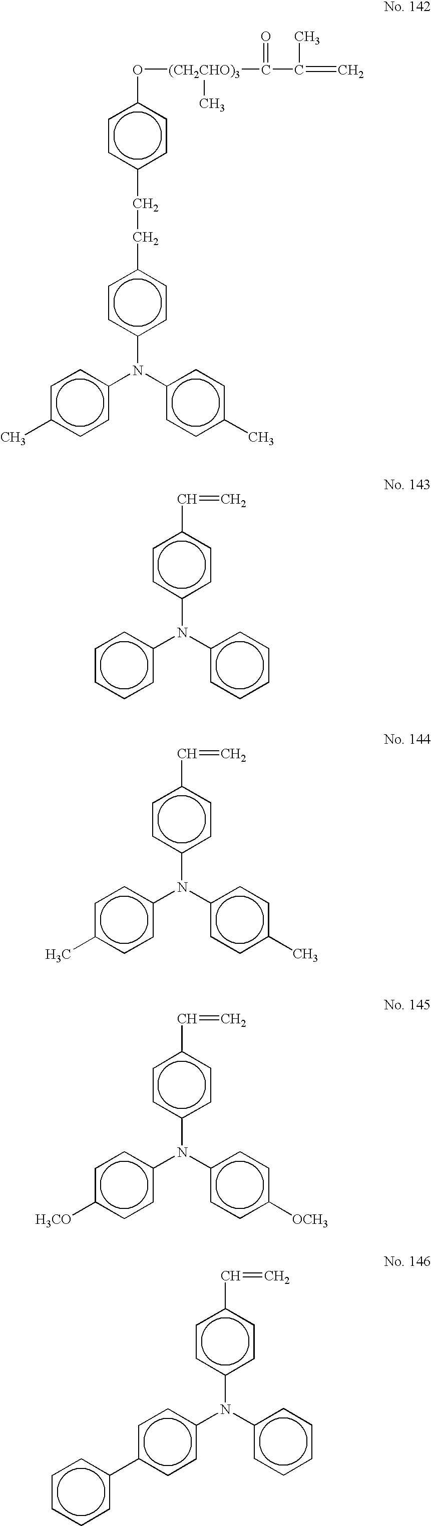

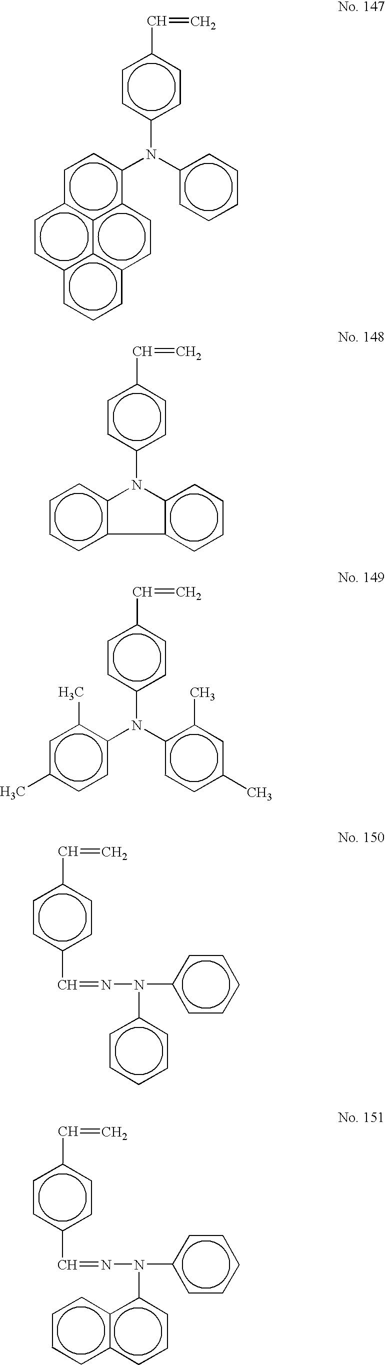

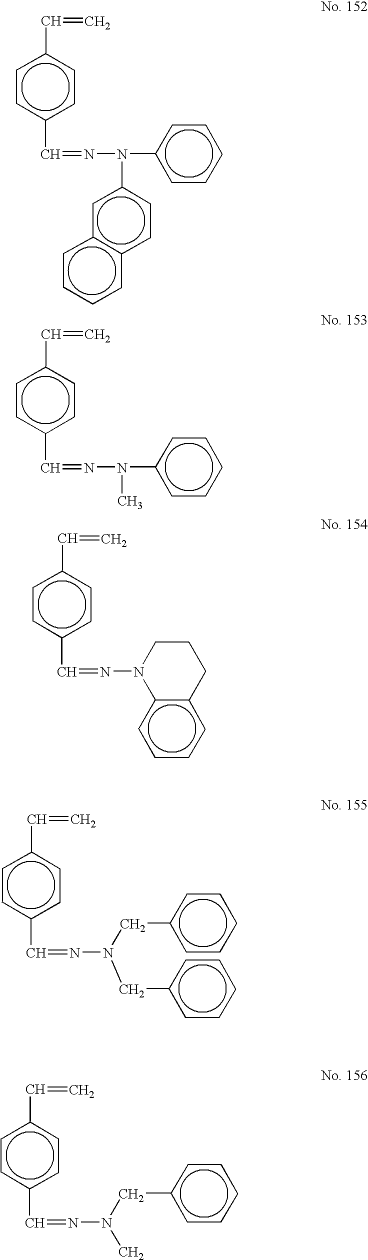

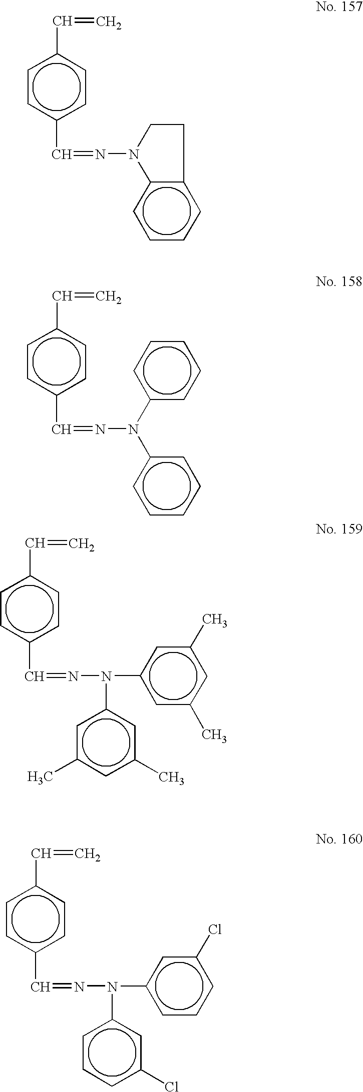

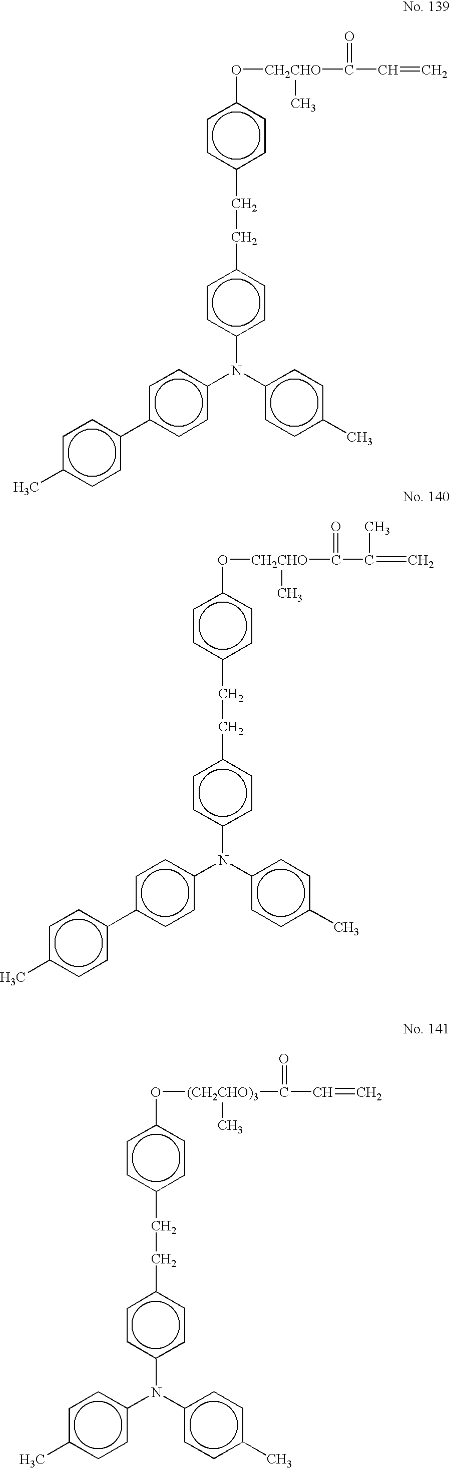

The radical polymerizing compound having one functional group with a charge transporting structure for use in the present invention is essential for imparting a charge transportability to the crosslinked surface layer, and is preferably included therein in an mount of 20 to 80% by weight, and more preferably from 30 to 70% by weight based on total we ight thereof. When less than 20% by weight, the crosslinked surface layer cannot maintain the charge transportability, a sensitivity of the resultant photoreceptor deteriorates and a residual potential thereof increases in repeated use. When greater than 80% by weight, a content of the monomer having three or more functional groups without a charge transporting structure decreases and the crosslinked density deteriorates, and therefore the resultant photoreceptor does not have a high abrasion resistance. Although it depends on a required abrasion resistance and electrical properties, in consideration of a balance therebetween, a content of the radical polymerizing compound having one functional group with a charge transporting structure is most preferably from 30 to 70% by weight.

As mentioned before, a radical polymerizing monomer having tow or more functional group with a charge transporting structure is not preferably included therein because of causing a charge transport trap and increase of internal stress therein.

The surface layer of the present invention is a crosslinked surface layer wherein at least the radical polymerizing monomer having three or more functional groups without a charge transporting structure and the radical polymerizing compound having one functional group with a charge transporting structure, are hardened at the same time, and can include a radical polymerizing monomer and a radical polymerizing oligomer having one or two functional groups as well to control a viscosity of the surface layer when coated, reduce a stress of thereof, impart a low surface free energy thereto and reduce friction coefficient thereof. Known radical polymerizing monomers and oligomers can be used. Specific examples of the radical monomer having one functional group include 2-ethylhexyl acrylate, 2-hydroxyethylacrylate, 2-hydroxypropylacrylate, tetrahydrofurfurylacrylate, 2-ethylhexylcarbitolacrylate, 3-methoxybutylacrylate, benzylacrylate, cyclohexylacrylate, isoamylacrylate, isobutylacrylate, methoxytriethyleneglycolacrylate, phenoxytetraethyleneglycolacrylate, cetylacrylate, isostearylacrylate, stearylacrylate, styrene monomer, etc. Specific examples of the radical monomer having two functional groups include 1,3-butanediolacrylate, 1,4-butanedioldiacrylate, 1,4-butanedioldimethacrylate, 1,6-hexanedioldiacrylate, 1,6-hexanedioldimethacrylate, diethyleneglycoldiacrylate, neopentylglycoldiacrylate, EO-modified bisphenol A diacrylate, EO-modified bisphenol F diacrylate, etc.

Specific examples of the functional monomers include octafluoropentylacrylate, 2-perfluorooctylethylacrylate, 2-perfluorooctylethylmethacrylate, 2-perfluoroisononylethylacrylate, etc., wherein a fluorine atom is substituted; vinyl monomers having a polysiloxane group with a repeat unit of from 20 to 70 disclosed in Japanese Patent Publications Nos. 5-60503 and 6-45770, such as acryloylpolydimethylsiloxaneethyl, methacryloylpolydimethylsiloxaneethyl, acryloylpolydimethylsiloxanepropyl, acryloylpolydimethylsiloxanebutyl, diacryloylpolydimethylsiloxanediethyl; acrylate; and methacrylate.

Specific examples of the radical polymerizing oligomer includes epoxyacrylate oligomers, urethaneacrylate oligomers and polyetseracrylate oligomers.

However, when the crosslinked surface layer includes a large amount of the radical polymerizing monomer and radical polymerizing oligomer having one or two functional groups, the three-dimensional crosslinked bonding density thereof substantially deteriorates, resulting in deterioration of the abrasion resistance thereof. Therefore, the surface layer of the present invention preferably includes the monomers and oligomers in an amount not greater than 20 parts by weight, and more preferably not greater than 10 parts by weight per 100 parts by weight of the radical polymerizing monomer having three or more functional groups.

The surface layer of the present invention is a crosslinked surface layer is formed by coating a coating liquid including the radical polymerizing monomer and hardening the coating liquid upon application of external energy, and the coating liquid can optionally include a polymerization initiator to effectively proceed the crosslinking reaction.

Specific examples of the heat polymerization initiators include peroxide initiators such as 2,5-dimethylhexane-2,5-dihydrooxide, dicumylperoxide, benzoylperoxide, t-butylcumylperoxide, 2,5-dimethyl-2,5-di(peroxybenzoyl)hexyne-3, di-t-butylbeloxide, t-butylhydrobeloxide, cumenehydobeloxide and lauroylperoxide; and azo initiators such as azobisisobutylnitrile, azobiscyclohexanecarbonitrile, azobisisomethylbutyrate, azobisisobutylamidinehydorchloride and 4,4-azobis-4-cyanovaleric acid.

Specific examples of the photo polymerization initiators include acetone or ketal photo polymerization initiators such as diethoxyacetophenone, 2,2-dimethoxy-1,2-diphenylethane-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-molpholinophenyl)butanone-1,2-hydroxy-2-methyl-1-phenylpropane-1-one and 1-phenyl-1,2-propanedion-2-(o-ethoxycarbonyl)oxime; benzoinether photo polymerization initiators such as benzoin, benzoinmethylether, benzoinethylether, benzoinisobutylether and benzoinisopropylether; benzophenone photo polymerization initiators such as benzophenone, 4-hydroxybenzophenone, o-benzoylmethylbenzoate, 2-benzoylnaphthalene, 4-benzoylviphenyl, 4-benzoylphenylether, acrylated benzophenone and 1,4-benzoylbenzene; thioxanthone photo polymerization initiators such as 2-isopropylthioxanthone, 2-chlorothioxanthone, 2,4-dimethylthioxanthone, 2,4-diethylthioxanthone and 2,4-dichlorothioxanthone; and other photo polymerization initiators such as ethylanthraquinone, 2,4,6-trimethylbenzoyldiphenylphosphineoxide, 2,4,6-trimethylbenzoyldiphenylethoxyphosphineoxide, bis(2,4,6-trimethylbenzoyl)phenylphosphineoxide, bis(2,4-dimethoxybenzoyl)-2,4,4-trimethylpentylphosphineoxi de, methylphenylglyoxyester, 9,10-phenanthrene, acridine compounds, triazine compounds and imidazole compounds. Further, a material having a photo polymerizing effect can be used alone or in combination with the above-mentioned photo polymerization initiators. Specific examples of the materials include triethanolamine, methyldiethanol amine, 4-dimethylaminoethylbenzoate, 4-dimethylaminoisoamylbenzoate, ethyl(2-dimethylamino)benzoate and 4,4-dimethylaminobenzophenone.

These polymerization initiators can be used alone or in combination. The surface layer of the present invention preferably includes the polymerization initiators in an amount of 0.5 to 40 parts by weight, and more preferably from 1 to 20 parts by weight per 100 parts by weight of the radical polymerizing compounds.

Further, a coating liquid for the surface layer of the present invention may optionally include various additives such as plasticizers (to soften a stress and improve adhesiveness thereof), leveling agents and low-molecular-weight charge transport materials without a radical reactivity. Known additives can be used, and specific examples of the plasticizers include plasticizers such as dibutylphthalate and dioctylphthalate used in typical resins. A content thereof is preferably not greater than 20% by weight, and more preferably not greater than 10% based on total weight of solid contents of the coating liquid. Specific examples of the leveling agents include silicone oil such as dimethylsilicone oil and methylphenylsilicone oil; and polymers and oligomers having a perfluoroalkyl group in the side chain. A content thereof is preferably not greater than 3% by weight.

The coating liquid can include other components when the radical polymerizing monomer is a liquid, and is optionally diluted with a solvent and coated. Specific examples of the solvent include alcohols such as methanol, ethanol, propanol and butanol; ketones such as acetone, methyl ethyl ketone, methyl isobutyl ketone and cyclohexanone; esters such as ethyl acetate and butyl acetate; ethers such as tetrahydrofuran, dioxane and propylether; halogens such as dichloromethane, dichloroethane, trichloroethane and chlorobenzene; aromatics such as benzene, toluene and xylene; and Cellosoves such as methyl Cellosolve, ethyl Cellosolve and Cellosolve acetate. These solvents can be used alone or in combination. A dilution ratio with the solvent can optionally be decided upon solubility of the compositions, a coating method and a purposed layer thickness. The crosslinked surface layer can be coated by a dip coating method, a spray coating method, a bead coating method, a ring coating method, etc.

In the present invention, after the coating liquid is coated to form layer, an external energy is applied thereto for hardening the layer to form the crosslinked surface layer. The external energy includes a heat, a light and a radiation. A heat energy is applied to the layer from the coated side or from the substrate using air, a gaseous body such as nitrogen, a steam, a variety of heating media, infrared or an electromagnetic wave. The heating temperature is preferably from 100 to 170° C. When less than 100° C., the reaction is slow in speed and is not completely finished. When greater than 170° C., the reaction nonuniformly proceeds and a large distortion appears in the crosslinked surface layer. To uniformly proceed the hardening reaction, after heated at comparatively a low temperature less than 100° C., the reaction is completed at not less than 100° C. Specific examples of the light energy include UV irradiators such as high pressure mercury lamps and metal halide lamps having an emission wavelength of UV light; and a visible light source adaptable to absorption wavelength of the radical polymerizing compounds and photo polymerization initiators. An irradiation light amount is preferably from 50 to 1,000 mW/cm². When less than 50 mW/cm² the hardening reaction takes time. When greater than 1,000 mW/cm², the reaction nonuniformly proceeds and the crosslinked surface layer has a large surface roughness. The radiation energy includes a radiation energy using an electron beam. Among these energies, the heat and light energies are effectively used because of their simple reaction speed controls and simple apparatuses.

The crosslinked surface layer of the present invention has a different thickness, depending on a layer structure of a photoreceptor using the crosslinked surface layer.

The crosslinked surface layer of the present invention preferably has a surface roughness Rz not greater than 1 μm. A photoreceptor having the crosslinked surface layer having high abrasion resistance and smoothness of the present invention can produce high-quality images for long periods.

The surface roughness Rz of the crosslinked surface layer of the present invention is a ten-point mean roughness measured according to JIS 20601-1994, and SURFCOM 1400D from TOKYO SEIMITSU CO., LTD. is used in the present invention. However, any apparatus having a capability equivalent thereto can be used.

The surface roughness Rz of the crosslinked surface layer is affected by (1) constituents included in a crosslinked surface layer coating liquid and their content ratios, (2) a diluent solvent of the coating liquid and a concentration of solid contents, (3) a coating method, (4) hardening means and conditions, (5) solubility of an underlayer. These interact with one another, on which the surface roughness depends, but has the following tendency.

When the crosslinked surface layer coating liquid includes a radical polymerizing compound having two or more functional groups with a charge transport structure, the bulky charge transport structure causes internal stress when hardened, resulting in a concavity and a convexity on the surface of the crosslinked surface layer. When the coating liquid includes a polymer material such as a binder resin, the binder resin is insoluble with a polymer produced by a hardening reaction of the radical polymerizing compositions (the radical polymerizing monomer and the radical polymerizing compound having a charge transporting structure) and a phase separation appears, resulting in large concavities and convexities of the crosslinked surface layer. Therefore, it is preferable not to use the binder resin.

When a large amount of a solvent easily dissolving the underlayer is used for the diluent solvent of the coating liquid, a binder resin and a low-molecular-weight CTM in the underlayer mix in the crosslinked surface layer, resulting in not only a hindrance to hardening but also deterioration of surface smoothness. On the contrary, when a solvent which does not dissolve the underlayer at all is used, adherence between the crosslinked surface layer and the underlayer deteriorates, and craters appear on the crosslinked surface layer due to a volume contraction thereof when hardened. In order to solve this problem, a mixed solvent is used to control solubility of the underlayer; an amount of the solvent included in an outermost layer is reduced by controlling the coating liquid constituents and coating method; a charge transport polymer material is used in the underlayer to prevent the components thereof from mixing in the upper layer; and an intermediate layer having low solubility and good adherence is formed between the underlayer and the crosslinked surface layer.

The crosslinked surface layer of the present invention needs to include a bulky charge transport structure to maintain electrical properties thereof and increase crosslinked density to increase hardness thereof. When quite a high external energy is rapidly applied to such a surface layer for hardening the layer, the hardening nonuniformly proceeds, resulting in large concavities and convexities thereon. Therefore, external energies such as heat and light are preferably used because the reaction speed can be controlled with heating conditions, light irradiation intensity and an amount of the polymerization initiator.

The photoreceptor of the present invention can have an intermediate layer between the crosslinked surface layer and the photosensitive layer when the crosslinked surface layer overlies the photosensitive layer. The intermediate layer prevents components of the lower photosensitive layer from mixing in the crosslinked surface layer to avoid a hardening reaction inhibition and concavities and convexities thereof. In addition, the intermediate layer can improve adherence between the crosslinked surface layer and photosensitive layer.

The intermediate layer includes a resin as a main component. Specific examples of the resin include polyamides, alcohol-soluble nylons, water-soluble polyvinyl butyral, polyvinyl butyral, polyvinyl alcohol, etc. The intermediate layer can be formed by one of the above-mentioned known coating methods. The intermediate layer preferably has a thickness of from 0.05 to 2 μm.

In the present invention, an antioxidant can be included in each of the layers, i.e., the crosslinked surface layer, charge generation layer, charge transport layer, undercoat layer and intermediate layer to improve the stability to withstand environmental conditions, namely to avoid decrease of photosensitivity and increase of residual potential.

Specific examples of the antioxidant for use in the present invention include the following compound.

(a) Phenolic Compounds

2,6-di-t-butyl-p-cresol, butylated hydroxyanisole, 2,6-di-t-butyl-4-ethylphenol, n-octadecyl-3-(4′-hydroxy-3′,5′-di-t-butylphenol), 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester, tocophenol compounds, etc.

(b) Paraphenylenediamine Compounds

N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, N,N′-dimethyl-N,N′-di-t-butyl-p-phenylenediamine, etc.

(c) Hydroquinone Compounds

2,5-di-t-octylhydroquinone, 2,6-didodecylhydroquinone, 2-dodecylhydroquinone, 2-dodecyl-5-chlorohydroquinone, 2-t-octyl-5-methylhydroquinone, 2-(2-octadecenyl)-5-methylhydroquinone, etc.

(d) Organic Sulfur-Containing Compounds

Dilauryl-3,3′-thiodipropionate, distearyl-3,3′-thiodipropionate, ditetradecyl-3,3′-thiodipropionate, etc.

(e) Organic Phosphorus-Containing Compounds

Triphenylphosphine, tri(nonylphenyl)phosphine, tri(dinonylphenyl)phosphine, tricresylphosphine, tri(2,4-dibutylphenoxy)phosphine, etc.

These compounds are known as antioxidants for rubbers, plastics, fats, etc., and marketed products thereof can easily be obtained.

Each of the layers preferably includes the antioxidant in an amount of from 0.01 to 10% by weight based on total weight thereof.

Next, the image forming method and image forming apparatus of the present invention will be explained in detail, referring to the drawings.

The image forming method and image forming apparatus of the present invention include a photoreceptor having a smooth transporting crosslinked surface layer, wherein the photoreceptor is charged and irradiated with imagewise light to form an electrostatic latent image thereon; the electrostatic latent image is developed to form a toner image; the toner image is transferred onto an image bearer (transfer sheet) and fixed thereon; and a surface of the photoreceptor is cleaned.

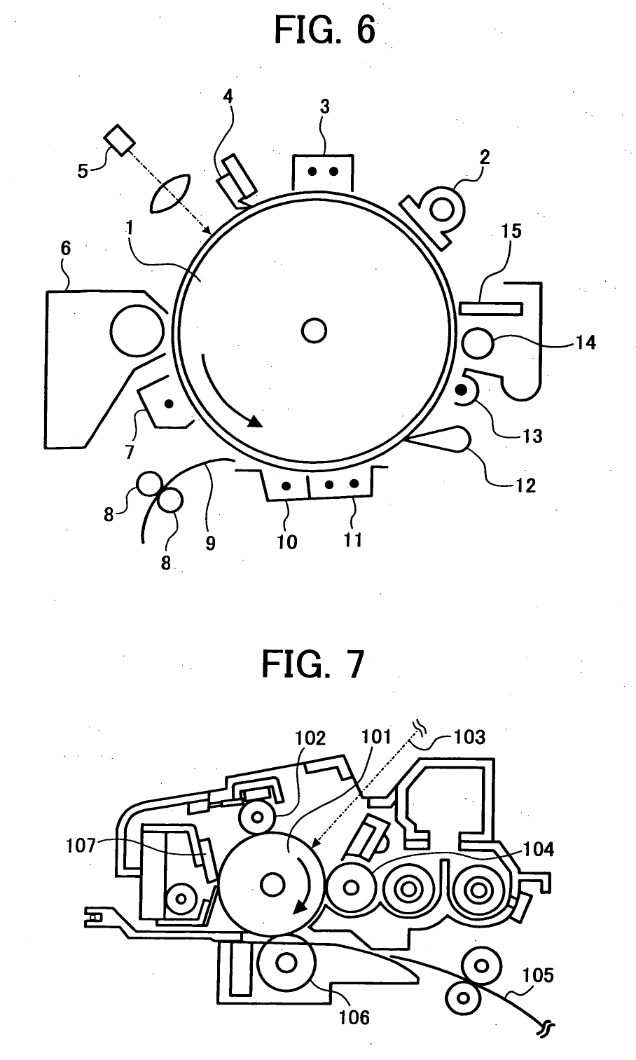

FIG. 6 is a schematic view illustrating a partial cross-section of an embodiment of the image forming apparatus of the present invention. A charger 3 is used to uniformly charge a photoreceptor 1. Specific examples of the charger include known chargers such as corotron devices, scorotron device, solid state chargers, needle electrode devices, roller charging devices and electroconductive brush devices.

Next, an imagewise light irradiator 5 is used to form an electrostatic latent image on the photoreceptor 1. The imagewise light irradiator 5 is a LD or a LED emitting light having a wavelength of from 400 to 450 nm. When a LD is used, the imagewise light irradiator 5 includes a LD, an aperture, a collimate lens, a main CYL, a sub CYL, a polygon mirror, a first scanning lens, a second scanning lens and a mirror. The LD preferably has an image frequency not less than 65 MHz, more preferably not less than 100 MHz, and furthermore preferably not less 130 MHz, wherein the temperature compensation is controlled. The polygon mirror rotates at 50K rpm, and preferably at 60K rpm. The light source preferably has a multibeam, and at least 2 channels, and more preferably not less than 4 channels. In addition, to obtain light having a desired wave length range, filters such as sharp-cut filters, band pass filters, near-infrared cutting filters, dichroic filters, interference filters and color temperature converting filters can be used.

Next, a developing unit 5 is used to visualize an electrostatic latent image formed on the photoreceptor 1.

The developing methods include a one-component developing method and a two-component developing method; and a wet developing method using a wet toner. When the photoreceptor positively or negatively charged is exposed to imagewise light, an electrostatic latent image having a positive or negative charge is formed on the photoreceptor. When the latent image having a positive charge is developed with a toner having a negative charge, a positive image can be obtained. In contrast, when the latent image having a positive charge is developed with a toner having a positive charge, a negative image can be obtained. The one-component developing method or two-component developing method using a dry toner includes a contact developing method and a non-contact developing method. The non-contact developing method is a method of forming a gap having a thickness no less than a developer layer thickness between an electrophotographic photoreceptor and a developer bearer, applying an electric filed thereto to develop a latent image. The developing voltage is a DC voltage or an AC voltage, or may be a DC+AC voltage. The AC voltage development applies an alternating electric filed to the electrophotographic photoreceptor and the developer bearer facing each other.

The toner preferably has an average particle diameter of from 2 to 8 μm, and may be a pulverized toner or a polymerized toner. The polymerized toner is a toner prepared by polymerizing constituents including a monomer and a colorant, or a prepolymer and a colorant, in an aqueous medium. The polymerized toner may optionally be subjected to a physical or a chemical treatment.

Next, a transfer charger 10 is used to transfer a toner image visualized on the photoreceptor onto a transfer sheet 9. A pre-transfer charger 7 may be used to perform the transfer better. Suitable transferers include a transferer charger, an electrostatic transferer using a bias roller, an adhesion transferer, a mechanical transferer using a pressure and a magnetic transferer. The above-mentioned chargers can be used for the electrostatic transferer.

Next, a separation charger 11 and a separation pick 12 are used to separate the transfer sheet 9 from the photoreceptor 1. Other separation means include an electrostatic absorption induction separator, a side-edge belt separator, a tip grip conveyor, a curvature separator, etc. The above-mentioned chargers can be used for the separation charger 11.

Next, a fur brush 14 and a cleaning blade 15 are used to remove a toner left on the photoreceptor after transferred therefrom. A pre-cleaning charger 13 may be used to perform the cleaning more effectively. Other cleaners include a web cleaner, a magnet brush cleaner, etc., and these cleaners can be used alone or in combination.

Next, a discharger is optionally used to remove a latent image in the photoreceptor. The discharger includes a discharge lamp 2 and a discharger, and the above-mentioned light sources and chargers can be used respectively.

Known means can be used for other an original reading process, a paper feeding process, a fixing process, a paper delivering process, etc.

A mechanism controlling the abrasion resistance of the photoreceptor (not shown) is, e.g., an applicator or a provider applying a lubricant or providing a low-surface-energy member to the surface thereof, and does not choose a location, but is preferably located between the cleaning process and the charging process. Specific examples of the materials controlling the abrasion resistance of the photoreceptor include fluorine-containing resins such as polytetrafluoroethylene (PTFE) used as TEFLON (registered brand), copolymers of tetrafluoroethylene and perfluoroalkylvinyl ether (PFA), polychlorotrifluoroethylene (PCTFE), copolymers of tetrafluoroethylene and ethylene (ETFE), polyvinylidenefluoride (PVDF), copolymers of tetrafluoroethylene and oxafluoropropylene (FEP), polytrifluorochloroethylene (PTFCE), dichlorofluoroethylene and polytrifluoroethylene (PTFE); and products of a polyfluorocarbon fiber and a polytetrafluoroethylene fiber. Among these materials, the polytetrafluoroethylene is effectively used.

The present invention is an image forming method and an image forming apparatus, using the electrophotographic photoreceptor of the present invention in the image forming unit.

The above-mentioned image forming unit may be fixedly set in a copier, a facsimile or a printer. However, the image forming unit maybe detachably set there in as a process cartridge. FIG. 7 is a schematic view illustrating a cross-section of an embodiment of the process cartridge for the image forming apparatus of the present invention.

The process cartridge means an image forming unit (or device) which includes a photoreceptor 101 and at least one of a charger 102, an image developer 104, a transferer 106, a cleaner 107 and a discharger (not shown).

The compound having one functional group with a charge-transporting structure of the present invention is synthesized by, e.g., a method disclosed in Japanese Patent No. 3164426. The following method is one of the examples thereof.

(1) Synthesis of a Hydroxy Group Substituted Triarylamine Compound having the Following Formula B

113.85 g (0.3 mol) of a methoxy group substituted triarylamine compound having the formula A, 138 g (0.92 mol) of sodium iodide and 240 ml of sulfolane were mixed to prepare a mixture. The mixture was heated to have a temperature of 60° C. in a nitrogen stream. 99 g (0.91 mol) of trimethylchlorosilane were dropped therein for 1 hr and the mixture was stirred for 4 hrs at about 60° C. About 1.5 L of toluene were added thereto and the mixture was cooled to have a room temperature, and repeatedly washed with water and an aqueous solution of sodium carbonate. Then, a solvent removed therefrom and refined by a column chromatographic process using silica gel as an absorption medium, and toluene and ethyl acetate (20-to-1) as a developing solvent. Cyclohexane was added to the thus prepared buff yellow oil to separate a crystal out. Thus, 88.1 g (yield of 80.4%) of a white crystal having the following formula B and a melting point of from 64.0 to 66.0° C. was prepared.

Element analytical value (%)

| | |
|---|---|
| | A |
| 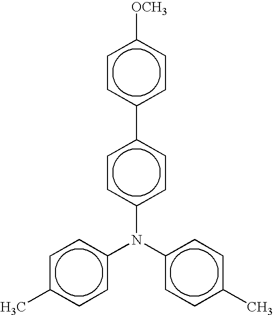 | |
| | B |
| 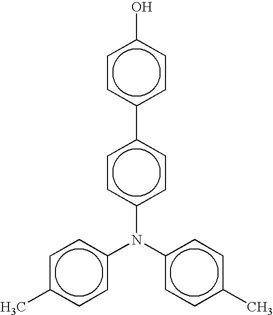 | |

| | C | H | N |
|---|---|---|---|
| Actual measurement | 85.06 | 6.41 | 3.73 |
| Calculated value | 85.44 | 6.34 | 3.83 |

(2) A Triarylamino Group Substituted Acrylate Compound (Compound No. 54)

82.9 g (0.227 mol) of the hydroxy group substituted triarylamine compound having the formula B prepared in (1) were dissolved in 400 ml of tetrahydrofuran to prepare a mixture, and an aqueous solution of sodium hydrate formed of 12.4g of NaOH and 100 mil of water was dropped therein in a nitrogen stream. The mixture was cooled to have a temperature of 5° C., and 25.2 g (0.272 mol) of chloride acrylate was dropped therein for 40 min. Then, the mixture was stirred at 5° C. for 3 hrs. The mixture was put in water and extracted with toluene. The extracted liquid was repeatedly washed with water and an aqueous solution of sodium carbonate. Then, a solvent removed therefrom and refined by a column chromatographic process using silica gel as an absorption medium and toluene as a developing solvent. N-hexane was added to the thus prepared colorless oil to separate a crystal out. Thus, 80.73 g (yield of 84.8%) of a white crystal of the compound No. 54 having a melting point of from 117.5 to 119.0° C. was prepared.

Element analytical value (%)

| | |
|---|---|
| | No. 54 |
| 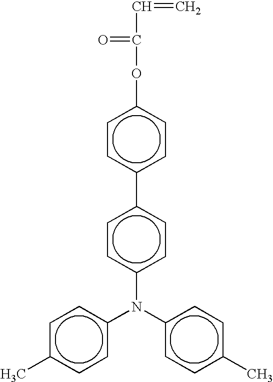 | |

| | C | H | N |
|---|---|---|---|
| Actual measurement | 83.13 | 6.01 | 3.16 |
| Calculated value | 83.02 | 6.00 | 3.33 |

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Independent dot form reproducibility and durability of electrophotographic photoreceptors prepared in the following Examples and Comparative Examples were evaluated by the following methods.

Independent Dot Form Reproducibility Test

Each electrophotographic photoreceptor was charged with a charging roller, and an independent circular dot image having a diameter of 20 μm, equivalent to 1,200 dpi, was formed on the electrophotographic photoreceptor by an image forming tester including an optical system wherein a LD is used as an imagewise light source emitting light having a wavelength of 405 nm, and the light beam can be adjusted with an aperture; a two-component developing unit; and a pattern generator. The initial potential of the photoreceptor was −600 V and a toner having an average particle diameter of 4 μm was used to form a toner image thereon. Next, the toner image was transferred onto an adhesive tape, observed with a microscope and photographed with a CCD camera to analyze the image for evaluating the form and reproducibility of the independent dot image. The evaluation results are shown in Table 1. The closer to a circle and clearer the outline, the better. The more toner scatters, more swollen and more contracted the image, the worse.

⊚: very good

◯: good

Δ: slightly distorted

X: toner scatters, swollen image and unclear outline

Durability Test

The electrophotographic photoreceptor was installed in Imagio MF2200 from Ricoh Company, Ltd., modified to have a LD as an imagewise light source emitting light having a wavelength of 405 nm, and durability test thereof was performed in an environment of normal temperature and humidity (23° C. and 60%). The initial dark place potential was set at -600 V and surface potentials of the dark place and a bright place were measured after 10,000 images were produced. In addition, an abraded thickness of the photoreceptor after 10,000 images were produced was measured.

Image properties were evaluated using a test chart including dot images and letters having an area ratio of 20%. The test chart included a non-printed part to see background fouling and a part to see image resolution.

Image Resolution and Background Fouling

A One dot independent halftone dot image was produced at a writing density of 1,200 dpi and 600 lines/inch for both of main and sub scanning. The background fouling was evaluated in3 grades, and the image resolution was evaluated by the halftone dot image reproducibility.

Background fouling

◯: None

Δ: Slightly occurred

X : Totally occurred

Image Resolution

◯: Good

Δ: Slightly low

X: Noticeably low

Next, the photoreceptor was taken out from Imagio MF2200, and installed again in the above-mentioned image forming tester to form a one dot image. The dot form was observed with a microscope and the evaluation results are shown in Table 1.

### Example 1

An undercoat coating liquid, a charge generation coating liquid and charge transport coating liquid, which have the following formulations, were coated in this order on an aluminum cylinder having a diameter of 30 mm and dried to form an undercoat layer of 3.5 μm thick, a CGL of 0.2 μm thick and a CTL of 14 μm thick thereon. The CTL was further coated with a crosslinked surface layer coating liquid having the following formulation by a spray coating method. The coated layer was irradiated with a metal halide lamp at a light quantity of 160 W/cm, a distance of 120 mm and an irradiation intensity of 600 mW/cm² for 60 sec, and further dried at 130° C. for 30 min to form a crosslinked surface layer having a thickness of 2 μm. Thus prepared electrophotographic photoreceptor was evaluated by the above-mentioned method.

Undercoat Layer Coating Liquid

| Undercoat layer coating liquid | |
|---|---|
| Alkyd resin | 6 |
| (BEKKOZOL1307-60-EL from Dainippon Ink & Chemicals, Inc.) | |
| Melamine resin | 4 |
| (SUPER BEKKAMIN G-821-60 from Dainippon Ink & Chemicals, | |
| Inc.) | |
| Titanium dioxide powder | 40 |
| Methyl ethyl ketone | 50 |
| CGL coating liquid | |
| Bisazo pigment having | 2.5 |
| the following formula (a): | |
| | (a) |
| 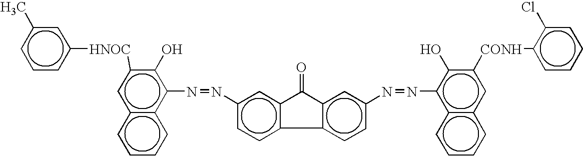 | |
| Polyvinyl butyral | 0.5 |
| (XYHL from Union Carbide Corp.) | |
| Cyclohexanone | 200 |
| Methyl ethyl ketone | 80 |
| CTL coating liquid | |
| Bisphenol Z-type Polycarbonate | 10 |
| Low-molecular-weight CTM | 7 |
| having the following formula (b): | |
| | (b) |
| 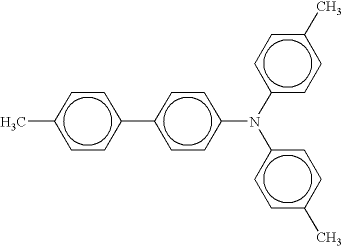 | |
| Tetrahydro furan | 100 |
| Tetrahydrofuran solution | 0.2 |
| including 1% silicone oil | |
| (KF50-100CS from Shin-Etsu Chemical Industry Co., Ltd.) | |
| Antioxidant (Distearyl-3,3′-thiopropionate) | 0.02 |
| Crosslinked surface layer coating liquid | |
| Radical polymerizing monomer | 10 |
| having three or more functional groups | |
| without a charge transport structure | |
| trimethylolpropanetriacrylate | |
| (KAYARAD TMPTA from NIPPON KAYAKU CO., LTD.) | |
| having a molecular weight (Mw) of 296, | |
| 3 functional groups and Mw/3 of 99 | |
| Radical polymerizing compound | 10 |
| having one functional group with | |
| a charge transporting structure | |
| (Compound No. 54) | |
| Photo polymerization initiator | 1 |
| (1-hydroxy-cyclohexyl-phenyl-ketone | |
| IRGACURE 184 from CIBA SPECIALTY CHEMICALS) | |
| Tetrahydrofuran | 100 |

### Example 2

An undercoat layer was formed on an aluminum cylinder by the same method as that of Example 1. Next, 1.5 parts of Y-type oxytitanitmphthalocyanine, 1 part of polyester resin (VYLON 200 from Toyobo Co., Ltd.) and 500 parts of a dichloromethane solution having a concentration of 0.5% were pulverized and mixed by a ball mill to prepare a dispersion, and the dispersion was coated on the undercoat layer to form a CGL having a thickness of 0.2 μm thereon. Next, 10 parts of a CTM having the following formula (c) and 10 parts of a polycarbonate resin (PANLITE C-1400 from Teijin Limited) were dissolved in tetrahydrofuran to prepare a CTL coating liquid, and the CTL coating liquid was coated on the CGL to form a CTL having a thickness of 15 μm thereon.

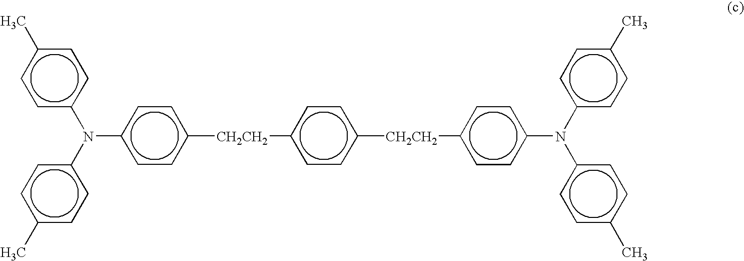

The procedures of preparation and evaluation of the electrophotographic photoreceptor in Example 1 were repeated except for changing the radical polymerizing monomer having three or more functional groups without a charge transport structure included in the crosslinked surface layer coating liquid into the following monomer.

| | |
|---|---|
| Radical polymerizing monomer | 10 |
| having three or more functional groups | |
| without a charge transport structure | |
| trimethylolpropanetriacrylate | |
| (SR-355 from NIPPON KAYAKU CO., LTD.) | |
| having a molecular weight (Mw) of 466, | |
| 4 functional groups and Mw/4 of 117 | |

### Example 3

The procedures of preparation and evaluation of the electrophotographic photoreceptor in Example 1 were repeated except for changing the radical polymerizing monomer having three or more functional groups without a charge transport structure included in the crosslinked surface layer coating liquid into the following monomer, the polymerization initiator into the following compound, the thickness of the CTL into 13 μm and the thickness of the crosslinked surface layer into 3 μm.

| | |
|---|---|
| Radical polymerizing monomer | 10 |
| having three or more functional groups | |
| without a charge transport structure | |
| pentaerythritoltetraacrylate | |
| (SR-295 from NIPPON KAYAKU CO., LTD.) | |
| having a molecular weight (Mw) of 352, | |
| 4 functional groups and Mw/4 of 88 | |
| Photo polymerization initiator | 1 |
| 2,4-diethylthioxantone | |
| (KAYACURE DETX-S from NIPPON KAYAKU CO., LTD.) | |

### Example 4

The procedures of preparation and evaluation of the electrophotographic photoreceptor in Example 1 were repeated except for changing the radical polymerizing monomer having three or more functional groups without a charge transport structure included in the crosslinked surface layer coating liquid into the following monomer, the thickness of the CTL into 11 μm and the thickness of the crosslinked surface layer into 5 μm.

| | |
|---|---|
| Radical polymerizing monomer | 10 |
| having three or more functional groups | |
| without a charge transport structure | |
| dipentaerythritolhexaacrylate | |
| (KAYARAD DPHA from NIPPON KAYAKU CO., LTD.) | |
| having a molecular weight (MW) of 579, | |
| 6 functional groups and Mw/6 of 95 | |

### Example 5

The procedures of preparation and evaluation of the electrophotographic photoreceptor in Example 1 were repeated except for changing the radical polymerizing monomer having three or more functional groups without a charge transport structure included in the crosslinked surface layer coating liquid into the following monomer, the thickness of the CTL into 8 μm and the thickness of the crosslinked surface layer into 8 μm.

| | |
|---|---|
| Radical polymerizing monomer | 10 |
| having three or more functional groups | |
| without a charge transport structure | |
| EO-modified trimethylolpropanetriacrylate | |
| (SR-502 from NIPPON KAYAKU CO., LTD.) | |
| having a molecular weight (Mw) of 692, | |
| 3 functional groups and Mw/3 of 231 | |

### Example 6

The procedures of preparation and evaluation of the electrophotographic photoreceptor in Example 1 were repeated except for changing the radical polymerizing monomer having three or more functional groups without a charge transport structure included in the crosslinked surface layer coating liquid into the following monomer, the thickness of the CTL into 5 μm and the thickness of the crosslinked surface layer into 10 μm.

| | |
|---|---|
| Radical polymerizing monomer | 10 |
| having three or more functional groups | |
| without a charge transport structure | |
| Caprolactone-modified trimethylolpropanetriacrylate | |
| (KARAYAD DPCA-120 from NIPPON KAYAKU CO., LTD.) | |
| having a molecular weight (Mw) of 1,947, | |
| 6 functional groups and Mw/6 of 325 | |

### Example 7

The procedures of preparation and evaluation of the electrophotographic photoreceptor in Example 1 were repeated except for changing the radical polymerizing compound having one functional group with a charge transporting structure included in the crosslinked surface layer coating liquid into 10 parts of compound No. 127, and the thickness of the CTL into 10 μm.

### Example 8

The procedures of preparation and evaluation of the electrophotographic photoreceptor in Example 1 were repeated except for changing the radical polymerizing compound having one functional group with a charge transporting structure included in the crosslinked surface layer coating liquid into 10 parts of compound No. 94, the polymerization initiator into the following heat polymerization initiator, heating the coated liquid at 70° C. for 30 min and further at 150° C. for 1 hr with an air blasting oven, the thickness of the CTL into 11 μm and the thickness of the crosslinked surface layer into 2 μm.

| | |
|---|---|
| Heat polymerization initiator | 1 |
| 2,2′-azobisisobutylonitrile | |
| (from Tokyo Kasei Kogyo Co., Ltd.) | |

### Example 9

The procedures of preparation and evaluation of the electrophotographic photoreceptor in Example 8 were repeated except for changing the radical polymerizing compound having one functional group with a charge transporting structure included in the crosslinked surface layer coating liquid into 10 parts of compound No. 138, and the thickness of the CTL into 12 μm.

### Example 10

The procedures of preparation and evaluation of the electrophotographic photoreceptor in Example 2were repeated except for changing the parts of the radical polymerizing monomer having three or more functional groups without a charge transport structure and the radical polymerizing compound having one functional group with a charge transporting structure included in the crosslinked surface layer coating liquid into 6 and 14 respectively.

### Example 11

The procedures of preparation and evaluation of the electrophotographic photoreceptor in Example 2 were repeated except for changing the parts of the radical polymerizing monomer having three or more functional groups without a charge transport structure and the radical polymerizing compound having one functional group with a charge transporting structure included in the crosslinked surface layer coating liquid into 14 and 6 respectively.

### Example 12

The procedures of preparation and evaluation of the electrophotographic photoreceptor in Example 1 were repeated except for using the following CTL coating liquid including a charge transport polymer material.

CTL coating liquid

| | |
|---|---|
| Charge transport polymer material | 15 |
| having the following formula: | |
| 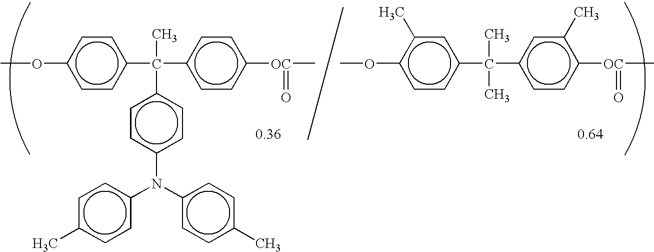 | |
| Tetrahydrofuran | 100 |
| Tetrahydrofuran solution | 0.3 |
| including 1% silicone oil | |
| (KF50-100CS from Shin-Etsu Chemical Industry Co., Ltd.) | |

### Example 13

The procedures of preparation and evaluation of the electrophotographic photoreceptor in Example 1 were repeated except for forming an intermediate layer formed of a polyamide resin (alcohol-soluble nylon CM8000 from Toray Industries, Inc.) having a thickness of 0.5 μm between the CTL and the crosslinked surface layer by a spray coating method, and changing the thickness thereof into 1 μm.

### Example 14

The procedures of preparation and evaluation of the electrophotographic photoreceptor in Example 1 were repeated except for spray-coating a crosslinked surface layer coating liquid having the following formulation on the CGL, changing the irradiation time into 120 sec and the thickness of the crosslinked surface layer into 15 μm.

Crosslinked surface layer coating liquid

| | |
|---|---|
| Radical polymerizing monomer | 10 |
| having three or more functional groups | |
| without a charge transport structure | |
| EO-modified trimethylolpropanetriacrylate | |
| (SR-502 from NIPPON KAYAKU CO., LTD.) | |
| having a molecular weight (Mw) of 692, | |
| 3 functional groups and Mw/3 of 231 | |
| Radical polymerizing compound | 10 |
| having one functional group with | |
| a charge transporting structure | |
| (Compound No. 54) | |
| Photo polymerization initiator | 1 |
| (1-hydroxy-cyclohexyl-phenyl-ketone | |
| IRGACURE 184 from CIBA SPECIALTY CHEMICALS) | |
| Tetrahydrofuran | 60 |
| Cyclohexanone | 20 |
| Tetrahydrofuran solution | 0.2 |
| including 1% silicone oil | |
| (KF50-100CS from Shin-Etsu Chemical Industry Co., Ltd.) | |

### Example 15

The procedures of preparation and evaluation of the electrophotographic photoreceptor in Example.1 were repeated except for coating a CTL coating liquid, wherein each 5 parts of CTMs having the following formulae (h) and (i) respectively and 10 parts of a polycarbonate resin (PANLITE C-1400 from Teijin Limited) were dissolved in tetrahydrofuran, on the undercoat layer, and dried the coated liquid at 80° C. for 2 min and further 130° C. for 20 min to form a CTL having a thickness of 18 μm thereon; and spray-coating a CGL coating liquid, wherein 7.5 parts of the bisazo compound having the formula (a), 5.0 parts of a phenoxy resin (PKHH from Union Carbide Corp.) and 833 parts of a methyl ethyl ketone/cyclohexanone. (weight ratio 4/1) solution were pulverized and mixed by a ball mill, on the CTL, and dried the coated liquid at 100° C. for 10 min to form a CGL having a thickness of 0.2 μm thereon.

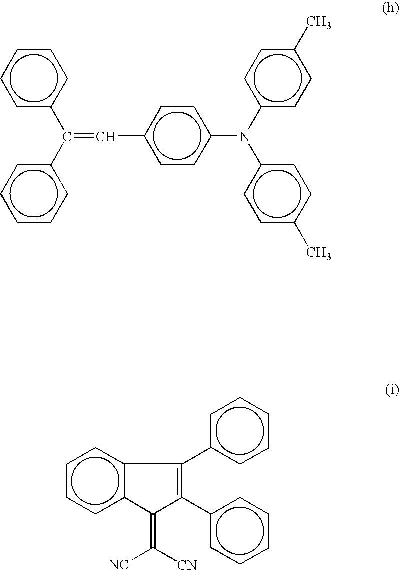

### Example 16

The surface of an aluminum cylinder having diameter of 30 mm was anodized and sealed. Each 10 parts of a CTM having the formula (h) and a polystyrene resin (SBM-700 from Sanyo Chemical Industries, Ltd.) were dissolved in tetrahydrofuran to prepare a CTL coating liquid. The CTL coating liquid was coated on the aluminum cylinder, and the coated liquid was dried at 80° C. for 2 min and further at 130° C. for 20 min to form a CTL having a thickness of 19 μm thereon.

Next, 7.5 parts of the bisazo compound having the formula (a), 2.5 parts of a phenoxy resin (PKHH from Union Carbide Corp.) and 833 parts of a methyl ethyl ketone/cyclohexanone (weight ratio 4/1) solution were pulverized and mixed by a ball mill to prepare a CGM dispersion. The CGM dispersion was spray-coated on the CTL, and naturally dried to form a CGL thereon. Next, 3 parts of a CTM having the following formula (k) and 1 part of a CTM having the following formula (1) were mixed in the following crosslinked surface layer, and the mixture was spray-coated on the CGL.

| | |
|---|---|
| | (k) |
| 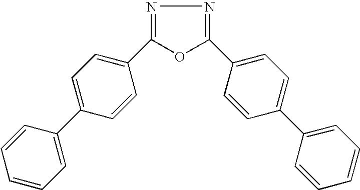 | |
| | (l) |
| 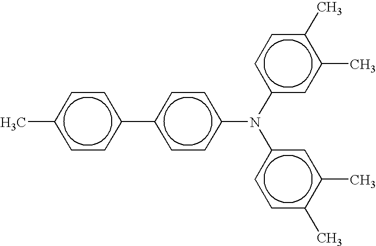 | |

Crosslinked surface layer coating liquid

| | |
|---|---|
| Radical polymerizing monomer | 10 |
| having three or more functional groups | |
| without a charge transport structure | |
| trimethylolpropanetriacrylate | |
| (KAYAPAD TMPTA from NIPPON KAYAKU CO., LTD.) | |
| having a molecular weight (Mw) of 296, | |
| 3 functional groups and Mw/3 of 99 | |
| Radical polymerizing compound | 10 |
| having one functional group with | |
| a charge transporting structure | |
| (Compound No. 94) | |
| Heat polymerization initiator | |
| 2,2′-azobisisobutylonitrile | |
| (from Tokyo Kasei Kogyo Co., Ltd.) | |
| Tetrahydrofuran | 100 |

The coated layer was irradiated with a metal halide lamp at a light quantity of 160 W/cm, a distance of 120 mm and an irradiation intensity of 600 mW/cm² for 60 sec, and further dried at 130° C. for 30 min to form a crosslinked surface layer having a thickness of 2 μm thereon to prepare an electrophotographic photoreceptor.

The electrophotographic photoreceptor was evaluated by the above-mentioned method. However, the electrophotographic photoreceptor was charged with a charger having a positive polarity. The initial potential was +600V, a positively charged toner having a particle diameter of 4 μm was used, a developing bias was pertinently positive, and a dot was developed by reverse development.

Further, the electrophotographic photoreceptor was installed in an experimental electrophotographic copier wherein a lubricant applicator was placed at the top end of a cleaner disclosed in Japanese Laid-Open Patent Publication No. 2000-47523 to control abrasion resistance of the photoreceptor. ELS507 from Asahi Kasei Corp. was used as the lubricant. Even after 10,000 images were produced, the bright place potential was +585 v and the dark place potential was +75 V, the dot form reproducibility and images were normal. The abrasion resistance was also satisfactory.

### Example 17

A CTL was formed on an aluminum cylinder by the same method in

### Example 16, and the following crosslinked surface layer was formed thereon.

7.5 parts of the bisazo compound having the formula (a), 2.5 parts of a phenoxy resin (PKHH from Union Carbide Corp.) and 833 parts of a methyl ethyl ketone/cyclohexanone (weight ratio 4/1) solution were pulverized and mixed by a ball mill to prepare a CGM dispersion. Next, 3.5parts of the CTM having the following formula (k) and 0.5 parts of the CTM having the following formula (1) were mixed in 10 parts of the CGM dispersion, and the mixture was further mixed in the following crosslinked surface layer coating liquid.

Crosslinked surface layer coating liquid

| | |
|---|---|
| Radical polymerizing monomer | 10 |
| having three or more functional groups | |
| without a charge transport structure | |
| trimethylolpropanetriacrylate | |
| (KAYARAD TMPTA from NIPPON KAYAKU CO., LTD.) | |
| having a molecular weight (Mw) of 296, | |
| 3 functional groups and Mw/3 of 99 | |
| Radical polymerizing compound | 7 |
| having one functional group with | |
| a charge transporting structure | |
| (Compound No. 94) | |
| Heat polymerization initiator | 1 |
| 2,2′-azobisisobutylonitrile | |
| (from Tokyo Kasei Kogyo Co., Ltd.) | |
| Tetrahydrofuran | 100 |

The thus prepared crosslinked surface layer coating liquid was spray-coated on the CTL. The coated layer was irradiated with a metal halide lamp at a light quantity of 160 W/cm, a distance of 120 mm and an irradiation intensity of 600 mW/cm² for 60 sec, and further dried at 130° C. for 30 min to form a crosslinked surface layer having a thickness of 5 μm thereon to prepare an electrophotographic photoreceptor. The electrophotographic photoreceptor was evaluated by the above-mentioned method.

### Comparative Example 1

The procedures of preparation and evaluation of the electrophotographic photoreceptor in Example 1 were repeated except for coating an outermost layer coating liquid having the following formulation on the CTL, and drying the coated liquid at 80° C. for 2 min and further at 130° C. for 20 min to form an outermost layer thereon.

Outermost layer coating liquid

| | |
|---|---|
| Charge transport polymer material | 8 |
| having the following formula: | |
| 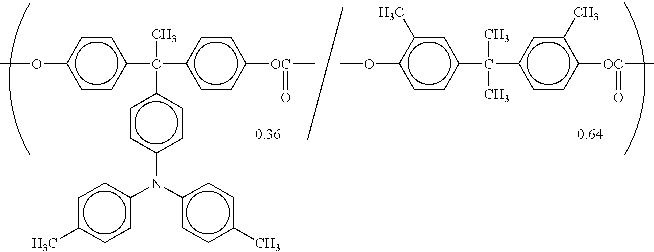 | |
| Particulate polytetrafluoroethylene | 3 |
| having an average primary particle | |
| diameter of 0.3 μm | |
| Tetrahydrofuran | 40 |
| Cyclohexanone | 140 |

### Comparative Example 2

An undercoat layer, a CGL and a CTL were formed on an aluminum cylinder by the same method in Example 2. However, the CTL had a thickness of 10 μm. Next, a protective layer coating liquid having the following formulation was coated on the CTL to form a protective layer having a thickness of 2 μm thereon.

Protective layer coating liquid

| CTM having the flowing formula (d): | 3 |
|---|---|
| | (d) |
| 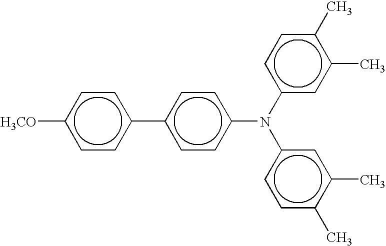 | |
| Distearyl-3,3-thiodipropionate | 0.03 |
| (as an antioxidant) | |
| Polystyrene resin | 5 |
| (SBM-700 from Sanyo Chemical Industries, Ltd.) | |
| Particulate titanium oxide | 2 |
| (CR97 from ISHIHARA SANGYO KAISHA, LTD. | |
| as a filler) | |
| Tetrahydrofuran | 100 |
| Cyclohexanone | 140 |

The thus prepared electrophotographic photoreceptor was evaluated by the above-mentioned method.

### Comparative Example 3

An undercoat layer, a CGL and a CTL were formed on an aluminum cylinder by the same method in Example 2. However, the CTL had a thickness of.10 μm. Next, a protective layer coating liquid having the following formulation was coated on the CTL, and the coated liquid was hardened at 140° C. for 2 hrs to form a protective layer having a thickness of 2 μm thereon.

Protective layer coating liquid

| CTM having the following formula (f): | 45 |
|---|---|
| | (f) |
| 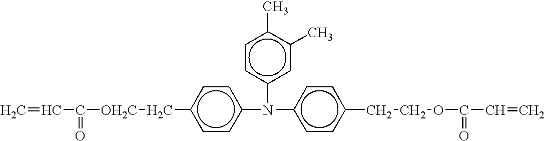 | |
| CTM having the following formula (g): | 5 |
| | (g) |
| 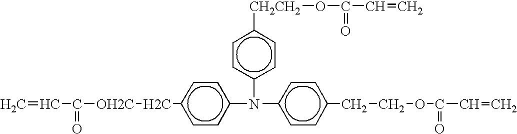 | |
| Heat polymerization initiator | 0.4 |
| having the following formula (e): | |
| | (e) |
| 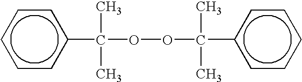 | |
| Chiorome thane | 30 |
| Toluene | 70 |
| The coated liquid | |

The thus prepared electrophotographic photoreceptor was evaluated by the above-mentioned method.

### Comparative Example 4

The procedures of preparation and evaluation of the electrophotographic photoreceptor in Example 1 were repeated except that the crosslinked surface layer was not formed and the CTL had a thickness of 25 μm.

TABLE 1(1)

| | | Sur- | | | | | | |
|---|---|---|---|---|---|---|---|---|
| | | face | | | | | | |
| | CTL | Layer | Independent | | Image Evaluation | | | |
| | Thick- | thick- | Dot | | Image | | background | |
| | ness | ness | reproducibility | | resolution | | fouling | |
| | μm | μm | Initial | 10,000 | Initial | 10,000 | Initial | 10,000 |
| Ex. 1 | 14 | 2 | ⊚ | ⊚ | ◯ | ◯ | ◯ | ◯ |
| Ex. 2 | 15 | 2 | ⊚ | ⊚ | ◯ | ◯ | ◯ | ◯ |
| Ex. 3 | 13 | 3 | ⊚ | ⊚ | ◯ | ◯ | ◯ | ◯ |
| Ex. 4 | 11 | 5 | ◯ | ◯ | ◯ | ◯ | ◯ | ◯ |
| Ex. 5 | 8 | 8 | ◯ | ◯ | ◯ | ◯ | ◯ | ◯ |
| Ex. 6 | 5 | 10 | ◯ | Δ | ◯ | Δ | ◯ | X |
| Ex. 7 | 10 | 2 | ⊚ | ⊚ | ◯ | ◯ | ◯ | ◯ |
| Ex. 8 | 11 | 2 | ⊚ | ⊚ | ◯ | ◯ | ◯ | Δ |
| Ex. 9 | 12 | 2 | ◯ | ◯ | ◯ | ◯ | ◯ | ◯ |
| Ex. | 15 | 2 | ◯ | ◯ | ◯ | ◯ | ◯ | ◯ |
| 10 | | | | | | | | |
| Ex. | 15 | 2 | ◯ | ◯ | ◯ | ◯ | ◯ | ◯ |
| 11 | | | | | | | | |
| Ex. | 14 | 2 | ◯ | ◯ | ◯ | ◯ | ◯ | ◯ |
| 12 | | | | | | | | |
| Ex. | 14 | 1 | ◯ | ◯ | ◯ | ◯ | ◯ | ◯ |
| 13 | | | | | | | | |
| Ex. | 15 | | ◯ | Δ | ◯ | Δ | ◯ | Δ |
| 14 | | | | | | | | |
| Ex. | 18 | 2 | ◯ | ◯ | ◯ | ◯ | ◯ | ◯ |
| 15 | | | | | | | | |
| Ex. | 19 | 2 | ◯ | ◯ | ◯ | ◯ | ◯ | ◯ |
| 16 | | | | | | | | |
| Ex. | 19 | 5 | ◯ | ◯ | ◯ | ◯ | ◯ | ◯ |
| 17 | | | | | | | | |
| Com. | 14 | 2 | Δ | X | X | Δ | ◯ | X |
| Ex. 1 | | | | | | | | |
| Com. | 10 | 2 | X | X | X | X | ◯ | X |
| Ex. 2 | | | | | | | | |
| Com. | 10 | 2 | ◯ | X | Δ | X | ◯ | Δ |
| Ex. 3 | | | | | | | | |
| Com. | 25 | Nil | X | X | X | X | ◯ | ◯ |
| Ex. 4 | | | | | | | | |

TABLE 1(2)

| | Potential (V) | | Potential (V) | | |
|---|---|---|---|---|---|
| | Initial | | 10,000 | | Abraded |
| | | Bright | | Bright | thickness |
| | Dark place | place | Dark place | place | μm |
| Ex. 1 | 600 | 40 | 585 | 80 | 0.2 |
| Ex. 2 | 600 | 45 | 530 | 30 | 0.18 |
| Ex. 3 | 600 | 40 | 560 | 70 | 0.21 |
| Ex. 4 | 600 | 40 | 540 | 75 | 0.22 |
| Ex. 5 | 600 | 35 | 565 | 75 | 0.19 |
| Ex. 6 | 600 | 40 | 510 | 190 | 0.2 |
| Ex. 7 | 600 | 50 | 550 | 50 | 0.23 |
| Ex. 8 | 600 | 50 | 580 | 60 | 0.21 |
| Ex. 9 | 600 | 40 | 570 | 70 | 0.2 |
| Ex. 10 | 600 | 50 | 520 | 100 | 0.19 |
| Ex. 11 | 600 | 40 | 530 | 120 | 0.21 |
| Ex. 12 | 600 | 35 | 540 | 55 | 0.21 |
| Ex. 13 | 600 | 40 | 555 | 50 | 0.21 |
| Ex. 14 | 600 | 50 | 585 | 155 | 0.22 |
| Ex. 15 | 600 | 50 | 560 | 80 | 0.2 |
| Ex. 16 | 600 | 40 | 585 | 75 | 0.23 |
| Ex. 17 | 600 | 50 | 545 | 86 | 0.32 |
| Com. Ex. 1 | 600 | 50 | 590 | 80 | 1.8 |
| Com. Ex. 2 | 600 | 65 | 580 | 95 | 0.11 |
| Com. Ex. 3 | 600 | 40 | 550 | 150 | 0.26 |
| Com. Ex. 4 | 600 | 75 | 590 | 90 | 3.1 |

### Example 18

Toners having an average particle diameter of from 2 to 10 μm were prepared by known methods. Independent dot forms were produced with these toners using the photoreceptor in Example 1. The evaluation results of each independent dot form reproducibility was shown in Table 2.

TABLE 2

| | Average particle | |
|---|---|---|
| | diameter μm | Independent dot form |
| Example 18 | 2 | ⊚ |
| | 3 | ⊚ |
| | 4 | ⊚ |
| | 5 | ⊚ |
| | 6 | ◯ |
| | 7 | ◯ |
| | 8 | ◯ |
| | 9 | Δ |
| | 10 | Δ |

### Example 19

Toners having a volume-average particle diameter of 3 μm and 4 μm (an average circularity of from 0.96 to 0.98) were prepared by known methods. Independent dot forms were produced with these toners, using the photoreceptor in Example 1 and the laser spot diameter of from 10 μm (equivalent to 2,400 dpi) to 40 μm (equivalent to 600 dpi). The evaluation results of each independent dot form reproducibility was shown in Table 3.

TABLE 3

| | |
|---|---|
| | Independent |
| Laser spot diameter | dot form |

| | μm | 3 μm | 4 μm |
|---|---|---|---|
| Example 19 | 10 | ◯ | Δ |
| | 15 | ⊚ | ◯ |
| | 20 | ⊚ | ◯ |
| | 30 | ⊚ | ⊚ |
| | 40 | ⊚ | ⊚ |

Table 1 shows that each of the photoreceptors having the crosslinked surface layer of the present invention in Examples 1 to 17 has high abrasion resistance, good electrical properties, and produces good images for long periods. On the contrary, each of the photoreceptors in Comparative Examples 1 to 4 has deteriorated surface uniformity, abrasion resistance and durability.

Table 2 shows that toners having an average particle diameter of from 2 to 8 μm produce dot images having good reproducibility. Table 3 shows that the photoreceptor of he present invention produces ultra high quality images having 2,400 dpi.

This application claims priority and contains subject matter related to Japanese Patent Application No. 2004-195722 filed on Jul. 1, 2004, the entire contents of which are hereby incorporated by reference.

Having now fully described the invention, it will be apparent to one of ordinary skill in the art that many changes and modifications can be made thereto without departing from the spirit and scope of the invention as set forth therein.

What is claimed as new desired to be secured by Letters Patent of the United States is:

1. An image forming method comprising:
charging an electrophotographic photoreceptor comprising:
an electroconductive substrate; and
a photosensitive layer located overlying the electroconductive substrate, comprising a crosslinked surface layer on a surface thereof,
irradiating the electrophotographic photoreceptor with imagewise light to form an electrostatic latent image thereon;
developing the electrostatic latent image with a toner to form a toner image on the electrophotographic photoreceptor;
transferring the toner image onto a transfer material; and
fixing the toner image on the transfer material,
wherein the photosensitive layer is sensitive to light having a wavelength of from 400 to 450 nm, and the crosslinked surface layer is formed by crosslinking and hardening a radical polymerizing monomer having three or more functional groups without a charge transport structure and a radical polymerizing compound having one functional group with charge transport structure.

2. The image forming method of claim 1, wherein the photosensitive layer further comprises a charge generation layer and a charge transport layer.

3. The image forming method of claim 1, wherein the photosensitive layer has a charge generating capability and a charge transporting capability.

4. The image forming method of claim 2, wherein the charge generation layer has a sensitivity to light having a wavelength of from 400 to 450 nm and is located overlying the electroconductive substrate; the charge transport layer is located overlying the charge generation layer; and the crosslinked surface layer is located overlying the charge transport layer.

5. The image forming method of claim 2, wherein the charge transport layer is located overlying the electroconductive substrate; the charge generation layer has a sensitivity to light having a wavelength of from 400 to 450 nm and is located overlying the charge transport layer; and the crosslinked surface layer is located overlying the charge generation layer.

6. The image forming method of claim 2, wherein the crosslinked surface layer has a thickness of from 1 to 10 μm.

7. The image forming method of claim 5, wherein the photosensitive layer further comprises a charge transport layer and wherein the crosslinked surface layer is a charge generation layer.

8. The image forming method of claim 7, wherein the crosslinked surface layer comprises at least one of a positive hole charge transport material and an electron charge transport material.

9. The image forming method of claim 1, wherein the functional groups of the radical polymerizing monomer having three or more functional groups without a charge transport structure and the radical polymerizing compound having one functional group with charge transport structure are independently an acryloyloxy group or a methacryloyloxy group.

10. The image forming method of claim 1, wherein the photo receptor is irridiated with light having a wavelength of from 400 to 450 nm emitted by a LD or a LED.

11. The image forming method of claim 1, wherein the photo receptor is irridiated with light having a wavelength of from 400 to 450 nm having a beam diameter of from 10 to 40 μm.

12. The image forming method of claim 1, wherein the toner has an average particle diameter of from 2 to 8 μm.

13. The image forming method of claim 1, further comprising:
controlling an abrasion resistance of the electrophotographic photoreceptor.

14. The image forming method of claim 13, wherein the abrasion resistance is controlled with an applicator applying a lubricant to the electrophotographic photoreceptor or a provider providing a member having a low surface energy thereto.

15. An image forming apparatus comprising:
an electrophotographic photoreceptor;
a charger configured to charge the electrophotographic photoreceptor;
an irradiator configured to irradiate the electrophotographic photoreceptor with imagewise light to form an electrostatic latent image thereon;
an image developer configured to develop the electrostatic latent image with a toner to form a toner image on the electrophotographic photoreceptor;
a transferer configured to transfer the toner image onto a transfer material; and
a fixer configured to fix the toner image on the transfer material,
wherein the electrophotographic photoreceptor is the electrophotographic photoreceptor according to claim 1.

16. A process cartridge detachable from the image forming apparatus according to claim 15, comprising:
the electrophotographic photoreceptor; and
at least one of the charger, the irradiator, the image developer, the transferer and a cleaner configured to remove the toner from the electrophotographic photoreceptor after transferred.
